(19) United States
(12) Patent Application Publication
(10) Pub. No.: US 2023/0155747 A1
(43) Pub. Date: May 18, 2023

(54) METHOD AND APPARATUS FOR MULTIPLE PHYSICAL SHARED CHANNEL SCHEDULING IN WIRELESS COMMUNICATION SYSTEMS

(71) Applicant: Samsung Electronics Co., Ltd., Suwon-si (KR)

(72) Inventors: Kyungjun CHOI, Suwon-si (KR); Youngrok JANG, Suwon-si (KR); Kyunggyu LEE, Suwon-si (KR); Hyoungju JI, Suwon-si (KR)

(21) Appl. No.: 18/051,405

(22) Filed: Oct. 31, 2022

(30) Foreign Application Priority Data
Oct. 29, 2021 (KR) 10-2021-0147250

(51) Int. Cl. H04L 1/18; H04W 72/12

(52) U.S. Cl. CPC H04L 1/1861; H04W 72/1289; H04L 1/1822; H04L 1/1819

(57) ABSTRACT

The disclosure relates to a 5th generation (5G) or pre-5G communication system to be provided for supporting higher data rates beyond 4th generation (4G) communication system such as long term evolution (LTE). The disclosure discloses, in a case that a terminal is configured with a time domain resource assignment (TDRA) including a plurality of start and length indication values (SLIVs) in a wireless communication system, a method for determining whether a downlink control information (DCI) format is used for a semi persistent scheduling (SPS) physical downlink shared channel (PDSCH) reception, a configured grant (CG) physical uplink shared channel (PUSCH) transmission, or a Scell dormancy indication transmission, and a selective SPS PDSCH reception method, a selective CG PUSCH transmission method, or a Scell dormancy application method according to the determination.

### CROSS REFERENCE TO RELATED APPLICATION

The present application claims priority to Korean Patent Application No. 10-2021-0147250, filed Oct. 29, 2021, the entire contents of which is incorporated herein for all purposes by this reference.

### BACKGROUND

### 1. Field

The disclosure relates to operations of a terminal and a base station in a wireless communication system. Specifically, the disclosure relates to a method for interpreting downlink control information for scheduling a plurality of downlinks of a terminal and a plurality of uplinks of a terminal, and an apparatus capable of performing the same.

### 2. Description of the Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (Bandwidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

Based on the above discussion, the disclosure provides an apparatus and method for effectively providing a service in a mobile communication system.

The disclosure discloses, in a case that a terminal is configured with a time domain resource assignment (TDRA) including a plurality of start and length indication values (SLIVs) in a wireless communication system, a method for determining whether a downlink control information (DCI) format is used for a semi persistent scheduling (SPS) physical downlink shared channel (PDSCH) reception, a configured grant (CG) physical uplink shared channel (PUSCH) transmission, or a Scell dormancy indication transmission, and a selective SPS PDSCH reception method, a selective CG PUSCH transmission method, or a Scell dormancy application method according to the determination.

According to the disclosure, a DCI format may include a plurality of new data indicator (NDI) fields and a plurality of redundancy version (RV) fields for a plurality of SLIVs, and according to a combination of values of the NDI fields and RV fields, the DCI format may be determined as an activation DCI or release DCI for SPS PDSCH reception/CG PUSCH transmission.

According to the disclosure, one, some, or all of the plurality of SLIVs may be used for SPS PDSCH reception/CG PUSCH transmission based on a combination of values of the NDI fields and RV fields in an activation DCI.

According to the disclosure, one or some or all of the activated SLIVs may belong to one SPS configuration/CG configuration, or may belong to a plurality of SPS configurations/CG configurations. In a case that one or some or all the activated SLIVs belong to the plurality of SPS configurations/CG configurations, the relationship between each SLIV and each SPS configuration/CG configuration may be configured via an upper layer or determined based on a predetermined rule.

According to the disclosure, the DCI format may be determined as a DCI for SPS PDSCH re-reception/CG PUSCH retransmission according to a combination of values of the NDI fields and RV fields.

According to the disclosure, based on a combination of values of the NDI fields and RV fields, one, some, or all of the plurality of SLIVs may be used for SPS PDSCH re-reception/CG PUSCH re-transmission.

According to the disclosure, a DCI format may be used as Scell dormancy indication, and in this case, a plurality of NDI fields and a plurality of RV fields may be listed in a predetermined order and used as a bitmap.

According to the technology provided in the disclosure, a terminal and a network may provide SPS/CG/Scell dormancy indication in a DCI format for a plurality of SLIVs.

According to the disclosure, a method performed by a terminal in a wireless communication system, may include receiving, from a base station, a radio resource control (RRC) message including scheduling information for physical downlink shared channels (PDSCHs); receiving, from the base station, downlink control information (DCI) including a time domain resource assignment (TDRA) field; identifying whether the DCI is related to a secondary cell (SCell) dormancy indication; identifying a number of bits of a new data indicator (NDI) field and a number of bits of a redundancy version (RV) field included in the DCI based on the RRC message and the TDRA field, in a case that the DCI is related to the SCell dormancy indication; identifying a bitmap of the SCell dormancy indication included in the DCI based on the number of bits of the NDI field and the number of bits of the RV field; and identifying an active bandwidth part (BWP) for the SCell configured in the terminal based on the identified bitmap.

According to the disclosure, a terminal in a wireless communication system may include a transceiver constituted to transmit and receive a signal; and a processor connected to the transceiver and configured to receive, from a base station, a radio resource control (RRC) message including scheduling information for physical downlink shared channels (PDSCHs); receive, from the base station, downlink control information (DCI) including a time domain resource assignment (TDRA) field; identify whether the DCI is related to a secondary cell (SCell) dormancy indication; identify a number of bits of a new data indicator (NDI) field and a number of bits of a redundancy version (RV) field included in the DCI based on the RRC message and the TDRA field, in a case that the DCI is related to the SCell dormancy indication; identify a bitmap of the SCell dormancy indication included in the DCI based on the number of bits of the NDI field and the number of bits of the RV field; and identify an active bandwidth part (BWP) for the SCell configured in the terminal based on the identified bitmap.

The apparatus and method according to embodiments of the disclosure can effectively provide a service in a mobile communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts.

FIG. 1 illustrates a basic structure of a time-frequency domain in a wireless communication system according to an embodiment of the disclosure.

FIG. 2 illustrates a frame, a subframe, and a slot structure in a wireless communication system according to an embodiment of the disclosure.

FIG. 3 illustrates an example of a bandwidth part configuration in a wireless communication system according to an embodiment of the disclosure.

FIG. 4 illustrates an example of a control resource set configuration of a downlink control channel in a wireless communication system according to an embodiment of the disclosure.

FIG. 5 illustrates a structure of a downlink control channel in a wireless communication system according to an embodiment of the disclosure.

FIG. 6 illustrates a method by which a base station and a terminal transmit and receive data in consideration of a downlink data channel and a rate matching resource in a wireless communication system according to an embodiment of the disclosure.

FIG. 7 illustrates an example of frequency axis resource allocation of physical downlink shared channel (PDSCH) in a wireless communication system according to an embodiment of the disclosure.

FIG. 8 illustrates an example of time axis resource allocation of a PDSCH in a wireless communication system according to an embodiment of the disclosure.

FIG. 9 illustrates an example of time axis resource allocation according to subcarrier spacings of a data channel and a control channel in a wireless communication system according to an embodiment of the disclosure.

FIG. 10 illustrates a radio protocol structure of a base station and a terminal in single cell, carrier aggregation, and dual connectivity situations in a wireless communication system according to an embodiment of the disclosure.

FIG. 11 illustrates scheduling of a plurality of PDSCHs according to an embodiment of the disclosure.

FIG. 12 illustrates DCI interpretation by single-PDSCH scheduling or DCI interpretation by multi-PDSCH scheduling when scheduling is configured for a plurality of PDSCHs according to an embodiment of the disclosure.

FIG. 13 illustrates a bitmap of Scell dormancy indication in a case of single-PDSCH scheduling according to an embodiment of the disclosure.

FIG. 14 illustrates a bitmap of Scell dormancy indication in a case of multi-PDSCH scheduling according to an embodiment of the disclosure.

FIG. 15 illustrates activation of a single SPS configuration in a case of multi-PDSCH scheduling according to an embodiment of the disclosure.

FIG. 16 illustrates activation of a single SPS configuration in a case of multi-PDSCH scheduling according to an embodiment of the disclosure.

FIG. 17 illustrates activation of a plurality of SPS configurations in a case of multi-PDSCH scheduling according to an embodiment of the disclosure.

FIG. 18 illustrates activation of a plurality of SPS configurations in a case of multi-PDSCH scheduling according to an embodiment of the disclosure.

FIG. 19 illustrates activation of SPS configuration corresponding to some scheduling information in a case of multi-PDSCH scheduling according to an embodiment of the disclosure.

FIG. 20 illustrates SPS retransmission in a case of single-PDSCH scheduling according to an embodiment of the disclosure.

FIG. 21 illustrates SPS retransmission in a case of multi-PDSCH scheduling according to an embodiment of the disclosure.

FIG. 22 illustrates SPS retransmission corresponding to some scheduling information in a case of multi-PDSCH scheduling according to an embodiment of the disclosure.

FIG. 23 illustrates a flowchart of interpretation of Scell dormancy indication according to an embodiment of the disclosure.

FIG. 24 illustrates a flowchart of activation, deactivation, and retransmission of SPS according to an embodiment of the disclosure.

FIG. 25 illustrates a structure of a terminal in a wireless communication system according to an embodiment of the disclosure.

FIG. 26 illustrates a structure of a base station in a wireless communication system according to an embodiment of the disclosure.

### DETAILED DESCRIPTION

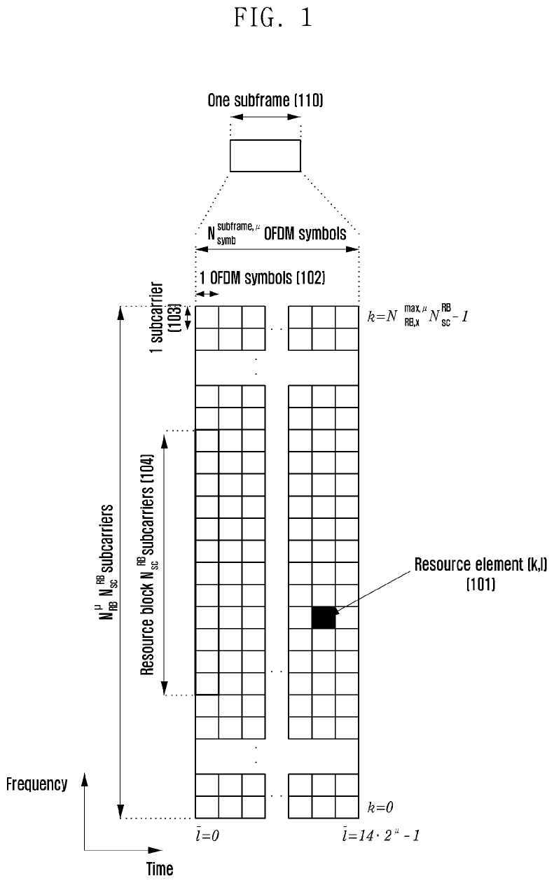

FIGS. 1 through 26, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing embodiments, descriptions related to technical contents well-known in the art and not associated directly with the disclosure will be omitted. Such an omission of unnecessary descriptions is intended to prevent obscuring of the subject matter of the disclosure and more clearly transfer the main idea.

For the same reason, in the accompanying drawings, some elements may be exaggerated, omitted, or schematically illustrated. Further, the size of each component does not completely reflect the actual size. In the drawings, identical or corresponding components are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims Throughout the specification, the same or like reference numerals designate the same or like elements. Further, in describing the disclosure, a detailed description of known functions or constitutions incorporated herein will be omitted in a case that it may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Hereinafter, a base station is a subject that performs resource allocation to a terminal, and may be at least one of a gNode B, an eNode B, a Node B, a base station (BS), a radio access unit, a base station controller, or a node on a network A terminal may include a user equipment (UE), a mobile station (MS), a cellular phone, a smartphone, a computer, or a multimedia system capable of performing communication functions. In the disclosure, a “downlink (DL)” refers to a wireless transmission path via which a base station transmits a signal to a terminal, and an “uplink (UL)” refers to a wireless transmission path via which a terminal transmits a signal to a base station. Further, although the following description may be directed to an LTE or LTE-A system by way of example, embodiments of the disclosure may also be applied to other communication systems having similar technical backgrounds or channel types. Examples of other communication systems may include 5th generation mobile communication technologies (5G, new radio, NR) developed beyond LTE-A, and in the following description, the 5G may be a concept that covers exiting LTE, LTE-A, and other similar services. In addition, based on determinations by those skilled in the art, the disclosure may be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus, so that the instructions, which are executed via the processor of the computer or other programmable data processing apparatus, create means for implementing the functions specified in the flowchart block(s). These computer program instructions may also be stored in a computer usable or computer-readable memory that can direct a computer or other programmable data processing apparatus to function in a particular manner, so that the instructions stored in the computer usable or computer-readable memory can produce an article of manufacture including instruction means that implement the function specified in the flowchart block(s). The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block(s).

Further, each block may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

In this case, the “unit” used in this embodiment refers to a software component or a hardware component, such as a Field Programmable Gate Array (FPGA) or an Application Specific Integrated Circuit (ASIC), which performs a predetermined function. However, the “unit” does not always have a meaning limited to software or hardware. The “unit” may be constituted either to be stored in an addressable storage medium or to execute one or more processors. Therefore, the “unit” includes, for example, components such as software components, object-oriented software components, class components and task components, processes, functions, properties, procedures, sub-routines, segments of a program code, drivers, firmware, micro-codes, circuits, data, database, data structures, tables, arrays, and parameters. The functionalities provided in the components and “units” may be combined into fewer components and “units” or may be further separated into additional components and “units.” Furthermore, the components and “units” may be implemented to operation on one or more CPUs within a device or a security multimedia card. Further, the “unit” in the embodiment may include one or more processors.

Wireless communication systems have been developed from an initial wireless communication system providing a voice-oriented service to a broadband wireless communication system providing a high-speed and high-quality packet data service, such as those according to communication standards including a high-speed packet access (HSPA) of 3GPP, long-term evolution ((LTE) or evolved universal terrestrial radio access (E-UTRA)), LTE-advanced (LTE-A), LTE-Pro, high rate packet data (HRPD) of 3GPP2, ultra mobile broadband (UMB), and 802.16e of IEEE.

In an LTE system, which is a representative example of the broadband wireless communication system, a downlink (DL) adopts an orthogonal frequency division multiplexing (OFDM) scheme and an uplink (UL) adopts a single carrier frequency division multiple access (SC-FDMA) scheme. The uplink refers to a radio link via which a terminal (user equipment (UE) or mobile station (MS)) transmits data or a control signal to a base station (BS) (or eNode B), and the downlink refers to a radio link via which a base station transmits data or a control signal to a UE. In such a multi-access scheme, normally data or control information of each user may be distinguished by allocating and operating time-frequency resources, at which the data or control information of each user is to be transmitted, so as not to overlap each other, that is, to establish orthogonality.

A 5G communication system, that is, a future communication system after LTE, should be able to freely reflect various requirements of users, service providers, etc., so that a service that concurrently satisfies various requirements should be supported. Services considered for the 5G communication system includes an enhanced mobile broadband (eMBB) communication, massive machine type communication (mMTC), ultra-reliability low latency communication (URLLC), and the like.

The eMBB aims to provide a data transmission rate that is more improved than a data transmission rate supported by existing LTE, LTE-A or LTE-Pro. For example, in the 5G communication system, an eMBB should be able to provide a peak data rate of 20 Gbps in a downlink and a peak data rate of 10 Gbps in an uplink from the perspective of one base station. The 5G communication system also needs to provide a peak data rate while concurrently providing an increased actual user perceived data rate of a UE. In order to satisfy these requirements, improvement of various transmission or reception technologies including a more advanced multi-antenna (multi-input multi-output (MIMO)) transmission technology is required. In addition, a signal may be transmitted using a maximum transmission bandwidth of 20 MHz in a 2 GHz band used by LTE, whereas, in the 5G communication system, a data transmission rate, which is required by the 5G communication system, may be satisfied by using a frequency bandwidth wider than 20 MHz in a frequency band of 3 to 6 GHz or a frequency band of 6 GHz or higher.

At the same time, the mMTC is being considered to support application services, such as Internet of things (IoT), in the 5G communication system. In order to efficiently provide the IoT, the mMTC may require support of a large-scale UE access in a cell, coverage enhancement of a UE, an improved battery time, cost reduction of a JE, and the like. The IoT is attached to a plurality of sensors and various devices to support communication functions, so that the IoT should be able to support a large number of UEs (e.g., 1,000,000 UEs/km²) within a cell. In addition, due to the nature of a service, a UE that supports the mMTC is likely to be located in a shaded region, which cannot be covered by a cell, such as the basement of a building, and therefore a wider coverage may be required compared to other services provided by the 5G communication system. The UE that supports the mMTC is constituted to be a low-cost UE, and since it is difficult to frequently replace a battery of the UE, a very long battery lifetime, such as 10 to 15 years, may be required.

Finally, in the case of URLLC, it corresponds to a cellular-based wireless communication service used for a specific purpose (mission-critical). For example, services, etc. used for a remote control of a robot or machinery, industrial automation, an unmanned aerial vehicle, remote health care, an emergency alert, and the like may be considered. Therefore, communication provided by the URLLC should also provide very low latency and very high reliability. For example, a service that supports the URLLC should satisfy an air interface latency less than 0.5 milliseconds and has requirements of a packet error rate of 10⁻⁵ or less at the same time. Therefore, for the service that supports the URLLC, the 5G system may be required to provide a transmission time interval (TTI) smaller than other services, and at the same time, design matters for allocating a wide resource in a frequency band may be required to secure the reliability of the communication link.

Three services of 5G, which are the eMBB, the URLLC, and the mMTC, may be multiplexed and transmitted in one system. In this case, different transmission or reception techniques and transmission or reception parameters may be used between services in order to satisfy different requirements of respective services. Also, it is obvious that 5G is not limited to the three services described above.

[NR Time-Frequency Resources]

Hereinafter, a frame structure of the 5G system will be described in more detail with reference to the drawings.

FIG. 1 illustrates basic structure of a time-frequency domain that is a radio resource region in which data or a control channel is transmitted in a 5G system.

In FIG. 1, a horizontal axis represents a time domain, and a vertical axis represents a frequency domain. A basic unit of a resource in the time and frequency domains is a resource element (RE) 101, and may be defined to be 1 orthogonal frequency division multiplexing (OFDM) symbol 102 on the time axis and 1 subcarrier 103 on the frequency axis. N_{sc}^{RB} (e.g., 12) consecutive REs in the frequency domain may constitute one resource block (RB) 104.

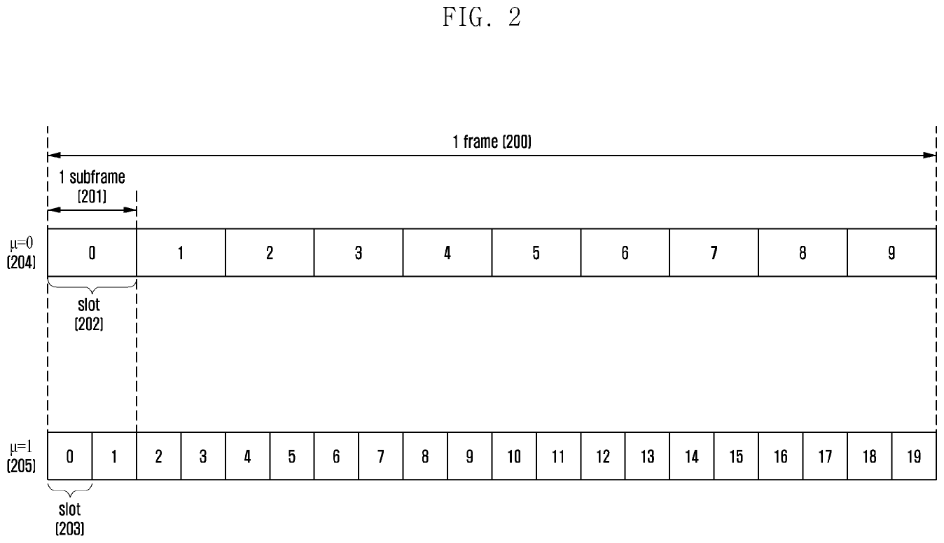

FIG. 2 illustrates frame, a subframe, and a slot structure in a wireless communication system according to an embodiment of the disclosure.

FIG. 2 illustrates an example of a structure of a frame 200, a subframe 201, and a slot 202. One frame 200 may be defined to be 10 ms. One subframe 201 may be defined to be 1 ms, and thus one frame 200 may be constituted with a total of 10 subframes 201. One slot 202, 203 may be defined as 14 OFDM symbols (that is, the number of symbols per slot (N_{symb}^{slot})=14). One subframe 201 may be constituted with one or a plurality of slots 202, 203, and the number of slots 202, 203 for one subframe 201 may vary according to configuration values p 204, 205 for subcarrier spacing. In an example of FIG. 2, a case where μ=0 204, and a case where μ=0.1 205 are illustrated as subcarrier spacing configuration values. In the case where μ=0 204, one subframe 201 may be constituted with one slot 202, and in the case where μ=1 205, one subframe 201 may be constituted with two slots 203. That is, the number (Nₛₗₒₜ^{subframe,μ}) of slots per subframe may vary according to the configuration value μ for the subcarrier spacing, and accordingly, the number (Nₛₗₒₜ^{frame,μ}) of slots per frame may vary. Nₛₗₒₜ^{subframe,μ} and Nₛₗₒₜ^{frame,μ} according to respective subcarrier spacing configurations p may be defined in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

[Bandwidth Part (BWP)]

Next, a bandwidth part (BWP) configuration in the 5G communication system will be described in detail with reference to the drawings.

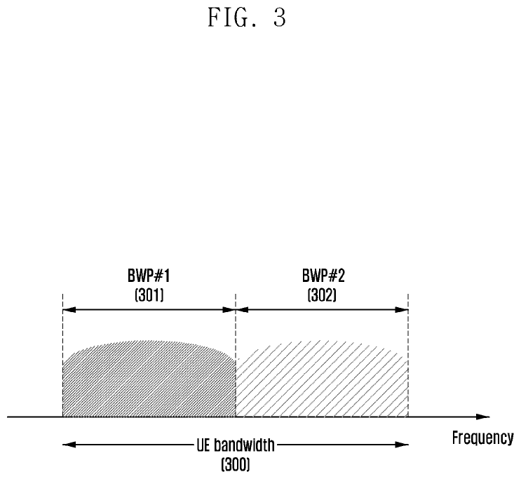

FIG. 3 illustrates an example of a configuration for a bandwidth part in a wireless communication system according to an embodiment of the disclosure.

FIG. 3 shows an example in which a UE bandwidth 300 is configured to have two bandwidth parts that are bandwidth part #1 301 and bandwidth part #2 302. A base station may configure one or a plurality of bandwidth parts for a UE, and may configure the following information as shown in Table 2 for each bandwidth part.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, n5}, |

(subcarrier spacing)

| | |
|---|---|
| cyclicPrefix | ENUMERATED { extended } |

(cyclic prefix)
}

It is obvious that the disclosure is not limited to the above example, and in addition to the above configuration information, various parameters related to the bandwidth part may be configured for a UE. The base station may transfer the information to the UE via upper layer signaling, for example, radio resource control (RRC) signaling. At least one bandwidth part among the configured one or a plurality of bandwidth parts may be activated. Whether or not the configured bandwidth part is activated may be transferred from the base station to the UE in a semi-static manner via RRC signaling or may be dynamically transferred via downlink control information (DCI).

According to some embodiments, the base station may configure an initial bandwidth part (BWP) for initial access, via a master information block (MIB), for the UE before an RRC connection. More specifically, in an initial access stage, the UE may receive configuration information for a search space and a control resource set (CORESET) in which PDCCH for receiving system information (may correspond to remaining system information (RMSI) or system information block 1 (SIB1)) required for initial access may be transmitted via the MIB. Each of the search space and the control resource set configured via the MIB may be considered as identity (ID) 0. The base station may notify the UE of configuration information, such as frequency allocation information, time allocation information, and numerology for control resource set #0, via the MIB. The base station may also notify the UE of configuration information for a monitoring period and occasion for control resource set #0, that is, the configuration information for search space #0, via the MIB. The UE may consider a frequency domain configured to control resource set #0, which is obtained from the MIB, as an initial bandwidth part for initial access. In this case, an identity (ID) of the initial bandwidth part may be considered to be 0.

The configuration of a bandwidth part supported by 5G may be used for various purposes.

According to some embodiments, in a case that a bandwidth supported by the UE is smaller than a bandwidth supported by a system bandwidth, this may be supported via the bandwidth part configuration. For example, the base station may configure a frequency location of the bandwidth part to the UE so that the UE may transmit or receive data at a specific frequency location within the system bandwidth.

According to some embodiments, for the purpose of supporting different numerologies, the base station may configure a plurality of bandwidth parts for the UE For example, in order to support both data transmission or reception using a subcarrier spacing of 15 kHz and a subcarrier spacing of 30 kHz for a certain UE, two bandwidth parts may be configured to subcarrier spacings of 15 kHz and 30 kHz, respectively. Different bandwidth parts may be frequency division multiplexed, and in the case that data is to be transmitted or received at a specific subcarrier spacing, a bandwidth part configured to the corresponding subcarrier spacing may be activated.

According to some embodiments, for the purpose of reducing power consumption of the UE, the base station may configure, for the UE, bandwidth parts having different bandwidth sizes. For example, in the case that the UE supports a very large bandwidth, for example, 100 MHz, and always transmits or receives data via the corresponding bandwidth, very large power consumption may occur. In particular, in a situation where there is no traffic, it may be very inefficient, in terms of power consumption, to perform monitoring for an unnecessary downlink control channel with a large bandwidth of 100 MHz. For the purpose of reducing the power consumption of the UE, the base station may configure, for the UE, a bandwidth part of a relatively small bandwidth, for example, a bandwidth part of 20 MHz. In the situation where there is no traffic, the UE may perform monitoring operation in the bandwidth part of 20 MHz, and in the case that data is generated, the UE may transmit or receive the data by using the bandwidth part of 100 MHz according to an indication of the base station.

In the method for configuring the bandwidth part, UEs before an RRC connection may receive configuration information for an initial bandwidth part via a master information block (MIB) in an initial access stage. More specifically, a UE may be configured with a control resource set (CORESET) for a downlink control channel via which downlink control information (DCI) for scheduling of a system information block (SIB) may be transmitted from an MIB of a physical broadcast channel (PBCH) A bandwidth of the control resource set configured via the MIB may be regarded as an initial bandwidth part, and the UE may receive a physical downlink shared channel (PDSCH) on which SIB is transmitted via the configured initial bandwidth part. In addition to the purpose of receiving the SIB, the initial bandwidth part may be used for other system information (OSI), paging, and random access.

[Change of Bandwidth Part (BWP)]

In a case that one or more BWPs are configured for a UE, a base station may indicate the UE to change (or switching, transition) a BWP by using a Bandwidth Part Indicator field in DCI. For example, in FIG. 3, in a case that the currently activated BWP of the UE is BWP #1 (301), the base station may indicate to the UE BWP #2 (302) as a bandwidth part indicator in DCI, and the UE may perform a BWP change to the BWP #2 (302) indicated by the bandwidth part indicator in the DCI.

As described above, since a BWP change based on DCI may be indicated by DCI scheduling a PDSCH or a PUSCH, in a case that a UE receives a BWP change request, the UE should transmit or receive the PDSCH or PUSCH scheduled by the corresponding DCI in a changed BWP within a certain time frame. To this end, a standard prescribes a requirement for a latency time interval (T_{BWP}) required for a BWP change, and the requirements may be defined, e.g., as shown below in Table 3.

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}:
Depends on UE capability.
Note 2:
If the BWP switch involves changing of SCS, the BWP switch delay is determined by the larger one between the SCS before BWP switch and the SCS after BWP switch.

The requirements for BWP change latency time interval may support type 1 or type 2 according to the UE capability. The UE may report a supportable type of BWP latency time interval to the base station.

According to the above requirements for BWP change latency time interval, in a case that the UE receives DCI including a BWP change indicator in slot n, the UE should complete changing to a new BWP indicated by the BWP change indicator no later than slot n+T_{BWP}, and transmit or receive a data channel scheduled by a corresponding DCI in the new changed BWP. In a case that the base station is to schedule a data channel in a new BWP, the base station may determine time domain resource allocation for the data channel in consideration of a BWP change latency time interval of the UE. That is, in a method of determining time domain resource allocation for a data channel, when the base station schedules the data channel in a new BWP, the data channel may be scheduled after a BWP change latency time interval. Accordingly, the UE may not expect that the DCI indicating the BWP change indicates a slot offset (K0 or K2) value smaller than the BWP change latency time interval (T_{BWP}).

If the UE receives the DCI (e.g., DCI format 1_1 or 0_1) indicating a BWP change, the UE may not perform any transmission or reception for the time interval corresponding from the third symbol of the slot that has received the PDCCH including a corresponding DCI to the start point of the slot indicated by the slot offset (K0 or K2) value indicated by the time domain resource allocation indicator field in the corresponding DCI. For example, if the UE has received the DCI indicating a BWP change in slot n, and the slot offset value indicated by the corresponding DCI is K, the UE may not perform any transmission or reception, starting from the third symbol of slot n to the previous symbol of slot n+K (that is, the last symbol of slot n+K−1).

[SS/PBCH Block]

In the following, a synchronization signal (SS)/PBCH block in 5G will be described.

The SS/PBCH block may refer to a physical layer channel block constituted with a primary SS (PSS), a secondary SS (SSS), and a PBCH. Detailed descriptions are as follows:
PSS: a signal that serves as a reference for downlink time/frequency synchronization and provides some information on a cell ID;
SSS: serving as a reference for downlink time/frequency synchronization, and providing remaining cell ID information that is not provided by a PSS. Additionally, the SSS may serve as a reference signal for demodulation of a PBCH;
PBCH: providing essential system information necessary for transmitting or receiving data channel and control channel of a UE. The essential system information may include search space-related control information indicating radio resource mapping information of a control channel, scheduling control information on a separate data channel for transmitting system information, and the like; and/or
SS/PBCH block: an SS/PBCH block is constituted with a combination of a PSS, an SSS, and a PBCH. One or a plurality of SS/PBCH blocks may be transmitted within 5 ms, and each transmitted SS/PBCH block may be distinguished by an index.

A UE may detect a PSS and an SSS in an initial access stage and may decode a PBCH. An MIB may be obtained from the PBCH, and control resource set (CORESET) #0 (which may correspond to a control resource set having a control resource set index of 0) may be configured therefrom. For example, the UE may perform monitoring on control resource set #0 while assuming that a selected SS/PBCH block and a demodulation reference signal (DMRS) transmitted in control resource set #0 are quasi-co-located (QCL) The UE may receive system information by using downlink control information transmitted in control resource set #0. The UE may acquire random access channel (RACH)-related configuration information required for initial access from the received system information. The UE may transmit a physical RACH (PRACH) to the base station in consideration of a selected SS/PBCH index, and the base station having received the PRACH may acquire information on an SS/PBCH block index selected by the UTE. The base station may know that the UE has selected a certain block from among respective SS/PBCH blocks and monitors control resource set #0 associated therewith.

[PDCCH: Related to DCI]

Next, downlink control information (DCI) in the 5G system will be described in detail.

In the 5G system, scheduling information on uplink data (or physical uplink data channel (PUSCH)) or downlink data (or physical downlink data channel (PDSCH)) is transferred from the base station to the UE via DCI. The UE may monitor a DCI format for fallback and a DCI format for non-fallback with respect to PUSCH or PDSCH The DCI format for fallback may be constituted with a fixed field predefined between the base station and the UE, and the DCI format for non-fallback may include a configurable field.

DCI may be transmitted through a physical downlink control channel (PDCCH) via channel coding and modulation. A cyclic redundancy check (CRC) is attached to a DCI message payload, and may be scrambled with a radio network temporary identifier (RNTI) corresponding to an identity of the UE. Different RNTIs may be used according to a purpose of the DCI message, for example, UE-specific data transmission, a power control command, a random access response, etc. That is, the RNTI is not explicitly transmitted, but is included in CRC calculation so as to be transmitted. When the DCI message transmitted on PDCCH is received, the UE performs a CRC identification by using an aligned RNTI and determines, if the CRC identification succeeds, that the message is addressed to the UE.

For example, DCI for scheduling of PDSCH for system information (SI) may be scrambled with an SI-RNTI. DCI for scheduling of PDSCH for a random access response (RAR) message may be scrambled with RA-RNTI. DCI for scheduling of PDSCH for a paging message may be scrambled with P-RNTI. DCI for notification of a slot format indicator (SFI) may be scrambled with SFI-RNTI. DCI for notification of a transmit power control (TPC) may be scrambled with TPC-RNTI. DCI for scheduling of UE-specific PDSCH or PUSCH may be scrambled with cell RNTI (C-RNTI).

DCI format 0_0 may be used for fallback DCI for scheduling of PUSCH, in which CRC may be scrambled with C-RNTI. DCI format 0_0 in which CRC is scrambled with C-RNTI may include, for example, the information in Table 4.

TABLE 4
- Identifier for DCI formats - [1] bit
- Frequency domain resource
assigment -[┌log ₂ (N_{RB}^{UL,BWP}(N_{RB}^{UL,BWP} +1)/2)┐ ] bits
- Time domain resource assignment - X bits
- Frequency hopping flag - 1 bit.
- Modulation and coding scheme - 5 bits
- New data indicator - 1 bit
- Redundancy version - 2 bits
- HARQ process number - 4 bits
- Transmit power control (TPC) command for scheduled PUSCH - [2] bits
- UL/supplementary (SUL) indicator - 0 or 1 bit

DCI format 0_1 may be used for non-fallback DCI for scheduling of PUSCH, in which CRC may be scrambled with C-RNTI. DCI format 0_1 in which CRC is scrambled with C-RNTI may include, for example, the information in Table 5.

```
TABLE 5
- Carrier indicator - 0 or 3 bits
- UL/SUL indicator - 0 or 1 bit
- Identifier for DCI formats - [1] bits
- Bandwidth part indicator - 0, 1 or 2 bits
- Frequency domain resource assignment
  • For resource allocation type 0, ┌N_{RB}^{UL,BWP}/P┐ bits
  • For resource allocation type 1, ┌log₂(N_{RB}^{UL,BWP}(N_{RB}^{UL,BWP} +1)/2)┐ bits
- Time domain resource assignment - 1, 2, 3, or 4 bits
- Virtual resource block (VRB)-to-physical resource block (PRB)
mapping - 0 or 1 bit, only for resource allocation type 1.
  • 0 bit if only resource allocation type 0 is configured;
  • 1 bit otherwise.
- Frequency hopping flag - 0 or 1 bit, only for resource allocation type 1.
  • 0 bit if only resource allocation type 0 is configured;
  • 1 bit otherwise.
- Modulation and coding scheme - 5 bits
- New data indicator - 1 bit
- Redundancy version - 2 bits
- HARQ process number - 4 bits
- 1st downlink assignment index - 1 or 2 bits
  • 1 bit for semi-static HARQ-ACK codebook (in a case of semi-static
HARQ-ACK codebook);
  • 2 bits for dynamic HARQ-ACK codebook with single HARQ-ACK
codebook (in a case of using dynamic HARQ-ACK codebook with single
HARQ-ACK codebook).
- 2nd downlink assignment index - 0 or 2 bits
  • 2 bits for dynamic HARQ-ACK codebook with two HARQ-ACK sub-
codebooks (in a case of using dynamic HARQ-ACK codebook with two
HARQ-ACK sub-codebooks);
  • 0 bit otherwise.
- TPC command for scheduled PUSCH - 2 bits
$- SRS resource indicator - ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$
  $\cdot ⌈ {log}_{2} ( {\sum }_{k = 1}^{{L}_{max}} ( \begin{matrix}{N}_{SRS} \\ k\end{matrix} ) ) ⌉ bits for non - codebook based PUSCH$
transmission (in a case that PUSCH transmission is not based on
codebook);
  • log₂┌(N_{SRS})┐ bits for codebook based PUSCH transmission (in a case
that PUSCH transmission is based on codebook).
- Precoding information and number of layers - up to 6 bits
- Antenna ports - up to 5 bits
- SRS request - 2 bits
- Channel state information (CSI) request - 0, 1, 2, 3, 4, 5, or 6 bits
- Code block group (CBG) transmission information - 0, 2, 4, 6, or 8 bits
- Phase tracking reference signal (PTRS)- Demodulation reference signal
(DMRS) association - 0 or 2 bits.
- beta_offset indicator - 0 or 2 bits
- DMRS sequence initialization - 0 or 1 bit
```

DCI format 1_0 may be used for fallback DCI for scheduling of PDSCH, in which CRC may be scrambled with C-RNTI. DCI format 1_0 in which CRC is scrambled with C-RNTI may include, for example, the information in Table 6.

TABLE 6

Identifier for DCI formats - [1] bit
Frequency domain resource assignment -
[┌log₂(N_{RB}^{DL, BWP}(N_{RB}^{DL, BWP} + 1)/2┐] bits
Time domain resource assignment - X bits
VRB-to-PRB mapping - 1 bit.
Modulation and coding scheme - 5 bits
New data indicator - 1 bit
Redundancy version - 2 bits
HARQ process number - 4 bits
Downlink assignment index - 2 bits
TPC command for scheduled PUCCH - [2] bits
PUCCH resource indicator - 3 bits
PDSCH-to-HARQ feedback timing indicator - [3] bits

DCI format 1_1 may be used for non-fallback DCI for scheduling of PUSCH, in which CRC may be scrambled with C-RNTI. DCI format 1_1 in which CRC is scrambled with C-RNTI may include, for example, the information in Table 7.

TABLE 7
Carrier indicator - 0 or 3 bits
Identifier for DCI formats - [1] bits
BWP indicator - 0, 1 or 2 bits
Frequency domain resource assignment
For resource allocation type 0,
┌N_{RB}^{DL, BWP}/P┐ bits
For resource allocation type 1,
┌log₂(N_{RB}^{DL, BWP} (N_{RB}^{DL, BWP} + 1)/2)┐ bits
Time domain resource assignment -1, 2, 3, or 4 bits
VRB-to-PRB mapping - 0 or 1 bit, only for resource allocation type 1.
0 bit if only resource allocation type 0 is configured;
1 bit otherwise.
Physical resource block (PRB) bundling size indicator - 0 or 1 bit
Rate matching indicator - 0, 1, or 2 bits
Zero power (ZP) channel state information (CSI)-
reference signal (RS) trigger - 0, 1, or 2 bits
For transport block 1(in a case of first transport block):
Modulation and coding scheme - 5 bits
New data indicator - 1 bit
Redundancy version - 2 bits
For transport block 2 (in a case of second transport block):
Modulation and coding scheme - 5 bits
New data indicator - 1 bit
Redundancy version - 2 bits
HARQ process number - 4 bits
Downlink assignment index - 0 or 2 or 4 bits
TPC command for scheduled PUCCH - 2 bits
PUCCH resource indicator - 3 bits
PDSCH-to-HARQ_feedback timing indicator - 3 bits
Antenna ports - 4, 5 or 6 bits
TCI - 0 or 3 bits
SRS request - 2 bits
CBG transmission information - 0, 2, 4, 6, or 8 bits
Code block group (CBG) flushing out information - 0 or 1 bit
DMRS sequence initialization - 1 bit

[PDCCH: CORESET, REG, CCE, Search Space]

Hereinafter, a downlink control channel in the 56 communication system will be described in more detail with reference to the drawings.

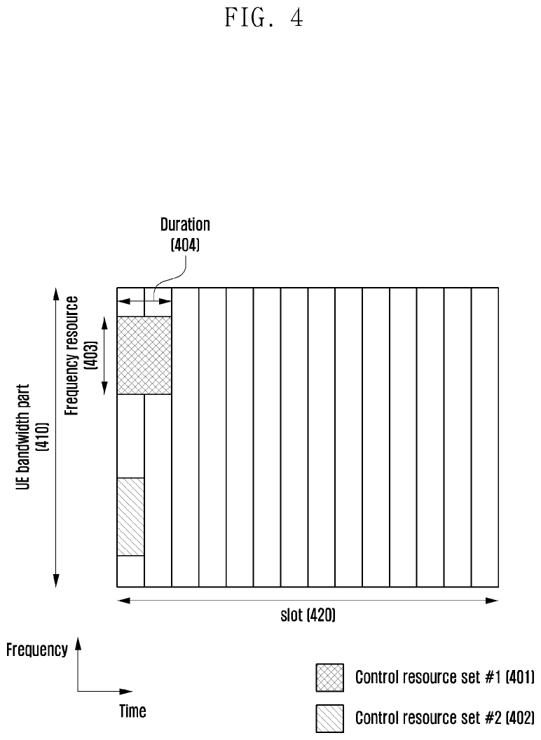

FIG. 4 illustrates an example of a control resource set (CORESET) at which a downlink control channel is transmitted in the 5G wireless communication system. FIG. 4 illustrates an example in which a bandwidth part 410 of a UE (WE bandwidth part) is configured on the frequency axis, and two control resource sets (control resource set #1 401, control resource set #2 402) are configured within one slot 420 on the time axis. The control resource sets 401, 402 may be configured for a specific frequency resource 403 within the entire E bandwidth part 410 on the frequency axis. The control resource set may be configured as one or a plurality of OFDM symbols on the Lime axis, which may be defined as a control resource set duration 404 With reference to the example illustrated in FIG. 4, control resource set #1 401 is configured to be a control resource set duration of 2 symbols, and control resource set #2 402 is configured to be a control resource set duration of symbol.

The above-described control resource sets in 5G may be configured for a UE by a base station via upper layer signaling (e.g., system information, master information block (MIB) radio resource control (RRC) signaling). Configuring a control resource set for a UE refers to providing information, such as an identity of the control resource set, a frequency location of the control resource set, and a symbol length of the control resource set. Configuration information for a control resource set may include, for example, the information in Table 8.

TABLE 8

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(Identity of control resource set)

| | |
|---|---|
| frequencyDomainResources | BIT STRING (SIZE (45)), |

(resource allocation information on frequency axis)

| | |
|---|---|
| duration | INTEGER (1..maxCoReSetDuration), |

(resource allocation information on time axis)

| | |
|---|---|
| cce-REG-MappingType | CHOICE { |

(CCE-to-REG mapping scheme)

| | |
|---|---|
| interleaved | SEQUENCE { |
| reg-BundleSize | ENUMERATED {n2, n3, n6}, |

(REG bundle size)

| | |
|---|---|
| precoderGranularity | ENUMERATED {sameAsREG-bundle, |

allContiguousRBs},

| | |
|---|---|
| interleaverSize | ENUMERATED {n2, n3, n6} |

```
            (interleaver size)
            shiftIndex
      INTEGER(0..maxNrofPhysicalResourceBlocks−1)
      OPTIONAL
          (interleaver shift)
    },
```

| | |
|---|---|
| nonInterleaved | NULL |

},

| | |
|---|---|
| tci-StatesPDCCH | SEQUENCE(SIZE (1..maxNrofTCI- |
| StatesPDCCH)) OF TCI-StateId | OPTIONAL, |

(QCL configuration information)

| | |
|---|---|
| tci-PresentInDCI | ENUMERATED {enabled} |

OPTIONAL, -- Need S
}

In Table 8, tci-StatesPDCCH (simply, referred to as a transmission configuration indication (TCI) state) configuration information may include information on one or a plurality of synchronization signal (SS)/physical broadcast channel (PBCH) block indices or channel state information reference signal (CSI-RS) indices having the quasi-co-location (QCL) relationship with a DMRS transmitted in the corresponding control resource set.

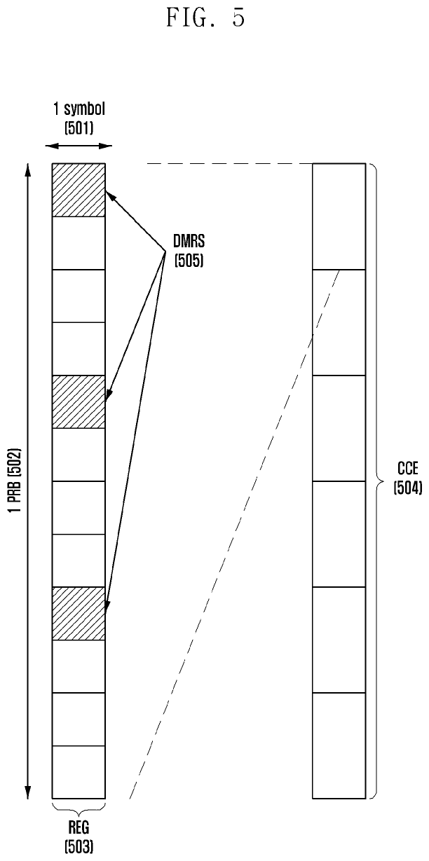

FIG. 5 illustrates an example of a basic unit of time and frequency resources constituting a downlink control channel which may be used in 5G. According to FIG. 5, a basic unit of time and frequency resources constituting a control channel may be referred to as a resource element group (REG) 503, and the REG 503 may be defined as 1 OFDM symbol 501 on the time axis and 1 physical resource block (PRB) 502 on the frequency axis, that is, 12 subcarriers. A base station may constitute a downlink control channel allocation unit by concatenating the REG 503.

As illustrated in FIG. 5, in a case that a basic unit for assignment of a downlink control channel in 5G is a control channel element (CCE) 504, 1 CCE 504 may be constituted with a plurality of REGs 503. Taking the REG 503 illustrated in FIG. 5 as an example, the REG 503 may constitute 12 REs, and if, 1 CCE 504 is constituted with, for example, 6 REGs 503, 1 CCE 504 may be constituted with 72 REs. When a downlink control resource set is configured, a corresponding region may be constituted with a plurality of CCEs 504, and a specific downlink control channel may be mapped to one or a plurality of CCEs 504 so as to be transmitted according to an aggregation level (AL) within the control resource set. The CCEs 504 within the control resource set are classified by numbers, and the numbers of the CCEs 504 may be assigned according to a logical mapping scheme.

The basic unit of the downlink control channel illustrated in FIG. 5, that is, the REG 503, may include both REs, to which DCI is mapped, and a region, to which a DMRS 505 that is a reference signal for decoding the REs, is mapped. As illustrated in FIG. 5, 3 DMRSs 505 may be transmitted within 1 REG 503. The number of CCEs required to transmit PDCCH may be 1, 2, 4, 8, or 16 depending on the aggregation level (AL), and the different numbers of CCEs may be used to implement link adaptation of the downlink control channel. For example, in a case that AL=L, one downlink control channel may be transmitted via the L number of CCEs. A UE needs to detect a signal without knowing information on the downlink control channel, wherein a search space representing a set of CCEs is defined for blind decoding. The search space is a set of downlink control channel candidate groups including CCEs, for which the UE needs to make an attempt of decoding on a given aggregation level. Since there are various aggregation levels that make one bundle with 1, 2, 4, 8, or 16 CCEs, the UE may have a plurality of search spaces. A search space set may be defined as a set of search spaces at all configured aggregation levels.

The search space may be classified into a common search space and a UE-specific search space. A certain group of UEs or all UEs may monitor a common search space of PDCCH in order to receive cell-common control information, such as a dynamic scheduling or paging message for system information. For example, PDSCH scheduling assignment information for transmission of an SIB including cell operator information, etc. may be received by monitoring the common search space of PDCCH. In the case of the common search space, the certain group of UEs or all UEs need to receive PDCCH, and may thus be defined as a set of previously agreed CCEs. Scheduling assignment information for UE-specific PDSCH or PUSCH may be received by monitoring a UE-specific search space of PDCCH. The UE-specific search space may be defined UE-specifically on the basis of an identity of the UE and functions of various system parameters.

In 5G, a parameter for the search space of PDCCH may be configured from the base station to the UE via upper layer signaling (e.g., SIB, MIB, and RRC signaling). For example, the base station may configure, to the UE, the number of PDCCH candidate groups at each aggregation level L, a monitoring period for a search space, a monitoring occasion per symbol in a slot for the search space, a search space type (common search space or UE-specific search space), a combination of an RNTI and a DCI format, which is to be monitored in the search space, a control resource set index for monitoring of the search space, etc. Configuration information on the search space for the PDCCH may include, for example, information in Table 9.

TABLE 9

| | |
|---|---|
| SearchSpace ::= | SEQUENCE { |

-- Identity of the search space. SearchSpaceId = 0 identifies the SearchSpace configured via
PBCH (MIB) or ServingCellConfigCommon.

| | |
|---|---|
| searchSpaceId | SearchSpaceId, |

(search space identifier)

| | |
|---|---|
| controlResourceSetId | ControlResourceSetId, |

(control resource set identifier)

| | |
|---|---|
| monitoringSlotPeriodicityAndOffset | CHOICE { |

(monitoring slot level period)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

```
      }
            OPTIONAL,
```

| | |
|---|---|
| duration (monitoring length) | INTEGER (2..2559) |
| monitoringSymbolsWithinSlot | BIT STRING (SIZE (14)) |

```
              OPTIONAL,
  (monitoring symbol within slot)
```

| | |
|---|---|
| nrofCandidates | SEQUENCE { |

(number of PDCCH candidates at each aggregation level)

| | |
|---|---|
| aggregationLevel1 | ENUMERATED {n0, n1, n2, n3, n4, n5, n6, |

n8},

| | |
|---|---|
| aggregationLevel2 | ENUMERATED {n0, n1, n2, n3, n4, n5, n6, |

n8},

| | |
|---|---|
| aggregationLevel4 | ENUMERATED {n0, n1, n2, n3, n4, n5, n6, |

n8},

| | |
|---|---|
| aggregationLevel8 | ENUMERATED {n0, n1, n2, n3, n4, n5, n6, |

n8},

| | |
|---|---|
| aggregationLevel16 | ENUMERATED {n0, n1, n2, n3, n4, n5, n6, |

n8}
},

| | |
|---|---|
| searchSpaceType | CHOICE { |

```
      (search space type)
        -- Configures this search space as common search space (CSS) and DCI formats to
monitor.
```

| | |
|---|---|
| common | SEQUENCE { |

```
      (common search space)
    }
```

| | |
|---|---|
| ue-Specific | SEQUENCE { |

```
      (UE-specific search space)
          -- Indicates whether the UE monitors in this USS for DCI formats 0-0 and
1-0 or for formats 0-1 and 1-1.
```

| | |
|---|---|
| formats | ENUMERATED {formats0-0-And-1-0, |

```
formats0-1-And-1-1},
          ...
        }
```

According to the configuration information, the base station may configure one or a plurality of search space sets for the UE. According to some embodiments, the base station may configure search space set 1 and search space set 2 to the TIE, may configure DCI format A, which is scrambled with X-RNTI in search space set 1, to be monitored in the common search space, and may configure DCI format B, which is scrambled with Y-RNTI in search space set 2, to be monitored in the UE-specific search space.

According to the configuration information, one or a plurality of search space sets may exist in the common search space or the UE-specific search space. For example, search space set #1 and search space set #2 may be configured to be the common search space, and search space set #3 and search space set #4 may be configured to be the UE-specific search space.

In the common search space, the following combinations of DCI formats and RNTIs may be monitored. It is obvious that the disclosure is not limited to the following examples.
DCI format 0_0/1_0 with CRC scrambled by C-RNTI, CS-RNTI, SP-CSI-RNTI, RA-RNTI, TC-RNTI, P-RNTI, SI-RNTI;
DCI format 2_0 with CRC scrambled by SFI-RNTI;
DCI format 2_1 with CRC scrambled by INT-RNTI;
DCI format 2_2 with CRC scrambled by TPC-PUSCH-RNTI, TPC-PUCCH-RNTI; and/or
DCI format 2_3 with CRC scrambled by TPC-SRS-RNTI.

In the UE-specific search space, the following combinations of DCI formats and RNTIs may be monitored. It is also obvious that the disclosure is not limited to the following examples
DCI format 0_0/1_0 with CRC scrambled by C-RNTI, CS-RNTI, TC-RNTI; and/or
DCI format 1_0/1_1 with CRC scrambled by C-RNTI, CS-RNTI, TC-RNTI.

The RNTIs specified above may comply with the following definition and purpose:
C-RNTI (Cell RNTI): used for UE-specific PDSCH scheduling;
TC-RNTI (Temporary Cell RNTI): used for UE-specific PDSCH scheduling;
CS-RNTI(Configured Scheduling RNTI): used for semi-statically configured UE-specific PDSCH scheduling;
RA-RNTI (Random Access RNTI): used for scheduling PDSCH at random access stage;
P-RNTI (Paging RNTI): used for scheduling PDSCH through which paging is transmitted;
SI-RNTI (System Information RNTI): used for scheduling PDSCH through which system information is transmitted,
INT-RNTI (Interruption RNTI): used for indicating whether puncturing is performed for PDSCH;
TPC-PUSCH-RNTI (Transmit Power Control for PUSCH RNTI): used for indicating PUSCH power control command;
TPC-PUCCH-RNTI (Transmit Power Control for PUCCH RNTI): used for indicating PUCCH power control command; and/or
TPC-SRS-RNTI (Transmit Power Control for SRS RNTI): used for indicating SRS power control command.

The above-described DCI formats may comply with the following definition.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH |
| | and PUSCH |
| 2_3 | Transmission of a group of TPC commands for |
| | SRS transmissions by one or more UEs |

In 5G, a search space of aggregation level L in control resource set p and search space set s may be expressed as Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad [ Equation 1 ]$$

L: aggregation level;
n_{CI}: Carrier index;
N_{CCE,p}: the total number of CCEs existing in control resource set p;
n_{s,f}^{μ}: slot index;
M_{s,max}^{(L)}: the number of PDCCH candidate groups at aggregation level L;
m_{s,n}_{_{CI}}=0, . . . , M_{s,max}^{(L)}−1: index of a PDCCH candidate group at aggregation level L;
i=0, . . . , L−1;
Y_{p,n}_{^{μ}}_{_{s,f}}=(Aₚ·Y_{p,n}_{^{μ}}_{_{s,f}}_{^{−1}}) mod D, Y_{p,-1}=n_{RNTI}≠0, Aₚ=39827 for pmod3=0, Aₚ=39829 for pmod3=1, Aₚ=39839 for pmod3=2, D=65537; and
n_{RNTI}: UE identity.

A value of Y_{p,n}_{^{μ}}_{_{s,f}} may correspond to 0 in the case of the common search space.

In the case of the UE-specific search space, a value of Y_{p,n}_{^{μ}}_{_{s,f}} may correspond to a value that varies depending on a time index and the identity (ID configured for the UE by C-RNTI or the base station) of the UE.

In 5G, a plurality of search space sets may be configured by different parameters (e.g., parameters in Table 9), and therefore a set of search spaces monitored by the UE at each point in time may vary. For example, in a case that search space set #1 is configured in an X-slot cycle, search space set #2 is configured in a Y-slot cycle, and X and Y are different from each other, the UE may monitor both search space set #1 and search space set #2 in a specific slot, and may monitor one of search space set #1 and search space set #2 in a specific slot.

[PDCCH: BD/CCE Limit]

In a case that a plurality of search space sets is configured to the UE, the following conditions may be considered for a method of determining a search space set required to be monitored by the UE.

If the UE is configured with a value of monitoringCapabilityConfig-r16, which is upper layer signaling, via r15monitoringcapability, the UE may define, for each slot, a maximum value for the number of PDCCH candidate groups that may be monitored and for the number of CCEs constituting the entire search space (here, the entire search space may refer to all CCE sets corresponding to a union region of a plurality of search space sets), and if a value of monitoringCapabilityConfig-r16 is configured via r16monitoringcapability, the UE may define, for each span, a maximum value for the number of PDCCH candidate groups that may be monitored and for the number of CCEs constituting the entire search space (here, the entire search space may refer to all CCE sets corresponding to a union region of a plurality of search space sets).

[Condition 1: Limiting the Maximum Number of PDCCH Candidate Groups]

As described above, according to a configuration value of upper layer signaling, Mμ, which is the maximum number of PDCCH candidate groups that may be monitored by the UE, may, for example, conform to Table 11 below in a case defined based on slot, and may conform to Table 12 below in a case defined based on span, in a cell configured with a subcarrier spacing of 15·2^{μ} kHz.

TABLE 11

| | Maximum number of PDCCH candidates |
|---|---|
| μ | per slot and per serving cell (M^{μ}) |
| 0 | 44 |
| 1 | 36 |
| 2 | 22 |
| 3 | 20 |

TABLE 12

| | Maximum number M^{μ} of monitored PDCCH | | |
|---|---|---|---|
| | candidates per span for combination (X, Y) | | |
| | and per serving cell | | |
| μ | (2, 2) | (4, 3) | (7, 3) |
| 0 | 14 | 28 | 44 |
| 1 | 12 | 24 | 36 |

[Condition 2: Limiting the Maximum Number of CCEs]

As described above, according to a configuration value of the upper layer signaling, Cμ, which is the maximum number of CCEs constituting the entire search space (here, the entire search space may refer to all CCE sets corresponding to a union region of a plurality of search space sets), may, for example, conform to Table 13 below in a case defined based on slot, and may conform to Table 14 below in a case defined based on span, in a cell configured with a subcarrier spacing of 15·2^{μ} kHz.

TABLE 13

| | Maximum number of non-overlapped CCEs per slot |
|---|---|
| μ | and per serving cell (C^{μ}) |
| 0 | 56 |
| 1 | 56 |
| 2 | 48 |
| 3 | 32 |

TABLE 14

| | Maximum number C^{μ} of non-overlapped | | |
|---|---|---|---|
| | CCEs per span for combination (X, Y) and | | |
| | per serving cell | | |
| μ | (2, 2) | (4, 3) | (7, 3) |
| 0 | 18 | 36 | 56 |
| 1 | 18 | 36 | 56 |

For the convenience of description, a situation in which both conditions 1 and 2 are satisfied at a specific point in time is defined as “condition A.” Therefore, not satisfying condition A may refer to not satisfying at least one of conditions 1 and 2.

[PDCCH: Overbooking]

According to configurations of the search space sets from the base station, a case in which condition A is not satisfied at a specific time point may occur. In a case that condition A is not satisfied at a specific time point, the UE may select and monitor only some of search space sets configured to satisfy condition A at the corresponding time point, and the base station may transmit PDCCH in the selected search space sets.

A method of selecting some search spaces from among all the configured search space sets may conform to the following method.

In a case that condition A for PDCCH is not satisfied at a specific time point (slot), the UE (or base station) may select a search space set, in which a search space type is configured to be a common search space, preferentially over a search space set configured to be a UE-specific search space, from among search space sets existing at the corresponding time point.

In a case that all the search space sets configured to be the common search space are selected (that is, in a case that condition A is satisfied even after all the search spaces configured to be the common search space are selected), the UE (or base station) may select the search space sets configured to be the UE-specific search space. In this case, in a case that there is a plurality of search space sets configured to be the UE-specific search spaces, a search space set having a low search space set index may have a higher priority. The UE (or base station) may select, in consideration of priority, UE-specific search space sets within a range in which condition A is satisfied.

[Related to Rate Matching/Puncturing]

Hereinafter, a rate matching operation and a puncturing operation are described in detail.

In a case that a time at which a predetermined symbol sequence A is transmitted and frequency resources A overlap a predetermined time and frequency resources B, a rate matching or puncturing operation may be considered as a transmission/reception operation of a channel A considering of resource C in an area in which the resource A and the resource B overlap each other. A detailed operation may follow the content below.

Rate Matching Operation

A base station may map and transmit a channel A only for the remaining resource areas except for the resource C corresponding to the area in which the entire resources A for transmitting the symbol sequence A to the UE overlap the resource B For example, in a case that a symbol sequence A is constituted with {symbol #1, symbol #2, symbol #3, symbol #4}, the resources A are {resource #1, resource #2, resource #3, resource #4}, and the resources B are {resource #3, resource #5}, the base station may sequentially map the symbol sequence A to the remaining resources {resource #1, resource #2, resource #4} except for {resource #3} corresponding to the resources C among the resources A and transmit the same. As a result, the base station may map the symbol sequence {symbol #1, symbol #2, symbol #3} to {resource #1, resource #2, resource #4}, respectively, and transmit the same.

The UE may determine the resources A and the resources B based on scheduling information for the symbol sequence A from the base station and determine the resources C in the area in which the resources A and the resources B overlap each other. The UE may receive the symbol sequence A based on the assumption that the symbol sequence A is mapped to and transmitted in the remaining areas except for the resources C among the entire resources A. For example, in a case that the symbol sequence A is constituted with {symbol #1, symbol #2, symbol #3, symbol #4}, the resources A are {resource #1, resource #2, resource #3, resource #4}, and the resources B are {resource #3, resource #5}, the UE may receive the symbol sequence A based on the assumption that the symbol sequence A is sequentially mapped to the remaining resources {resource #1, resource #2, resource #4} except for {resource #3} corresponding to the resources C among the resources A As a result, the UE may perform a series of reception operation later based on the assumption that the symbol sequence {symbol #1, symbol #2, symbol #3} is mapped to and transmitted in {resource #1, resource #2, resource #4}, respectively.

Puncturing Operation

In a case that there are resources C corresponding to an area in which the entire resources A for transmitting the symbol sequence A to the UE overlap the resources B, the base station may map the symbol sequence A to all the resources A, but may perform transmission only in the remaining resource areas except for the resources C among the resources A without transmission in a resource area corresponding to the resources C. For example, in a case that the symbol sequence A is constituted with {symbol #1, symbol #2, symbol #3, symbol #4}, the resources A are {resource #1, resource #2, resource #3, resource #4}, and the resources B are {resource #3, resource #5}, the base station may map the symbol sequence A {symbol #1, symbol #2, symbol #3, symbol #4} to the resources A {resource #1, resource #2, resource #3, resource #4}, respectively, and transmit only the symbol sequence {symbol #1, symbol #2, symbol #4} corresponding to the remaining resources {resource #1, resource #2, resource #4} except for {resource #3} corresponding to the resources C among the resources A without transmission of {symbol #3} mapped to {resource #3} corresponding to the resources C. As a result, the base station may map the symbol sequence {symbol #1, symbol #2, symbol #4} to {resource #1, resource #2, resource #4}, respectively, and transmit the same.

The UE may determine the resources A and the resources B based on scheduling information for the symbol sequence A from the base station and determine the resources C in the area in which the resources A and the resources B overlap each other. The UE may receive the symbol sequence A based on the assumption that the symbol sequence A is mapped to the entire resources A but is transmitted only in the remaining areas except for the resources C among the resources A. For example, in a case that the symbol sequence A is constituted with {symbol #1, symbol #2, symbol #3, symbol #4}, the resources A are {resource #1, resource #2, resource #3, resource #4}, and the resources B are {resource #3, resource #5}, the UE may assume that the symbol sequence A {symbol #1, symbol #2, symbol #3, symbol #4} is mapped to the resources A {resource #1, resource #2, resource #3, resource #4}, respectively, but {symbol #3} mapped to {resource #3} corresponding to the resources C is not transmitted, and may perform reception on the basis the assumption that the symbol sequence {symbol #1, symbol #2, symbol #4} corresponding to the remaining resources {resource #1, resource #2, resource #4} except for {resource #3} corresponding to the resources C among the resources A is mapped and transmitted. As a result, the UE may perform a series of reception operation later based on the assumption that the symbol sequence {symbol #1, symbol #2, symbol #4} is mapped to and transmitted in {resource #1, resource #2, resource #4}, respectively.

Hereinafter, a method of configuring a rate matching resource for the purpose of rate matching in a 5G communication system will be described. Rate matching means that the size of a signal is controlled in consideration of amounts of resources capable of transmitting the signal. For example, the rate matching of a data channel may mean that the size of data is controlled accordingly without mapping and transmitting the data channel for a specific time and a frequency resource region.

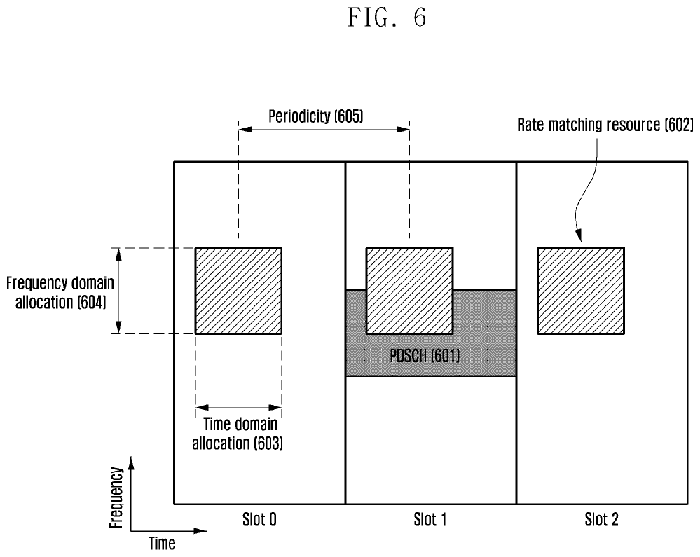

FIG. 6 illustrates a method by which a base station and a terminal transmit and receive data based on a downlink data channel and a rate matching resource according to an embodiment of the disclosure.

In FIG. 6, a downlink data channel (PDSCH) 601 and a rate matching resource 602 are illustrated. A base station may configure one or a plurality of rate matching resources 602 in the UE through upper layer signaling (for example, RRC signaling). Configuration information of the rate matching resource 602 may include time-axis resource allocation information 603, frequency-axis resource allocation information 604, and period information 605. Hereinafter, a bitmap corresponding to the frequency-axis resource allocation information 604 is called a “first bitmap”, a bitmap corresponding to the time-axis resource allocation information 603 is called a “second bitmap”, and a bitmap corresponding to the period information 605 is called a “third bitmap”. In a case that all or some of the time and frequency resources of the scheduled data channel 601 overlap the configured rate matching resource 602, the base station may match and transmit the data channel 601 in the part of the rate matching resource 602, and the UE may perform reception and decoding based on the assumption that the data channel 601 is rate-matched in the part of the rate matching resource 602.

The base station may dynamically notify the UE of whether to rate match the data channel in the configured rate matching resource part through an additional configuration (corresponding to a “rate matching indicator” in the above-described DCI format). Specifically, the base station may select some of the configured rate matching resources, group the selected rate matching resources into a rate matching resource group, and inform the UE of whether to perform rate matching on the data channel for each rate matching resource group through DCI using a bitmap scheme. For example, in a case that 4 rate matching resources, RMR #1, RMR #2, RMR #3, and RMR #4 are configured, the base station may configure rate matching groups RMG #1={RMR #1, RMR #2} and RMG #2={RMR #3, RMR #4}, and inform the UE of whether to perform rate matching in each of RMG #1 and RMG #2 by using 2 bits within a DCI field. For example, the base station may configure each bit as “1” in a case that rate matching is needed, and configure each bit as “0” in a case that rate matching is not needed.

In the 5G, granularity at an “RB symbol level” and an “RE level” is supported as a method of configuring the rate matching resource in the UE. More specifically, the following configuration method may be used.

RB Symbol Level

The UE may receive a configuration of a maximum of 4 RateMatchPatterns for each BWP through upper layer signaling, and one RateMatchPattern may include the following content.

As reserved resources within a BWP, resources in which time and frequency resource areas of the corresponding reserved resources are configured by a combination of a bitmap at an RB level and a bitmap at a symbol level in the frequency axis may be included. The reserved resources may span one or two slots. A time domain pattern (periodicityAndPattern) in which the time and frequency domains constituted with a pair of bitmaps at the RB level and the symbol level are repeated may be additionally configured.

Time and frequency domain resource areas configured as a control resource set within a 3WP and a resource area corresponding to a time domain pattern configured by a search space configuration in which the corresponding resource areas are repeated may be included.

RE Level

The UE may receive a configuration of the following content through upper layer signaling.

As configuration information (lte-CRS-ToMatchAround) for REs corresponding to a LTE cell-specific reference signal or common reference signal (CRS) pattern, the number of LTE CSR ports (nrofCRS-Ports), values of LTE-CRS-vshift(s) (v-shift), information on a center subcarrier location (carrierFreqDL) of an LTE carrier from a frequency point that is a reference (for example, reference point A), information on a bandwidth size of an LTE carrier (carrierBandwidthDL), subframe configuration information (mbsfn-SubframConfigList) corresponding to a multicast-broadcast single-frequency network (MBSFN), and the like. The UE may determine the location of the CRS within the NR slot corresponding to the LTE subframe based on the above-described information.

Configuration information for a resource set corresponding to one or a plurality of zero power (ZP) CSI-RSs within the BWP may be included.

[Related to LTE CRS Rate Match]

Next, the rate match process for the above-described LTE CRS will be described in detail. For the coexistence of long term evolution (LTE) and a new radio (NR) (LTE-NR Coexistence), a NR provides a function of configuring a cell specific reference signal (CRS) pattern of LTE to an NR terminal. More specifically, the CRS pattern may be provided by RRC signaling including at least one parameter in ServingCellConfig IE (Information Element) or ServingCellConfigCommon IE. Examples of the parameter may include lte-CRS-ToMatchAround, lte-CRS-PatternList1-r16, lte-CRS-PatternList2-r16, crs-RateMatch-PerCORESETPoolIndex-r16, and the like.

Rel-15 NR provides a function in which one CRS pattern can be configured per serving cell through the lte-CRS-ToMatchAround parameter. In Rel-16 NR, the above function has been extended to enable configuration of a plurality of CRS patterns per serving cell. More specifically, one CRS pattern per one LTE carrier may be configured in a single-transmission and reception point (TRP) configuration terminal, and two CRS patterns per one LTE carrier may be configured in a multi-TRP configuration terminal. For example, in the single-TRP configuration terminal, up to three CRS patterns per serving cell can be configured through the lte-CRS-PatternList1-r16 parameter. For another example, a CRS may be configured for each TRP in the multi-TRP configuration terminal. That is, the CRS pattern for TRP1 may be configured through the lte-CRS-PatternList1-r16 parameter, and the CRS pattern for TRP2 may be configured through the lte-CRS-PatternList2-r16 parameter. On the other hand, in a case that two TRPs are configured as described above, whether to apply both the CRS patterns of TRP1 and TRP2 to a specific physical downlink shared channel (PDSCH) or whether to apply only the CRS pattern for one TRP is determined through crs-RateMatch-PerCORESETPoolIndex-r16 parameter. If the crs-RateMatch-PerCORESETPoolIndex-r16 parameter is configured as enabled, only the CRS pattern of one TRP is applied, and in other cases, all CRS patterns of both TRPs are applied.

Table 15 shows the ServingCellConfig IE including the CRS pattern, and Table 16 shows the RateMatchPatternLTE-CRS IE including at least one parameter for the CRS pattern.

TABLE 15
ServingCellConfig ::= SEQUENCE {
tdd-UL-DL-ConfigurationDedicated TDD-UL-DL-ConfigDedicated
OPTIONAL, -- Cond TDD

| | |
|---|---|
| initialDownlinkBWP BWP-DownlinkDedicated | OPTIONAL, -- |

```
Need M
  downlinkBWP-ToReleaseList SEQUENCE (SIZE (1..maxNrofBWPs)) OF BWP-Id
OPTIONAL, -- Need N
  downlinkBWP-ToAddModList SEQUENCE (SIZE (1..maxNrofBWPs)) OF BWP-
Downlink  OPTIONAL, -- Need N
```

| | |
|---|---|
| firstActiveDownlinkBWP-Id BWP-Id | OPTIONAL, -- Cond |

```
SyncAndCellAdd
  bwp-InactivityTimer ENUMERATED {ms2, ms3, ms4, ms5, rns6, ms8, ms10,
ms20, ms30,
      ms40,ms50, ms60, ms80,ms100, ms200,ms300, ms500,
      ms750, ms1280, ms1920, ms2560, spare10, spare9, spare8,
      spare7, spare6, spare5, spare4, spare3, spare2, spare1 } OPTIONAL, --
Need R
```

| | |
|---|---|
| defaultDownlinkBWP-Id BWP-Id | OPTIONAL, -- Need S |
| uplinkConfig UplinkConfig | OPTIONAL, -- Need M |
| supplementaryUplink UplinkConfig | OPTIONAL, -- Need M |

```
  pdcch-ServingCellConfig SetupRelease { PDCCH-ServingCellConfig }
OPTIONAL, -- Need M
  pdsch-ServingCellConfig SetupRelease { PDSCH-ServingCellConfig }
OPTIONAL, -- Need M
```

| | |
|---|---|
| csi-MeasConfig SetupRelease { CSI-MeasConfig } | OPTIONAL, -- |

```
Need M
  sCellDeactivationTimer ENUMERATED {ms20, ms40, ms80, ms160, ms200,
ms240,
      ms320, ms400, ms480, ms520, ms640, ms720,
      ms840, ms1280, spare2,spare1} OPTIONAL, -- Cond
ServingCellWithoutPUCCH
  crossCarrierSchedulingConfig CrossCarrierSchedulingConfig
OPTIONAL, -- Need M
  tag-Id TAG-Id,
```

| | |
|---|---|
| dummy ENUMERATED {enabled} | OPTIONAL, -- Need R |

pathlossReferenceLinking ENUMERATED {spCell, sCell}
OPTIONAL, -- Cond SCellOnly

| | |
|---|---|
| servingCellMO MeasObjectId | OPTIONAL, -- Cond MeasObject |

```
  ...,
  [[
  lte-CRS-ToMatchAround SetupRelease { RateMatchPatternLTE-CRS }
OPTIONAL, -- Need M
  rateMatchPatternToAddModList SEQUENCE (SIZE (1..maxNrofRateMatchPatterns))
OF RateMatchPattern OPTIONAL, -- Need N
  rateMatchPatternToReleaseList SEQUENCE (SIZE (1..maxNrofRateMatchPatterns))
OF RateMatchPatternId OPTIONAL, -- Need N
  downlinkChannelBW-PerSCS-List SEQUENCE (SIZE (1..maxSCSs)) OF SCS-
SpecificCarrier OPTIONAL -- Need S
  ]],
  [[
```

| | |
|---|---|
| supplementaryUplinkRelease ENUMERATED {true} | OPTIONAL, -- |

```
Need N
  tdd-UL-DL-ConfigurationDedicated-IAB-MT-r16 TDD-UL-DL-ConfigDedicated-IAB-
MT-r16  OPTIONAL, -- Cond TDD_LAB
  dormantBWP-Config-r16 SetupRelease { DormantBWP-Config-r16 }
OPTIONAL, -- Need M
  ca-SlotOffset-r16 CHOICE {
    refSCS15kHz INTEGER (−2..2),
    refSCS30KHz INTEGER (−5..5),
    refSCS60KHz INTEGER (−10..10),
    refSCS120KHz INTEGER (−20..20)
```

| | |
|---|---|
| } | OPTIONAL, -- Cond AsyncCA |

```
  channelAccessConfig-r16 SetupRelease { ChannelAccessConfig-r16 }
OPTIONAL, -- Need M
  intraCellGuardBandsDL-List-r16 SEQUENCE (SIZE (1..maxSCSs)) OF
IntraCellGuardBandsPerSCS-r16 OPTIONAL, -- Need S
  intraCellGuardBandsUL-List-r16 SEQUENCE (SIZE (1..maxSCSs)) OF
IntraCellGuardBandsPerSCS-r16 OPTIONAL, -- Need S
  csi-RS-ValidationWith-DCI-r16 ENUMERATED {enabled}
OPTIONAL, -- Need R
  lte-CRS-PatternList1-r16 SetupRelease { LTE-CRS-PatternList-r16 }
OPTIONAL, -- Need M
  lte-CRS-PatternList2-r16 SetupRelease { LTE-CRS-PatternList-r16 }
OPTIONAL, -- Need M
  crs-RateMatch-PerCORESETPoolIndex-r16 ENUMERATED {enabled}
OPTIONAL, -- Need R
  enableTwoDefaultTCI-States-r16 ENUMERATED {enabled}
OPTIONAL, -- Need R
  enableDefaultTCI-StatePerCoresetPoolIndex-r16 ENUMERATED {enabled}
OPTIONAL, -- Need R
```

| | |
|---|---|
| enableBeamSwitchTiming-r16 ENUMERATED {true} | OPTIONAL, |

```
-- Need R
  cbg-TxDiffTBsProcessingType1-r16 ENUMERATED {enabled}
OPTIONAL, -- Need R
  cbg-TxDiffTBsProcessingType2-r16 ENUMERATED {enabled}
OPTIONAL -- Need R
  ]]
}
```

TABLE 16
- RateMatchPatternLTE-CRS
The IE RateMatchPatternLTE-CRS is used to configure a pattern to
rate match around LTE CRS. See TS 38.214 [19], clause 5.1.4.2.
RateMatchPatternLTE-CRS information element
-- ASN1START
-- TAG-RATEMATCHPATTERNLTE-CRS-START

| | |
|---|---|
| RateMatchPatternLTE-CRS ::= | SEQUENCE { |
| carrierFreqDL | INTEGER (0..16383), |
| carrierBandwidthDL | ENUMERATED {n6, n15, n25, n50, n75, n100, spare2, spare1}, |
| mbsfn-SubframeConfigList | EUTRA-MBSFN-SubframeConfigList |

OPTIONAL, -- Need M

| | |
|---|---|
| nrofCRS-Ports | ENUMERATED {n1, n2, n4}, |
| v-Shift | ENUMERATED {n0, n1, n2, n3, n4, n5} |

}

| | |
|---|---|
| LTE-CRS-PatternList-r16 ::= | SEQUENCE (SIZE (1..maxLTE-CRS-Patterns-r16)) |

OF RateMatchPatternLTE-CRS
-- TAG-RATEMATCHPATTERNLTE-CRS-STOP
-- ASN1STOP
Descriptions of RateMatchPatternLTE-CRS Field
carrierBandwidthDL
BW of the LTE carrier in number of PRBs (see TS 38.214 [19], clause 5.1.4.2).
carrierFreqDL
Center of the LTE carrier (see TS 38.214 [19], clause 5.1.4.2).
mbsfn-SubframeConfigList
LTE MBSFN subframe configuration (see TS 38.214 [19], clause 5.1.4.2).
nrofCRS-Ports
Number of LTE CRS antenna port to rate-match around (see TS 38.214 [19], clause 5.1.4.2).
v-Shift
Shifting value v-shift in LTE to rate match around LTE CRS (see TS 38.214 [19], clause 5.1.4.2).

[PDSCH: Related to Frequency Resource Allocation]

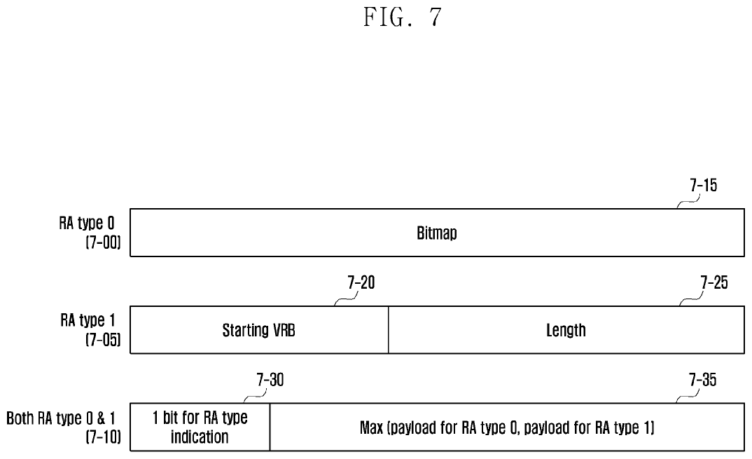

FIG. 7 illustrates an example of frequency axis resource allocation of a physical downlink shared channel (PDSCH) in a wireless communication system according to an embodiment of the disclosure.

FIG. 7 illustrates three frequency axis resource allocation methods of type 0 7-00, type 1 7-05, and a dynamic switch 7-10 configurable via an upper layer in an NR wireless communication system.

With reference to FIG. 7, in a case that a UE is configured, through upper layer signaling, to use only resource type 0 7-00, a part of downlink control information (DCI) for allocating PDSCH to the corresponding UE includes a bitmap constituted with NRBG bits. Conditions for this will be described later. In this case, NRBG refers to the number of resource block groups (RBGs) determined, as shown in [Table 17] below, according to rbg-Size, which is an upper layer parameter, and a BWP size allocated by a BWP indicator, and data is transmitted on RBG indicated by number 1 via the bitmap.

TABLE 17

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

In a case that the UE is configured, via upper layer signaling, to use only resource type 1 7-05, a part of DCI for allocating PDSCH to the corresponding UE includes frequency axis resource allocation information constituted with ┌log₂(N (N_{RB}^{DLBWP}(N_{RB}^{DLBWP}+1)/2┐ bits.

Conditions for this will be described later. Based on this, the base station may configure a starting VRB 7-20 and a length 7-25 of a frequency axis resource continuously allocated therefrom.

In a case that the UE is configured, via upper layer signaling, to use both resource type 0 and resource type 1 as in 7-10, a part of DCI for allocating PDSCH to the corresponding UE includes frequency axis resource allocation information constituted with bits of a larger value 7-35 among a payload 7-15 for configuring resource type 0 and a payload 7-20, 7-25 for configuring resource type 1. Conditions for this will be described later. In this case, one bit may be added to a first part (MSB) of frequency axis resource allocation information in DCI. In case that a value of the bit is “0,” use of resource type 0 may be indicated, and in a case that a value of the bit is “1,” use of resource type 1 may be indicated.

[PDSCH/PUSCH: Relating to Time Resource Allocation]

Hereinafter, a time domain resource allocation (TDRA) method for a data channel in a next-generation mobile communication system (5G or NR system) will be described.

The base station may configure, to the UE via upper layer signaling (e.g., RRC signaling), a table for time domain resource allocation information on a downlink data channel (physical downlink shared channel (PDSCH)) and an uplink data channel (physical uplink shared channel (PUSCH)). A table constituted with up to 16 entries (maxNrofDL-Allocations=16) may be configured for PDSCH, and a table constituted with up to 16 entries (maxNrofUL-Allocations=16) may be configured for the PUSCH. In an embodiment, the time domain resource allocation information may include a PDCCH-to-PDSCH slot timing (indicated as K0, and corresponding to a time interval of a slot unit between a point in time when PDCCH is received and a point in time when PDSCH scheduled by received PDCCH is transmitted), a PDCCH-to-PUSCH slot timing (indicated as K2, and corresponding to a time interval of a slot unit between a point in time when PDCCH is received and a point in time when PUSCH scheduled by received PDCCH is transmitted), information on a location and length of a start symbol in which PDSCH or PUSCH is scheduled within a slot, a mapping type of PDSCH or the PUSCH, and the like. For example, information as shown in [Table 18] or [Table 19] below may be transmitted from the base station to the UE.

TABLE 18
PDSCH-TimeDomainResourceAllocationList ::= SEQUENCE (SIZE(1..maxNrofDL-
Allocations)) OF PDSCH-TimeDomainResourceAllocation
PDSCH-TimeDomainResourceAllocation ::= SEQUENCE {

| | | |
|---|---|---|
| k0 | INTEGER(0..32) | OPTIONAL, -- Need S |

| | |
|---|---|
| mappingType | ENUMERATED {typeA, typeB}, |
| startSymbolAndLength | INTEGER (0..127) |

}

TABLE 19
PUSCH-TimeDomainResourceAllocationList ::= SEQUENCE (SIZE(1..maxNrofUL-
Allocations)) OF PUSCH-TimeDomainResourceAllocation
PUSCH-TimeDomainResourceAllocation ::= SEQUENCE {

| | | |
|---|---|---|
| k2 | INTEGER(0..32) | OPTIONAL, -- Need S |

| | |
|---|---|
| mappingType | ENUMERATED {typeA, typeB}, |
| startSymbolAndLength | INTEGER (0..127) |

}

The base station may notify one of the entries of table for the time domain resource allocation information to the UE via L1 signaling (e.g., DCI) (e.g., the entry may be indicated by a “time domain resource allocation” field in DCI). The UE may acquire the time domain resource allocation information for PDSCH or PUSCH, based on DCI received from the base station.

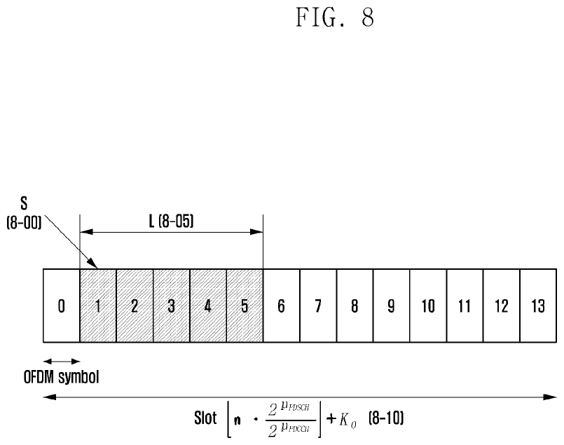

FIG. 8 illustrates an example of time axis resource allocation of PDSCH in a wireless communication system according to an embodiment of the disclosure.

With reference to FIG. 8, a base station may indicate a time axis location of a PDSCH resource according to subcarrier spacing (SCS) (μPDSCH, μPDCCH) of a data channel and a control channel configured using upper layer signaling, a scheduling offset (K0) value, and an OFDM symbol start location 8-00 and length 8-05 in one slot dynamically indicated via DCI.

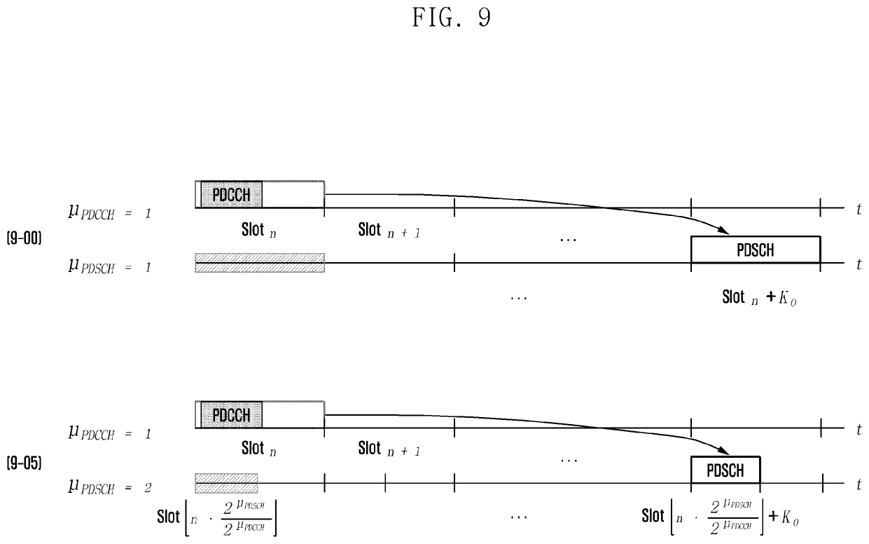

FIG. 9 illustrates an example of time axis resource allocation according to subcarrier spacing of a data channel and a control channel in a wireless communication system according to an embodiment of the disclosure.

With reference to FIG. 9, in a case that subcarrier spacings of a data channel and a control channel are the same 9-00 (pPDSCH=sPDCCH), slot numbers for data and control are the same, and thus a base station and a UE may generate a scheduling offset according to a predetermined slot offset K0. On the other hand, in a case that the subcarrier spacings of the data channel and the control channel are different 9-05 (sPDSCH≠sPDCCH), the slot numbers for data and control are different, and thus the base station and the UE may generate a scheduling offset according to a predetermined slot offset K0, based on the subcarrier spacing of PDCCH.

[PUSCH: Regarding Transmission Scheme]

Next, a scheduling scheme of PUSCH transmission will be described. The PUSCH transmission may be dynamically scheduled by UL grant in DCI or may operate by configured grant Type 1 or Type 2. A dynamic scheduling indication regarding the PUSCH transmission is enabled by a DCI format 0_0 or 0_1.

The configured grant Type 1 PUSCH transmission may be quasi-statically configured through reception of configuredGrantConfig including rrc-ConfiguredUplinkGrant of Table 20 via upper signaling, without receiving the UL grant in the DCI. The configured grant Type 2 PUSCH transmission may be semi-persistently scheduled by the UL grant in the DCI after reception of configuredGrantConfig not including rrc-ConfiguredUplinkGrant of Table 20, via upper signaling. In a case that the PUSCH transmission operates by configured grant, parameters applied to the PUSCH transmission are applied through configuredGrantConfig that is upper signaling of Table 20, except for dataScramblingIdentityPUSCH, txConfig, codebookSubset, maxRank, and scaling of UCI-OnPUSCH provided via pusch-Config of Table 21 that is upper signaling. When the UE is provided with transformPrecoder in the configuredGrantConfig that is upper signaling of Table 20, the UE applies tp-pi2BPSK in the pusch-Config of Table 21 with respect to the PUSCH transmission operating by the configured grant.

```
TABLE 20
ConfiguredGrantConfig ::= SEQUENCE {
  frequencyHopping ENUMERATED {intraSlot, interSlot}
OPTIONAL, -- Need S,
  cg-DMRS-Configuration DMRS-UplinkConfig,
  mcs-Table ENUMERATED {qam256, qam64LowSE}
OPTIONAL, -- Need S
  mcs-TableTransformPrecoder ENUMERATED {qam256, qam64LowSE}
OPTIONAL, -- Need S
  uci-OnPUSCH SetupRelease { CG-UCI-OnPUSCH }
OPTIONAL, -- Need M
  resourceAllocation ENUMERATED { resourceAllocationType0,
resourceAllocationType1, dynamicSwitch },
```

| | |
|---|---|
| rbg-Size ENUMERATED {config2} | OPTIONAL, -- Need S |

```
  powerControlLoopToUse ENUMERATED {n0, n1},
  p0-PUSCH-Alpha P0-PUSCH-AlphaSetId,
  transformPrecoder ENUMERATED {enabled, disabled}
OPTIONAL, -- Need S
  nrofHARQ-Processes INTEGER(1..16),
  repK ENUMERATED {n1, n2, n4, n8},
  repK-RV ENUMERATED {s1-0231, s2-0303, s3-0000}
OPTIONAL, -- Need R
  periodicity ENUMERATED {
    sym2, sym7, sym1x14, sym2x14, sym4x14, sym5x14, sym8x14,
sym10x14, sym16x14, sym20x14,
    sym32x14, sym40x14, sym64x14, sym80x14, sym128x14,
sym160x14, sym256x14, sym320x14, sym512x14,
    sym640x14, sym1024x14, sym1280x14, sym2560x14, sym5120x14,
    sym6, sym1x12, sym2x12, sym4x12, sym5x12, sym8x12, sym10x12,
sym16x12, sym20x12, sym32x12,
    sym40x12, sym64x12, sym80x12, sym128x12, sym160x12, sym256x12,
sym320x12, sym512x12, sym640x12,
    sym1280x12, sym2560x12
  },
```

| | |
|---|---|
| configuredGrantTimer INTEGER (1..64) | OPTIONAL, -- Need |

```
R
  rrc-ConfiguredUplinkGrant SEQUENCE {
  timeDomainOffset INTEGER (0..5119),
  timeDomainAllocation INTEGER (0..15),
  frequencyDomainAllocation BIT STRING (SIZE(18)),
  antennaPort INTEGER (0..31),
```

| | |
|---|---|
| dmrs-SeqInitialization INTEGER (0..1) | OPTIONAL, -- Need R |

precodingAndNumberOfLayers INTEGER (0..63),

| | |
|---|---|
| srs-ResourceIndicator INTEGER (0..15) | OPTIONAL, -- Need |

```
R
  mcsAndTBS INTEGER (0..31),
  frequencyHoppingOffset INTEGER (1.. maxNrofPhysicalResourceBlocks−1)
OPTIONAL, -- Need R
  pathlossReferenceIndex INTEGER (0..maxNrofPUSCH-
PathlossReferenceRSs−1),
  ...
```

| | |
|---|---|
| } | OPTIONAL, -- Need R |

...
}

Next, a PUSCH transmission method will be described. A DMRS antenna port for PUSCH transmission is the same as an antenna port for SRS transmission. The PUSCH transmission may follow a codebook-based transmission method or a non-codebook-based transmission method, depending on whether a value of txConfig in the pusch-Config of Table 21 that is upper signaling is “codebook” or “nonCodebook.”

As described above, the PUSCH transmission may be dynamically scheduled via the DCI format 0_0 or 0_1, and may be configured quasi-statically by the configured grant. When scheduling regarding the PUSCH transmission is indicated to the UE via the DCI format 0_0, the UE may perform beam configuration for the PUSCH transmission by using pucch-spatialRelationInfoID corresponding to a UE-specific PUCCH resource corresponding to a minimum ID in an uplink BWP activated in a serving cell, and in this case, the PUSCH transmission is based on a single antenna port. The UE does not expect the scheduling regarding the PUSCH transmission via the DCI format 0_0, in a BWP in which a PUCCH resource including pucch-spatialRelationInfo is not configured. When the UE is not configured with txConfig in the pusch-Config of Table 21, the UE does not expect scheduling via the DCI format 0_1.

```
TABLE 21
PUSCH-Config ::= SEQUENCE {
  dataScramblingIdentityPUSCH INTEGER (0..1023)
OPTIONAL, -- Need S
  txConfig ENUMERATED {codebook, nonCodebook}
OPTIONAL, -- Need S
  dmrs-UplinkForPUSCH-MappingTypeA SetupRelease { DMRS-UplinkConfig }
OPTIONAL, -- Need M
  dmrs-UplinkForPUSCH-MappingTypeB SetupRelease { DMRS-UplinkConfig }
OPTIONAL, -- Need M
```

| | |
|---|---|
| pusch-PowerControl PUSCH-PowerControl | OPTIONAL, -- |

```
Need M
  frequencyHopping ENUMERATED {intraSlot, interSlot}
OPTIONAL, -- Need S
  frequencyHoppingOffsetLists SEQUENCE (SIZE (1..4)) OF INTEGER (1..
maxNrofPhysicalResourceBlocks−1)
      OPTIONAL, -- Need M
  resourceAllocation ENUMERATED { resourceAllocationType0,
resourceAllocationType1, dynamicSwitch},
  pusch-TimeDomainAllocationList SetupRelease { PUSCH-
TimeDomainResourceAllocationList } OPTIONAL, -- Need M
  pusch-AggregationFactor ENUMERATED { n2, n4, n8 }
OPTIONAL, -- Need S
  mcs-Table ENUMERATED {qam256, qam64LowSE}
OPTIONAL, -- Need S
  mcs-TableTransformPrecoder ENUMERATED {qam256, qam64LowSE}
OPTIONAL, -- Need S
  transformPrecoder ENUMERATED {enabled, disabled}
OPTIONAL, -- Need S
  codebookSubset ENUMERATED {fullyAndPartialAndNonCoherent,
partialAndNonCoherent,nonCoherent}
    OPTIONAL, -- Cond codebookBased
```

| | |
|---|---|
| maxRank INTEGER (1..4) | OPTIONAL, -- Cond |

codebookBased

| | |
|---|---|
| rbg-Size ENUMERATED { config2} | OPTIONAL, -- Need S |
| uci-OnPUSCH SetupRelease { UCI-OnPUSCH} | OPTIONAL, -- |

Need M

| | |
|---|---|
| tp-pi2BPSK ENUMERATED {enabled} | OPTIONAL, -- Need |

S
...
}

Next, codebook-based PUSCH transmission will be described. The codebook-based PUSCH transmission may be dynamically scheduled via the DCI format 0_0 or 0_1, or may quasi-statically operate by the configured grant. When a codebook-based PUSCH is dynamically scheduled by the DCI format 0_1 or quasi-statically configured by the configured grant, the UE determines a precoder for the PUSCH transmission, based on an SRS resource indicator (SRI), a transmission precoding matrix indicator (TPMI), and a transmission rank (the number of PUSCH transmission layers).

In this case, the SRI may be provided via a field SRS resource indicator in the DCI or via srs-ResourceIndicator that is upper signaling. The UE is configured with at least one SRS resource, and may be configured up to two SRS resources, during the codebook-based PUSCH transmission. In a case that the UE is provided with the SRI via the DCI, an SRS resource indicated by the corresponding SRI denotes an SRS resource corresponding to the SRI, from among SRS resources transmitted before a PDCCH including the SRI. Also, the TPMI and transmission rank may be provided via field precoding information and number of layers in the DCI or may be configured via precodingAndNumberOfLayers that is upper signaling. The TPMI is used to indicate a precoder applied to the PUSCH transmission. When the UE is configured with one SRS resource, the TPMI is used to indicate the precoder to be applied to the one configured SRS resource. When the UE is configured with a plurality of SRS resources, the TPMI is used to indicate the precoder to be applied to the SRS resource indicated via the SRI.

The precoder to be used for the PUSCH transmission is selected from an uplink codebook having the number of antenna ports equal to a value of nrofSRS-Ports in SRS-Config that is upper signaling. In the codebook-based PUSCH transmission, the UE determines a codebook subset, based on the TPMI and the codebookSubset in the pusch-Config that is upper signaling. The codebookSubset in the pusch-Config that is upper signaling may be configured to be one of “fullyAndPartialAndNonCoherent,” “partialAndNonCoherent,” and “nonCoherent,” based on UE capability reported by the UE to the base station. When the UE reported “partialAndNonCoherent” as the UE capability, the UE does not expect a value of codebookSubset that is upper signaling to be configured to “fullyAndPartialAndNonCoherent.” Also, when the UE reported “nonCoherent” as the UE capability, the UE does not expect the value of codebookSubset that is upper signaling to be configured to “fullyAndPartialAndNonCoherent” or “partialAndNonCoherent.” In a case that nrofSRS-Ports in SRS-ResourceSet that is upper signaling indicates two SRS antenna ports, the UE does not expect the value of codebookSubset that is upper signaling to be configured to “partialAndNonCoherent.”

The UE may be configured with one SRS resource set in which a value of usage in SRS-ResourceSet that is upper signaling is configured to ‘codebook,” and one SRS resource in the SRS resource set may be indicated via SRI. When several SRS resources are configured in the SRS resource set in which the value of usage in SRS-ResourceSet that is upper signaling is configured to “codebook,” the UE expects a value of nrofSRS-Ports in SRS-Resource that is upper signaling to be the same for all SRS resources.

The UE transmits, to the base station, one or a plurality of SRS resources included in the SRS resource set in which the value of usage is configured to “codebook” according to upper signaling, and the base station selects one of the SRS resources transmitted by the UE and instructs the UE to perform the PUSCH transmission, by using transmission beam information of the selected SRS resource. Here, in the codebook-based PUSCH transmission, SRI is used as information for selecting an index of one SRS resource, and is included in the DCI. In addition, the base station includes, to the DCI, information indicating the TPMI and rank to be used by the UE for the PUSCH transmission. The UE performs the PUSCH transmission by applying the precoder indicated by the rank and TPMI indicated based on a transmission beam of the SRS resource, by using the SRS resource indicated by the SRI.

Next, non-codebook-based PUSCH transmission will be described. The non-codebook-based PUSCH transmission may be dynamically scheduled via the DCI format 0_0 or 0_1, or may quasi-statically operate by the configured grant. In a case that at least one SRS resource is configured in the SRS resource set in which a value of usage in SRS-ResourceSet that is upper signaling is configured to “nonCodebook,” the UE may receive scheduling of the non-codebook-based PUSCH transmission via the DCI format 0_1.

Regarding the SRS resource set in which the value of usage in SRS-ResourceSet that is upper signaling is configured to “nonCodebook,” the UE may receive configuration of one connected non-zero power (NZP) CSI-RS resource. The UE may perform calculation regarding a precoder for SRS transmission via measurement on the NZP CSI-RS resource connected to the SRS resource set. When a difference between a last reception symbol of an aperiodic NZP CSI-RS resource connected to the SRS resource set and a first symbol of aperiodic SRS transmission in the UE is less than 42 symbols, the UE does not expect information regarding the precoder for SRS transmission to be updated.

When a value of resourceType in SRS-ResourceSet that is upper signaling is configured to be “aperiodic,” the connected NZP CSI-RS is indicated by an SRS request that is a field in the DCI format 0_1 or 1_1. Here, when the connected NZP CSI-RS resource is an aperiodic NZP CSI-RS resource, it is indicated that the connected NZP CSI-RS is present regarding a case where a value of SRS request that is the field in the DCI format 0_1 or 1_1 is not “00.” In this case, corresponding DCI does not indicate cross carrier or cross BWP scheduling. Also, when the value of SRS request indicates the presence of NZP CSI-RS, the NZP CSI-RS is located at a slot on which PDCCH including an SRS request field is transmitted. Here, TCI states configured in a scheduled subcarrier are not configured to be QCL-TypeD.

When a periodic or semi-persistent SRS resource set is configured, the connected NZP CSI-RS may be indicated via associatedCSI-RS in the SRS-ResourceSet that is upper signaling. Regarding the non-codebook-based transmission, the UE does not expect spatialRelationInfo that is upper signaling for the SRS resource and associatedCSI-RS in SRS-ResourceSet that is upper signaling to be configured together.

In a case that a plurality of SRS resources is configured, the UE may determine the precoder and a transmission rank to be applied to the PUSCH transmission, based on SRI indicated by the base station. Here, the SRI may be indicated via a field SRS resource indicator in the DCI or configured via srs-ResourceIndicator that is upper signaling. Like the codebook-based PUSCH transmission, in a case that the UE receives the SRI via the DCI, the SRS resource indicated by the corresponding SRI denotes an SRS resource corresponding to the SRI from among SRS resources transmitted prior to the PDCCH including the corresponding SRI. The UE may use one or a plurality of SRS resources for SRS transmission, and a maximum number of SRS resources capable of being simultaneously transmitted from a same symbol in one SRS resource set and a maximum number of SRS resources are determined by UE capability reported by the UE to the base station. Here, the SRS resources simultaneously transmitted by the UE occupy a same RB. The UE configures one SRS port for each SRS resource. Only one SRS resource set, in which the value of usage in SRS-ResourceSet that is upper signaling is configured to be “nonCodebook,” may be configured, and up to 4 SRS resources for the non-codebook-based PUSCH transmission may be configured.

The base station transmits, to the UE, one NZP CSI-RS connected to the SRS resource set. Based on a result of measurement during the reception of NZP CSI-RS, the UE calculates the precoder to be used for transmission of one or a plurality of SRS resources in the SRS resource set. The UE applies the calculated precoder when transmitting, to the base station, one or a plurality of SRS resources in the SRS resource set, in which the usage is configured to be “nonCodebook,” and the base station selects one or a plurality of SRS resources from among the received one or a plurality of SRS resources. Here, in the non-codebook-based PUSCH transmission, the SRI denotes an index capable of representing one SRS resource or a combination of a plurality of SRS resources, and the SRI is included in the DCI. In this case, the number of SRS resources indicated by the SRI transmitted by the base station may be the number of transmission layers of the PUSCH, and the UE transmits the PUSCH by applying, to each layer, the precoder applied for the SRS resource transmission.

[PUSCH: Preparation Procedure Time]

Next, a PUSCH preparation procedure time will be described. In a case that the base station schedules the UE to transmit the PUSCH by using the DCI format 0_0, 0_1, or 0_2, the UE may require the PUSCH preparation procedure time for transmitting the PUSCH by applying a transmission method (a transmission precoding method of an SRS resource, the number of transmission layers, and a spatial domain transmission filter) indicated via the DCI. In NR, the PUSCH preparation procedure time is defined in consideration of the same. The PUSCH preparation procedure time of the UE may follow Equation 2 below.

T_{pmc,2}=max((N₂+d_{2,1}+d₂)(2048+144)κ2^{-μ}T_{c}+Tₑₓₜ+T_{switch},d_{2,2}). [Equation 2]

Each variable in Tproc,2 described above with Equation 2 may have a meaning below:
N2: The number of symbols determined according to the UE processing capability 1 or 2 according to the capability of the UE and the numerology p. In the case reported as UE processing capability 1 according to the capability report of the UE, it has the value of [Table 22], and in a case that UE processing capability 2 is reported and the availability of using the UE processing capability 2 is configured through upper layer signaling, it may have the value of [Table 23].

TABLE 22

| μ | PUSCH preparation time N₂ [symbols] |
|---|---|
| 0 | 10 |
| 1 | 12 |
| 2 | 23 |
| 3 | 36 |

TABLE 23

| μ | PUSCH preparation time N₂ [symbols] |
|---|---|
| 0 | 5 |
| 1 | 5.5 |
| 2 | 11 for frequency range 1 |

d_{2,1}: The number of symbols determined to be 0 in a case that resource elements of a first OFDM symbol of PUSCH transmission are all DM-RS, and to be 1 otherwise,
κ: 64;
μ: Follows the value at which T_{proc,2} is greater, from μ_{DL} and μ_{UL}. μ_{DL} denotes a downlink numerology in which a PDCCH including a DCI for scheduling a PUSCH is transmitted, and μ_{UL} denotes an uplink numerology in which a PUSCH is transmitted;
T_{c}: Has 1/(Δfₘₐₓ*N_{f}), Δfₘₐₓ=480*10³ Hz, Nᵣ=4096;
d_{2,2}: Follows a BWP switching time in a case that the DCI for scheduling the PUSCH indicates BWP switching, and is 0 otherwise;
d₂: In a case that a PUSCH having a high priority index with a PUCCH and an OFDM symbol of a PUCCH having a low priority index overlap on time, a value of d₂ of the PUSCH having the high priority index is used. Otherwise, d₂ is 0;
Tₑₓₜ: In a case that the UE uses a shared spectrum channel access scheme, the UE calculates Tₑₓₜ to apply the same to PUSCH preparation procedure time. Other words, Tₑₓₜ is assumed to be 0; and
T_{switch}: In a case that an uplink switching interval is triggered, T_{switch} is assumed to be a switching interval time. Otherwise. T_{switch} is assumed to be 0.

The base station and the UE determine that the PUSCH preparation procedure time is not sufficient in a case that a first symbol of the PUSCH starts before a first uplink symbol where CP starts after T_{proc,2} from a last symbol of the PDCCH including the DCI for scheduling the PUSCH, considering time axis resource mapping information of the PUSCH scheduled via the DCI and a timing advance effect between the uplink and the downlink. Otherwise, the base station and the UE determine that the PUSCH preparation procedure time is sufficient. In the case that the PUSCH preparation procedure time is sufficient, the UE transmits the PUSCH, and in the case that the PUSCH preparation procedure time is not sufficient, the UE may ignore the DCI for scheduling the PUSCH.

[Relating to CA/DC]

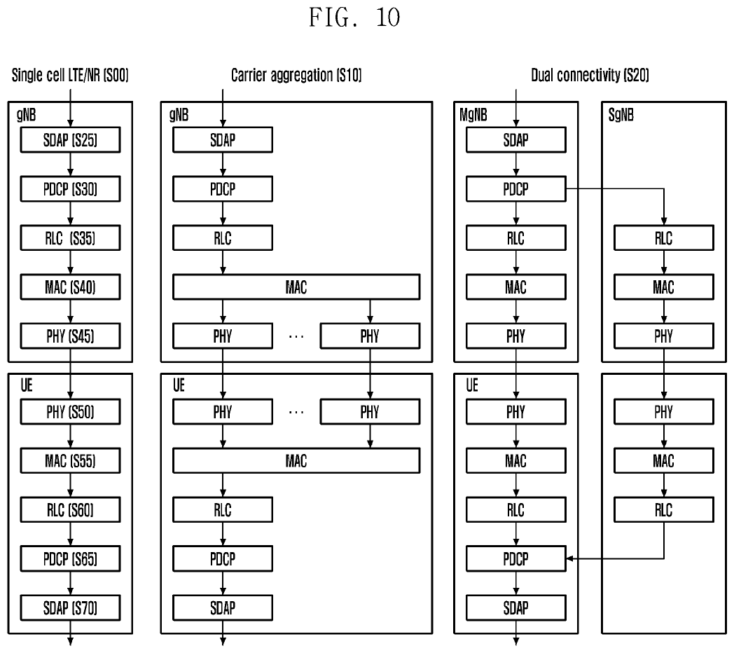

FIG. 10 illustrates a radio protocol structure of a base station and a UE in a single cell, carrier aggregation, and dual connectivity situations according to an embodiment of the disclosure.

With reference to FIG. 10, radio protocols of a next-generation mobile communication system include NR service data adaptation protocol (SDAP) S25, S70, NR packet data convergence protocol (PDCP) S30, S65, NR radio link control (RLC) S35, S60, and NR medium access control (MAC) S40, S55, in a UE and an NR base station, respectively.

Main functions of the NR SDAP S25, S70 may include some of the following functions:
user data transfer function (transfer of user plane data);
function of mapping QoS flow and data bearer for uplink and downlink (mapping between a QoS flow and a DRB for both DL and UL);
function of marking QoS flow ID in uplink and downlink (marking QoS flow ID in both DL and UL packets); and/or
function of mapping reflective QoS flow to data bearer for uplink SDAP PDUs (reflective QoS flow to DRB mapping for the UL SDAP PDUs).

With respect to the SDAP layer device, the UE may be configured, via an RRC message, whether to use a header of the SDAP layer device or whether to use a function of the SDAP layer device for each PDCP layer device, for each bearer, or for each logical channel, and in a case that the SDAP header is configured, a NAS QoS reflection configuration 1-bit indicator (NAS reflective QoS) and an AS QoS reflection configuration 1-bit indicator (AS reflective QoS) in the SDAP header may indicate the UE to update or reconfigure mapping information for data bearers and QoS flows in uplink and downlink. The SDAP header may include QoS flow ID information indicating QoS. The QoS information may be used as a data processing priority, scheduling information, etc. to support a smooth service.

Main functions of the NR PDCP S30, S65 may include some of the following functions:
header compression and decompression function (header compression and decompression: ROHC only);
user data transmission function (transfer of user data);
in-sequence delivery function (in-sequence delivery of upper layer PDUs);
out-of-sequence delivery function (out-of-sequence delivery of upper layer PDUs);
reordering function (PDCP PDU reordering for reception);
duplicate detection function (duplicate detection of lower layer SDUs),
retransmission function (retransmission of PDCP SDUs);
encryption and decryption function (ciphering and deciphering); and/or
timer-based SDU delete function (timer-based SDU discard in uplink).

The reordering function of the NR PDCP device refers to a function of reordering PDCP PDUs received from a lower layer, in sequence based on a PDCP sequence number (SN), and may include a function of transferring data to an upper layer according to the reordered sequence. Alternatively, the reordering function of the NR PDCP device may include a function of direct transfer without considering a sequence, may include a function of reordering the sequence to record lost PDCP PDUs, may include a function of reporting states of the lost PDCP PDUs to a transmission side, and may include a function of requesting retransmission of the lost PDCP PDUs.

Main functions of the NR RLC S35, S60 may include some of the following functions:
data transmission function (transfer of upper layer PDUs),
in-sequence delivery function (in-sequence delivery of upper layer PDUs),
out-of-sequence delivery function (out-of-sequence delivery of upper layer PDUs);
ARQ function (error correction through ARQ);
concatenation, segmentation, and reassembly function (concatenation, segmentation, and reassembly of RLC SDUs);
re-segmentation function (re-segmentation of RLC data PDUs);
reordering function (reordering of RLC data PDUs);
duplicate detection function (duplicate detection);
error detection function (protocol error detection);
RLC SDU discard function (RLC SDU discard); and/or
RLC re-establishment function (RLC re-establishment).

The in-sequence delivery function of the NR RLC device may refer to a function of sequentially transferring, to an upper layer, RLC SDUs received from a lower layer. The in-sequence delivery function of the NR RLC may include a function of, in a case that originally one RLC SDU is segmented into a plurality of RLC SDUs and then received, reassembling and transferring the same, may include a function of reordering the received RLC PDUs according to an RLC sequence number (SN) or a PDCP sequence number (SN), may include a function of reordering a sequence and recording lost RLC PDUs, may include a function of reporting states of the lost RLC PDUs to a transmission side, and may include a function of requesting retransmission of the lost RLC PDUs. The in-sequence delivery function of the NR RLC device may include a function of, in a case that there is a lost RLC SDU, sequentially transferring only RLC SDUs before the lost RLC SDU to the upper layer, or may include a function of sequentially transferring all the received RLC SDUs to the upper layer before a predetermined timer starts if the timer expires even if there is the lost RLC SDU. Alternatively, the in-sequence delivery function of the NR RLC device may include a function of sequentially transferring all the RLC SDUs received up to the current time to the upper layer if the predetermined timer expires even if there is the lost RLC SDU. Also, the RLC PDUs may be processed in the order of reception thereof (in order of arrival regardless of the order of the sequence numbers or serial numbers) and may be transferred to the PDCP device regardless of the order (out-of-sequence delivery) In a case of segments, the segments stored in a buffer or to be received at a later time may be received, reconfigured into one complete RLC PDU, processed, and then may be transferred to the PDCP device. The NR RLC layer may not include a concatenation function, and the function may be performed in an NR MAC layer or may be replace with a multiplexing function of the NR MAC layer.

The out-of-sequence delivery function of the NR RLC device refers to a function of transferring RLC SDUs received from a lower layer to an immediate upper layer in any order, may include a function of, in a case that originally one RLC SDU is segmented into a plurality of RLC SDUs and then received, reassembling and transferring the same, and may include a function of storing RLC SN or PDCP SN of the received RLC PDUs, arranging the sequence thereof, and recording the lost RLC PDUs.

The NR MAC S40, S55 may be connected to a plurality of NR RLC layer devices constituted in one UE, and main functions of the NR MAC may include some of the following functions:
mapping function (mapping between logical channels and transport channels);
multiplexing and demultiplexing function (multiplexing/demultiplexing of MAC SDUs);
scheduling information reporting function (scheduling information reporting);
HARQ function (error correction through HARQ);
function of priority handling between logical channels (priority handling between logical channels of one UE);
function of priority handling between UEs (priority handling between UEs by means of dynamic scheduling);
MBMS service identification function (MBMS service identification),
transmission format selection function (transport format selection), and/or
a padding function (padding).

The NR PHY layer S45, S50 may perform channel-coding and modulation of upper layer data, make the channel-coded and modulated upper layer data into OFDM symbols, and transmit the OFDM symbols via a radio channel, or may perform demodulation and channel-decoding of the OFDM symbols received through the radio channel and transfer the same to the upper layer.

The detailed structure of the radio protocol structure may be variously changed according to a carrier (or cell) operating method. For example, in a case that the base station transmits data to the UE on the basis of a single carrier (or cell), the base station and the UE use a protocol structure having a single structure for each layer as shown in S00 On the other hand, in a case that the base station transmits data to the UE, based on carrier aggregation (CA) using a plurality of carriers in a single TRP, the base station and the UE use a protocol structure in which a single structure is provided until the RLC layer but the PHY layer is multiplexed via the MAC layer as shown in S10 As another example, in a case that the base station transmits data to the UE, based on dual connectivity (DC) using a plurality of carriers in a plurality of TRPs, the base station and the UE use a protocol structure in which a single structure is provided until the RLC layer and the PHY layer is multiplexed via the MAC layer as shown in S20.

Referring to the above descriptions relating to PDCCH and beam configurations, PDCCH repetitive transmission is not supported currently in Rel-15 and Rel-16 NR, and it is thus difficult to achieve required reliability in a scenario requiring high reliability, such as URLLC. The disclosure provides a method of PDCCH repetitive transmission via multiple transmission point (TRP) so that PDCCH reception reliability of a UE may be improved. Specific methods are described in detail in the following examples.

Hereinafter, an embodiment of the disclosure will be described in detail with reference to the accompanying drawings. Contents of the disclosure are applicable to FDD and TDD systems. Hereinafter, in the disclosure, upper signaling (or upper layer signaling) is a method of transferring a signal from a base station to a UE by using a physical layer downlink data channel or transferring a signal from a UE to a base station by using a physical layer uplink data channel, and may be referred to as RRC signaling, PDCP signaling, or a medium access control (MAC) control element (MAC CE).

Hereinafter, in the disclosure, in determining whether to apply cooperative communication, it is possible for a UE to use various methods, in which PDCCH(s) assigning PDSCH to which the cooperative communication is applied has a specific format, PDCCH(s) assigning PDSCH to which the cooperative communication is applied includes a specific indicator indicating whether the cooperative communication is applied, PDCCH(s) assigning PDSCH to which the cooperative communication is applied is scrambled with a specific RNTI, or applying of the cooperative communication in a specific section indicated by an upper layer is assumed, and so on. For convenience of description, a case in which a UE receives PDSCH to which cooperative communication has been applied based on conditions similar to the above will be referred to as a NC-JT case.

Hereinafter, in the disclosure, determining the priority between A and B may be mentioned in various ways, such as selecting one having a higher priority according to a predetermined priority rule to perform an operation corresponding thereto, or omitting or dropping an operation having a lower priority.

Hereinafter, in the disclosure, descriptions of the above-described examples will be provided via a number of embodiments, but these are not independent ones, and it is possible that one or more embodiments are applied simultaneously or in combination.

Hereinafter, embodiments of the disclosure will be described in detail with reference to accompanying drawings. Hereinafter, the base station is an entity that allocates resources of a terminal, and may be at least one of a gNode B, a gNB, an eNode B, a Node B, a base station (BS), a wireless access unit, a BS controller, or a node on a network. A terminal may include user equipment (UE), a mobile station (MS), a cellular phone, a smartphone, a computer, and a multimedia system capable of performing a communication function. Hereinafter, embodiments of the disclosure will be described with an example of a 5G system, but the embodiments of the disclosure may also be applied to other communication systems having a similar technical background or channel form. For example, LTE or LTE-A mobile communication and a mobile communication technology developed after 5G may be included thereto. Accordingly, it will be understood by one of ordinary skill in the art that the disclosure may be applied to other communication systems through some modifications without departing from the scope of the disclosure. The content of the disclosure may be applied to FDD and TDD systems.

Further, while describing the disclosure, detailed description of related well-known functions or configurations may be omitted when it is deemed that they may unnecessarily obscure the essence of the disclosure. Also, terms used below are defined in consideration of functions in the disclosure, and may have different meanings according to an intention of a user or operator, customs, or the like. Thus, the terms should be defined based on the description throughout the specification.

Hereinafter, in describing the disclosure, upper layer signaling may be signaling corresponding to at least one of signalings below or a combination of one or more thereof:
MIB (Master Information Block);
SIB (System Information Block) or SIB X (X=1, 2, . . . );
RRC (Radio Resource Control); and/or
MAC (Medium Access Control) CE (Control Element).

Also, L1 signaling may be signaling corresponding to at least one of signaling methods, described below, using a physical layer channel or a combination of one or more of the methods:
Physical downlink control channel (PDCCH);
Downlink control information (DCI);
UE-specific DCI;
Group common DCI;
Common DCI;
Scheduling DCI (e.g., DCI used for scheduling downlink or uplink data);
Non-scheduling DCI (e.g., DCI not for scheduling downlink or uplink data);
Physical uplink control channel (PUCCH); and/or
Uplink control information (UCI).

Hereinafter, in the disclosure, determining the priority between A and B may be mentioned in various ways, such as selecting one having a higher priority according to a predetermined priority rule to perform an operation corresponding thereto, or omitting or dropping an operation having a lower priority.

Hereinafter, in the disclosure, descriptions of the above-described examples will be provided via a number of embodiments, but these are not independent ones, and it is possible that one or more embodiments are applied simultaneously or in combination.

[Related to Multi-PDSCH/PUSCH Scheduling]

A new scheduling method was introduced in the Rel-17 new radio (NR) of 3rd generation partnership project (3GPP). The disclosure relates to the new scheduling method. The new scheduling method introduced in the Rel-17 NR is “multi-PDSCH scheduling” in which one DCI can schedule one or a plurality of PDSCHs and “multi-PUSCH scheduling” in which one DCI can schedule one or a plurality of PUSCHs. Here, in a plurality of PDSCHs or a plurality of PUSCHs, each PDSCH or each PUSCH transmits different transport blocks (TBs). By using the multi-PDSCH scheduling and multi-PUSCH scheduling, the base station does not schedule a plurality of DCIs for respectively scheduling a plurality of PDSCHs or a plurality of PUSCHs in a UE, so that the overhead of the downlink control channel can be reduced. However, since one DCI for the multi-PDSCH scheduling and multi-PUSCH scheduling must include scheduling information for a plurality of PDSCHs or a plurality of PUSCHs, the size of the DCI may be increased. To this end, when multi-PDSCH scheduling and multi-PUSCH scheduling are configured for the UE, a method for the UE to properly interpret the DCI is required.

Although the disclosure describes multi-PDSCH scheduling, the spirit of the technology provided in the disclosure can be used in multi-PUSCH scheduling.

The base station may configure multi-PDSCH scheduling to the UE. The base station may explicitly configure multi-PDSCH scheduling to the UE via an upper layer signal (e.g., a radio resource control (RRC) signal). The base station may implicitly configure multi-PDSCH scheduling to the UE via an upper layer signal (e.g., RRC signal).

The base station may configure a time domain resource assignment (TDRA) table via an upper layer signal (e.g., an RRC signal) as follows for multi-PDSCH scheduling to the UE. It may include one or a plurality of rows of the TDRA table. The rows may be configured to a maximum number of rows, N_rows, and each row may be assigned a unique index. The unique index may be one value of 1, 2, . . . , N_row. Here, N_row may preferably be 16. One or a plurality of pieces of scheduling information may be configured for each row. Here, when one piece of scheduling information is configured in one row, the row schedules one PDSCH. That is, when the row is indicated, it can be said that “single-PDSCH scheduling is indicated.” When a plurality of pieces of scheduling information are configured in one row, a plurality of pieces of scheduling information schedules a plurality of PDSCHs in order. That is, when the row is indicated, it can be said that “multi-PDSCH scheduling is indicated.”

The scheduling information may be (K0, SLIV, PDSCH mapping type). That is, the scheduling information may include at least one of K0, SLIV, or PDSCH mapping type. That is, in a case that multi-PDSCH scheduling is indicated, a row may include a plurality of pieces of scheduling information (K0, SLIV, PDSCH mapping types). Among them, the N-th scheduling information (K0, SLIV, PDSCH mapping type) is the scheduling information of the N-th PDSCH. For reference, one row may include a maximum N_pdsch of scheduling information (K0, SLIV, PDSCH mapping type). Here, preferably, N_pdsch is 8. That is, one row may schedule up to 8 PDSCHs.

Here, K0 indicates a slot in which a PDSCH is scheduled, and indicates a slot difference between a slot in which a PDCCH transmitting the DCI for scheduling the PDSCH is received and a slot in which the PDSCH has been scheduled. That is, if K0 is 0, the PDSCH and the PDCCH are the same slot. Here, a start and length indictor value (SLIV) indicates an index of a symbol at which the PDSCH starts within one slot and the number of consecutive symbols to which the PDSCH is allocated. The PDSCH mapping type indicates information related to the location of the first front-loaded DMRS (DMRS) of the PDSCH. In the case of PDSCH mapping type A, the first front-loaded DMRS (DMRS) of the PDSCH starts at the 3rd to 4th symbols of the slot, and in the case of PDSCH mapping type B, the first front-loaded DMRS (DMRS) of the PDSCH starts at the first of the symbols at which PDSCH has been scheduled.

Here, when configuring a row of the TDRA table via an upper layer signal, some of K0, SLIV, and PDSCH mapping types may be omitted from scheduling information. In this case, it may be interpreted as a default value. For example, in a case that K0 is omitted, the value of K0 may be interpreted as 0. In addition, when configuring a row of the TDRA table, information other than K0, SLIV, and PDSCH mapping types may be additionally configured.

In the following description, the UE is configured with multi-PDSCH scheduling. Here, the configuration of “multi-PDSCH scheduling” is to configure a plurality of pieces of scheduling information in at least one row of the TDRA table. For reference, in another row of the TDRA table, one piece of scheduling information may be configured. Therefore, even if multi-PDSCH scheduling is configured for the UE, the UE may be indicated with single-PDSCH scheduling or multi-PDSCH scheduling according to the TDRA field of the received DCI. In other words, the indication of multi-PDSCH scheduling is a case in which a row of the TDRA table that the UE is instructed from DCI includes a plurality of pieces of scheduling information, and the indication of single-PDSCH scheduling is a case in which a row of the TDRA table that the UE is instructed from DCI includes one piece of scheduling information.

In the case of single-PDSCH scheduling indication, one PDSCH is scheduled, and the one PDSCH requires information such as a modulation coding scheme (MCS), new data indicator (NDI), redundancy version (RV), and HARQ process number (HPN). For this purpose, the DCI indicating single-PDSCH scheduling may include information such as MCS, NDI, RV, HPN, etc. of the one PDSCH. More particularly, the DCI may include the information as follows:
The DCI indicating single-PDSCH scheduling may include one MCS field. The MCS indicated by the MCS field (i.e., a modulation scheme and a code rate of a channel code) may be applied to one PDSCH scheduled by the DCI;
The DCI indicating single-PDSCH scheduling may include a 1-bit NDI field. It is possible to obtain an NDI value from the 1-bit NDI field and determine whether one PDSCH transmits a new transport block or retransmits a previous transport block based on the NDI value;
The DCI indicating single-PDSCH scheduling may include a 2-bit RV field. An RV value may be obtained from the 2-bit RV field, and a redundancy version of one PDSCH may be determined based on the RV value; and/or
The DCI scheduling single-PDSCH may include one HPN field. The one HPN field may be 4 bits. (For reference, in a case that the UE supports up to 32 HARQ processes, the HPN field is extended to 5 bits, but it is assumed that 4 bits are used for convenience in the description of the disclosure). One HARQ process ID may be indicated through the one HPN field. The one HARQ process ID may be a HARQ process ID of one scheduled PDSCH.

In a case that multi-PDSCH scheduling is indicated, since a plurality of PDSCHs is scheduled, each PDSCH needs information such as MCS, NDI, RV, HPN. For this purpose, the DCI indicating multi-PDSCH scheduling may include information such as MCS, NDI, RV, HPN, etc. of each scheduled PDSCH. More particularly, the DCI may include the information as follows:
The DCI indicating multi-PDSCH scheduling may include one MCS field. The MCS indicated by the MCS field (i.e., a modulation scheme and a code rate of a channel code) may be equally applied to all PDSCHs scheduled by the DCI. That is, the DCI scheduling multi-PDSCH cannot schedule different PDSCHs with different MCSs;
The DCI indicating multi-PDSCH scheduling may include a K-bit NDI field. Here, K may be the largest value among the number of scheduling information included in each row of the TDRA table. For example, when the TDRA table includes two rows, the first row includes 4 scheduling information, and the second row includes 8 scheduling information, K may be 8. The k-th bit of the K-bit NDI field may indicate the NDI value of the PDSCH corresponding to the k-th scheduling information. That is, the k-th PDSCH may obtain an NDI value from the k-th bit of the K-bit NDI field, and determine whether the k-th PDSCH transmits a new transport block or retransmits a previous transport block based on the NDI value;
The DCI indicating multi-PDSCH scheduling may include a K-bit RV field. The k-th bit of the K-bit RV field may indicate the RV value of the PDSCH corresponding to the k-th scheduling information That is, the k-th PDSCH may obtain an RV value from the k-th bit of the K-bit RV field, and determine the redundancy version of the k-th PDSCH based on the RV value, and/or
The DCI indicating multi-PDSCH scheduling may include one HPN field. The one HPN field may be 4 bits. (For reference, in a case that the UE supports up to 32 HARQ processes, the HPN field is extended to 5 bits, but it is assumed that 4 bits are used for convenience in the description of the disclosure). One HARQ process ID may be indicated through the one HPN field. The one HARQ process ID may be the HPN (e.g., HARQ process ID) of the first PDSCH among the PDSCHs scheduled by the DCI indicating multi-PDSCH scheduling. Here, the first PDSCH corresponds to the first scheduling information. Then thereafter, the HPN (e.g., HARQ process ID) of the PDSCHs is sequentially increased by one. That is, in the case of the second PDSCH (corresponding to the second scheduling information), the HPN (e.g., HARQ process ID) is a value increased by 1 in the HPN (e.g., HARQ process ID) of the first PDSCH For reference, in a case that the HPN (e.g., HARQ process ID) exceeds the maximum number (numOfHARQProcessID) of HPN (e.g., HARQ process ID)s configured for the UE, a modulo operation is performed. In other words, in a case that the HPN (e.g., HARQ process II)) indicated by DCI is “x,” the HPN (e.g., HARQ process ID) of the k-th PDSCH is determined as follows.

HPN of k-th PDSCH=(x+k−1)modulo numOfHARQProcessID

As described above, in the case of indication of Single-PDSCH scheduling, the DCI includes a 1-bit NDI field or a 2-bit RV field, and in the case of indication of multi-PDSCH scheduling, the DCI includes a K-bit NDI field or a K-bit RV field. For reference, the Single-PDSCH scheduling indication or the multi-PDSCH scheduling indication is indicated in the TDRA field of DCI (that is, according to the number of scheduling information included in a row of the indicated TDRA field, it is determined whether it is single-PDSCH scheduling indication or multi-PDSCH scheduling indication). Accordingly, one DCI must support both single-PDSCH scheduling and multi-PDSCH scheduling. If the length of the DCI for single-PDSCH scheduling indication and the length of the DCI for multi-PDSCH scheduling indication are different from each other, the DCI of the shorter length among the DCIs must be matched to the same length by padding with “0.”

The DCI interpretation process of the UE is as follows. The UE receives DCI. In this case, it is assumed that the length of the DCI is the greater one of the length of the DCI for single-PDSCH scheduling indication and the length of the DCI for multi-PDSCH scheduling indication. The UE may know the location of the TDRA field in the DCI. The location of the TDRA field may be the same in the DCI for single-PDSCH scheduling indication and the DCI for multi-PDSCH scheduling indication. The UE may determine whether it is the DCI for single-PDSCH scheduling indication or the DCI for multi-PDSCH scheduling indication through the TDRA field. That is, if the number of scheduling information included in a row of the indicated TDRA field is one, the UE may determine that it is the single-PDSCH scheduling indication, and if the number of scheduling information included in a row of the indicated TDRA field is two or more, the UE may determine that it is the multi-PDSCH scheduling indication. If the UE determines that it is the single-PDSCH scheduling indication, DCI may be interpreted according to the determination. That is, it can be interpreted that the NDI field is 1 bit and the RV field is 2 bits. If the UE determines that it is the multi-PDSCH scheduling indication, DCI may be interpreted according to the above determination. That is, it may be interpreted that the NDI field is K bits and the RV field is K bits. For reference, the locations of other fields in DCI may vary according to the length of the NDI field or the length of the RV field. Accordingly, other fields may have the same bit length depending on whether it is the single-PDSCH scheduling indication or the multi-PDSCH scheduling indication, but may have different locations within DCI.

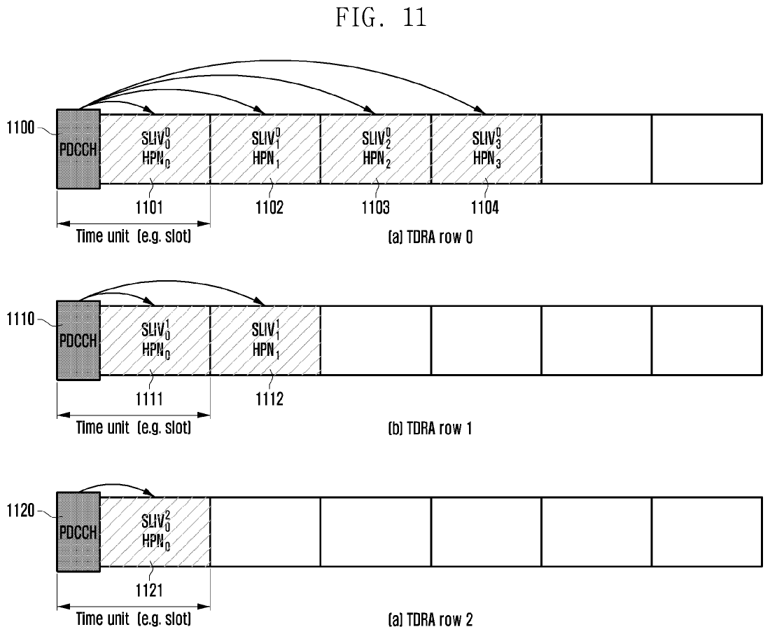

FIG. 11 illustrates a PDSCH scheduling scheme according to the above description. In the disclosure, the following TDRA table is assumed.
The first row (row 0) of the TDRA table includes four pieces of scheduling information (K0, SLIV, PDSCH mapping type). Here, the first SLIV is called SLIV00, the second SLIV is called SLIV01, the third SLIV is called SLIV02, and the fourth SLIV is called SLIV03 Accordingly, when the UE receives an indication of the first row (row 0) of the TDRA table, it can be determined that multi-PDSCH scheduling is instructed.
The second row (row 1) of the TDRA table includes two pieces of scheduling information (K0, SLIV, PDSCH mapping type). Here, the first SLIV is called SLIV10, and the second SLIV is called SLIV11. Accordingly, when the UE receives an indication of the second row (row 1) of the TDRA table, it can be determined that multi-PDSCH scheduling is instructed.
The third row (row 2) of the TDRA table includes one piece of scheduling information (K0, SLIV, PDSCH mapping type). Here, SLIV is referred to as SLIV20. Therefore, when the UE receives an indication of the third row (row 2) of the TDRA table, it can be determined single-PDSCH scheduling is indicated.

FIG. 11(a) illustrates a case in which the UE is instructed to the first row (row 0) of the TDRA table. In the DCI received by the UE on a PDCCH 1100, the TDRA field may be indicated by the first row (row 0). Accordingly, the UE may receive four PDSCHs based on the four pieces of scheduling information (K0, SLIV, PDSCH mapping type) in the first row (row 0). Symbols for receiving a first PDSCH 1101 may be determined based on SLIV⁰₀ which is the first SLIV, symbols for receiving a second PDSCH 1102 may be determined based on SLIV⁰₁ which is the second SLIV, symbols for receiving a third PDSCH 1102 may be determined based on SLIV⁰₂ which is the third SLIV, and symbols for receiving a fourth PDSCH 1103 may be determined based on SLIV⁰₃ which is the fourth SLIV. Each of the four PDSCHs may have a unique HARQ process ID. That is, the first PDSCH may have HPN₀ as the HARQ process ID, the second PDSCH may have HPN₁ as the HARQ process ID, the third PDSCH may have HPN₂ as the HARQ process ID, and the fourth PDSCH may have HPN₃ as the HARQ process ID. Here, the DCI indicates the HARQ process ID of the first PDSCH. For example, in DCI, HPN₀=0 may be indicated as the HARQ process ID of the first PDSCH. In this case, HPN₁=1 may be indicated as the HARQ process ID of the second PDSCH, HPN₁=2 may be indicated as the HARQ process ID of the third PDSCH, and HPN₁=3 may be indicated as the HARQ process ID of the fourth PDSCH.

FIG. 11(b) illustrates a case in which the UE is instructed to the second row (row 1) of the TDRA table. In the DCI received by the UE in the PDCCH 1110, the TDRA field may be indicated by the second row (row 1). Accordingly, the UE may receive two PDSCHs based on the two pieces of scheduling information (K0, SLIV, PDSCH mapping type) of the second row (row 1). Symbols for receiving the first PDSCH 1111 may be determined based on SLIV¹₀, which is the first SLIV, and symbols for receiving the second PDSCH 1112 may be determined based on SLIV¹₁, which is the second SLIV. Each of the two PDSCHs may have a unique HARQ process ID. That is, the first PDSCH may have HPN₀ as the HARQ process ID, and the second PDSCH may have HPN₁ as the HARQ process ID. Here, in DCI, the HARQ process ID of the first PDSCH is indicated. For example, in DCI, HPN₀=0 may be indicated as the HARQ process ID of the first PDSCH. In this case, the HARQ process ID of the second PDSCH may be HPN₁=1.

FIG. 11(c) illustrates a case in which the UE is instructed to the third row (row 2) of the TDRA table. In the DCI received by the UE on the PDCCH 1120, the TDRA field may be indicated by a third row (row 2). Accordingly, the UE may receive one PDSCH based on one piece of scheduling information (K0, SLIV, PDSCH mapping type) of the third row (row 2). Symbols for receiving one PDSCH 1121 may be determined based on SLIV²₀, which is one SLIV. HARQ process ID of one PDSCH, that is, HPN₀ is indicated in DCI. For example, in DCI, HPN₀=0 may be indicated as the HARQ process ID of the first PDSCH.

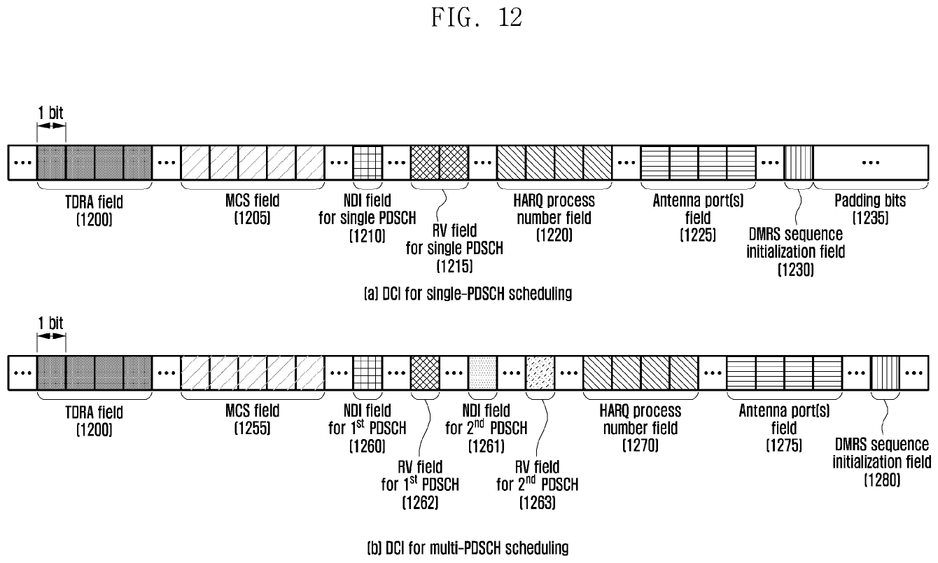

FIG. 12 illustrates DCI of single-PDSCH scheduling and multi-PDSCH scheduling.

With references to FIGS. 12(a) and (b), the UE may determine the location of the TDRA field 1200 in the received DCI. The location of the TDRA field is the same in single-PDSCH scheduling DCI and multi-PDSCH scheduling DCI. The UE may determine from the value of the TDRA field whether the received DCI is the DCI indicating single-PDSCH scheduling or the DCI indicating multi-PDSCH scheduling.

In a case that a row corresponding to the value of the TDRA field of the received DCI includes one piece of scheduling information (K0, SLIV, PDSCH mapping type) (for example, the third row of the TDRA table (row 2)), the UE interprets it as single-PDSCH scheduling DCI as illustrated in FIG. 12(a). With reference to FIG. 12(a), the single-PDSCH scheduling DCI includes a 5-bit MCS field 1205, a 1-bit NDI field 1210, a 2-bit RV field 1215, and a 4-bits HARQ field 1220. In addition, the single-PDSCH scheduling DCI may include other fields. For example, the single-PDSCH scheduling DCI may also include an antenna port(s) field 1225, a DMRS sequence initialization field 1230, or the like. Also, in a case that the single-PDSCH scheduling DCI is shorter than the multi-PDSCH scheduling DCI, padding bits 1235 may be included.

In a case that a row corresponding to the value of the TDRA field of the received DCI includes two or more pieces of scheduling information (K0, SLIV, PDSCH mapping type) (e.g., the first row (row 0) or second row (row 1) of the TDRA table), the UE interprets it as the multi-PDSCH scheduling DCI as illustrated in FIG. 12(b). With reference to FIG. 12(b), the multi-PDSCH scheduling DCI includes a 5-bit MCS field 1255, K-bit NDI fields 1260, 1261, K-bit RV fields 1262, 1263, a 4-bits HARQ Field 1270. In addition, the multi-PDSCH scheduling DCI may include other fields. For example, the multi-PDSCH scheduling DCI may include an antenna port(s) field 1275, a DMRS sequence initialization field 1280, or the like. For reference, DCI in which up to two PDSCHs are scheduled is illustrated in FIG. 12(b). Here, the 2-bit NDI fields 1260, 1261 are illustrated separately, but may be attached as one 2 bits. In addition, although the 2-bit RV fields 1262, 1263 are separately illustrated in FIG. 12(b), they may be attached as one 2 bits.

For reference, with reference to FIGS. 12(a) and 12(b), assuming that the length of the DCI indicating single-PDSCH scheduling is shorter than the length of the DCI indicating multi-PDSCH scheduling, padding bits 1235 are added to the single-PDSCH Scheduling DCI. In a case that the length of the DCI indicating single-PDSCH scheduling is longer than the length of the DCI indicating multi-PDSCH scheduling, the padding bits may be added to the DCI indicating multi-PDSCH scheduling.

Hereinafter, the disclosure assumes that the PDSCH transmits a single codeword unless otherwise specified. In a case that the transmission of two codewords is configured to the UE, the fields of DCI are for the first codeword unless otherwise specified.

[Relating to Scell Dormancy]

Scell dormancy is supported in order to reduce the power consumption of the UE. Here, Scell may refer to a cell additionally configured in addition to a primary cell (Pcell) in carrier aggregation (CA). The motivation for introducing Scell is to secure a high data transmission rate by using a wider frequency band of a plurality of Scells while Pcell is used to secure wide coverage. Scell Dormancy was first introduced in Rel-15 LTE. Here, when a data transmission requirement is not very high, Scell is in an inactive mode in order to reduce power consumption. This inactive state is called a Scell dormant state. In the case of Scell dormant state, the UE stops receiving PDCCH in the Scell, but does not stop channel state information (CSI) measurement/reporting and radio resource management (RRM) measurement. Such transition to Scell dominant state is performed through medium access control (MAC).

3GPP Rel-16 NR supports Scell dormancy using a bandwidth part (BWP). The UE may be configured with one dormancy BWP for Scell dormancy operation in the Scell. PDCCH monitoring is not configured in this dormancy BWP. Compared with the Scell dormancy of Rel-15 LTE, the Scell dormancy of Rel-16 NR may be indicated through DCI. When Scell dormancy information is indicated through the DCI, the information may be referred to as Scell dormancy indication.

Scell dormancy indication may be transmitted through DCI format. Here, the DCI format may be DCI format 1_1. For reference, DCI format 1_1 is a DCI format for scheduling PDSCH. DCI format may include a bitmap (bitmap) for Scell dormancy indication. Each bit of the bitmap corresponds to one Scell or one Sell group. For example, in a case that the n-th bit of the bitmap is indicated as 0, the n-th Scell or the Scells of the n-th Scell group change an active BWP to a dominant BWP. That is, the n-th Scell or the Scells of the n-th Scell group are in a dominant state. In a case that the n-th bit of the bitmap is indicated as 1, the n-th Scell or the Scells of the n-th Scell group perform the following operation.

In a case that the n-th Scell or the Scells of the n-th Scell group have the dominant BWP as the active BWP, the active BWP is changed to the BWP configured by the base station. Here, the BWP configured by the base station is the BWP to be activated first after the dormancy state.

In a case that the n-th Scell or the Scells of the n-th Scell group have other activated BWP other than the dormant BWP, the other BWP is maintained.

Previously, DCI format 1_1 was referred to as a DCI format for scheduling PDSCH. Also, the length of the bitmap of Scell dormancy indication may be equal to the maximum number of configured Scells. For example, in a case that 8 Scells are configured for the UE, the UE may need the bitmap of up to 8 bits. However, when the bitmap is always included in DCI format 1_1, DCI overhead may be high, and thus coverage degradation of the PDCCH carrying the DCI may occur.

To solve this, in Rel-16 NR, when DCI format 1_1 satisfies the condition for transmitting Scell dormancy indication, the DCI format 1_1 does not schedule the PDSCH. Instead, the fields used for PDSCH scheduling in the DCI format 1_1 may be reused as a bitmap of Scell dormancy indication.

<Condition for transmitting Scell dormancy indication> of DCI format 1_1 is as follows. In a case that all the following conditions are satisfied, it can be determined that the DCI format 1_1 is the transmission of Scell dormancy indication.
CRC of DCI format 1_1 is scrambled with C-RNTI or MCS-C-RNTI. Here, C-RNTI and MCS-C-RNTI are RNTIs used when scheduling a PDSCH.
There is no one-shot HARQ-ACK request field in the DCI format 1_1, or if there is, the field must be “0.”
The DCI format 1_1 must be received in a PCell, and the DCI format does not have a carrier indictor field, or if there is, the field must be “0.”
In a case that a type-0 FDRA scheme is configured to the UE as a frequency domain resource assignment (FDRA) method, all bits of the FDRA field must be configured to “0.” Alternatively, in a case that the type-1 FDRA scheme is configured to the UE as a method for allocating resources in a frequency domain, all bits of the FDRA field must be configured to “L.” Alternatively, in a case that dynamic switch between the type-0 FDRA scheme and the type-1 FDRA scheme is configured for the UE, all bits of the FDRA field must be all “0” or all “1.”

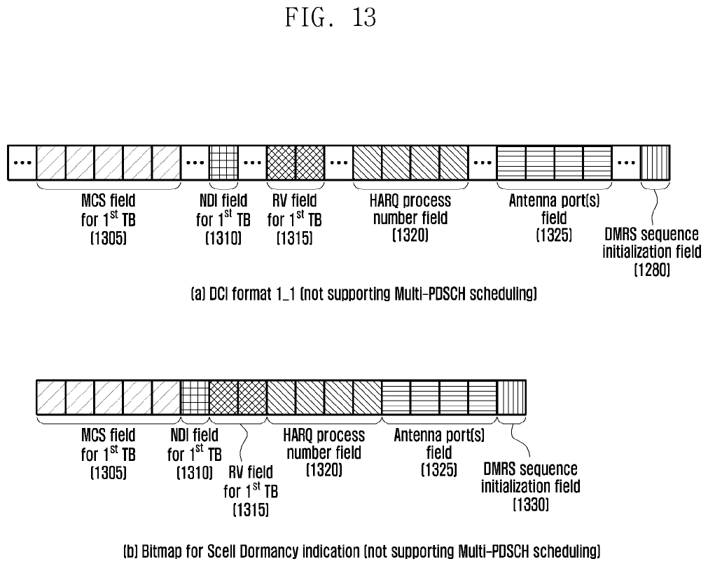

When the above condition is satisfied, the UE may determine that the DCI format 1_1 transmits Scell dormancy indication without scheduling a PDSCH. Also, some fields of the DCI format 1_1 may be reused (repurpose) as a bitmap of Scell dormancy indication. With reference to FIG. 13, a method of generating a bitmap with some fields and some fields is as follows.
In the DCI format 1_1, a MCS field 1305 of transport block 1, an NDI field 1310 of transport block 1, a RV field 1315 of transport block 1, a HPN field 1320, an antenna port(s) field 1325, and a DMRS sequence initialization field 1330 may be sequentially used as a bitmap. Here, the MCS field is 5 bits, the NDI field is 1 bit, the RV field is 2 bits, the HPN field is 4 bits, the antenna port(s) field is one of 4 bits, 5 bits, and 6 bits depending on the configuration, and the DMRS initialization field is 1 bit. With reference to FIG. 13, when the antenna port(s) field is 4 bits, the bitmap of Scell dormancy indication is 5+1+2+4+4+1=17 bits. Accordingly, the dormancy state of a maximum of 17 Scells or a maximum of 17 Scell groups can be indicated through the bitmap.

### First Embodiment: A Method of Acquiring Scell Dormancy Indication Information in a Case of Configuring Multi-PDSCH Scheduling

Multi-PDSCH scheduling was introduced in Rel-17 NR. In a case of configuring multi-PDSCH scheduling, it is necessary to determine how to transmit Scell dormancy indication. In a case that multi-PDSCH scheduling is configured, the UE needs to receive DCI to know whether single-PDSCH scheduling is indicated or multi-PDSCH scheduling is indicated, and to know the locations of the remaining fields, including the NDI field and the RV field, in the DCI. However, in the case of the DCI transmitting Scell dormancy indication, since a PDSCH is not scheduled, there is a problem in determining whether single-PDSCH scheduling is indicated or multi-PDSCH scheduling is indicated. The disclosure provides a method for this.

[First Method] DCI Interpretation Based on Assumption of DCI Indicating Single-PDSCH Scheduling

In the first method of the disclosure, although the UE has been configured with multi-PDSCH scheduling, it may be determined whether the <condition for transmitting Scell dormancy indication> is satisfied based on the assumption of the DCI indicating single-PDSCH scheduling. That is, although there is a possibility that the DCI schedules multi-PDSCH, the UE may reuse the <condition for transmitting Scell dormancy indication> defined in Rel-16 by interpreting the DCI as the DCI indicating single-PDSCH scheduling.

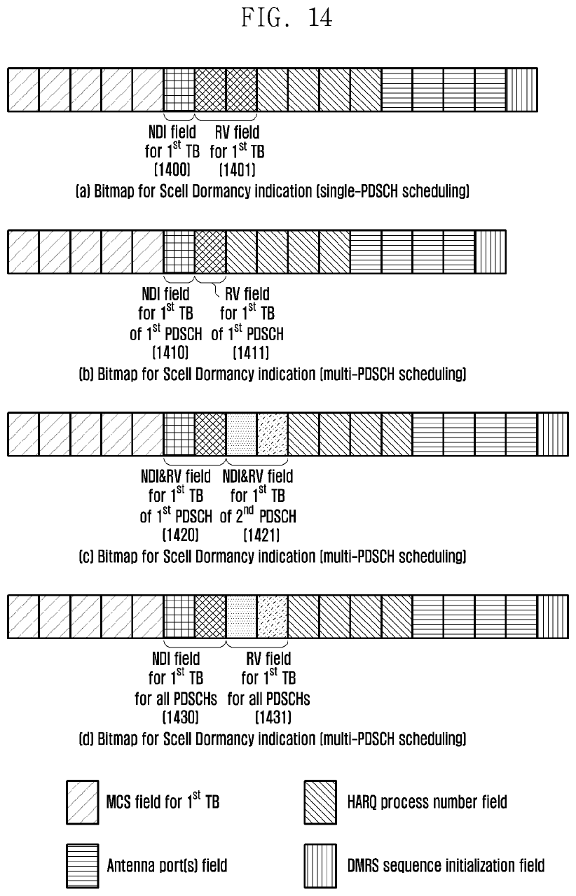

More specifically, in the first method, the UE may perform the following process. The UE may receive the DCI format 1_1 through a PDCCH. The UE may regard the DCI format 1_1 as the DCI indicating single-PDSCH scheduling. That is, it is interpreted as in FIG. 12(a). Here, since the received DCI format 1_1 is interpreted as the DCI indicating single-PDSCH scheduling, the NDI field of transport block 1 is regarded as 1 bit and the RV field of transport block 1 is considered as 2 bits. In addition, the locations of different fields (MCS field, HPN field, antenna port(s) field, DMRS sequence initialization field, FDRA field, one-shot HARQ-ACK request field, carrier indicator) are determined according to the 1-bit NDI field and the 2-bit RV field. The UE may determine whether the <condition for transmitting Scell dormancy indication> is satisfied using the determined FDRA field, one-shot HARQ-ACK request field, and carrier indicator field. In a case that the <condition for transmitting Scell dormancy indication> is satisfied, the UE considers the DCI as the DCI indicating single-PDSCH scheduling and may constitute the bitmap of Scell dormancy indication by combining the MCS field, the NDI field, the RV field, the HPN field, the antenna port(s) field, and the DMRS sequence initialization field in order. With referring to FIG. 14(a), the UE interprets the DCI as the DCI indicating single-PDSCH scheduling, and may constitute a bitmap of Scell dormancy indication by combining a 5-bit MCS field, a 1-bit NDI field 1400, a 2-bit RV field 1401, an HPN field, and an antenna port(s) field, and a DMRS sequence initialization field in order.

In a case that the <condition for transmitting Scell dormancy indication> is not satisfied, the UE may determine the DCI as the DCI scheduling PDSCH.

[Second Method] DCI Interpretation on the Assumption of DCI Scheduling Multi-PDSCH

In the second method of the disclosure, although the UE has been configured with multi-PDSCH scheduling, the UE may determine whether the <condition for transmitting Scell dormancy indication> is satisfied based on the assumption that DCI always indicates multi-PDSCH scheduling. That is, although there is a possibility that DCI schedules single-PDSCH, the UE considers and interprets the DCI indicating multi-PDSCH scheduling.

More specifically, in the second method, the UE may perform the following process. The UE may receive the DCI format 1_1 through a PDCCH. The UE may regard the DCI format 1_1 as the DCI indicating multi-PDSCH scheduling. That is, it is interpreted as in FIG. 12(b). Here, since the received DCI format 1_1 is interpreted as the DCI indicating multi-PDSCH scheduling, it is assumed that the NDI field of transport block 1 is K bits and the RV field of transport block 1 is K bits. In addition, the locations of different fields (a MCS field, a HPN field, an antenna port(s) field, a DMRS sequence initialization field, a FDRA field, a one-shot HARQ-ACK request field, a carrier indicator field, etc.) may be determined according to the K-bit NDI field and the K-bit RV field. The UE may determine whether the <condition for transmitting Scell dormancy indication> is satisfied using the determined FDRA field, one-shot HARQ-ACK request field, and carrier indicator field. In a case that the <condition for transmitting Scell dormancy indication> is satisfied, the UE interprets the DCI as the DCI indicating single-PDSCH scheduling, and may constitute a bitmap of Scell dormancy indication by combining the MCS field, the K-bit NDI field, the K-bit RV field, the HPN field, the antenna port(s) field, and the DMRS sequence initialization field in order. In a case that the <condition for transmitting Scell dormancy indication> is not satisfied, the UE may determine the DCI as the DCI scheduling PDSCH.

With reference to FIG. 12(b), when the DCI format 1_1 is interpreted as the DCI indicating multi-PDSCH scheduling, the DCI may include the K-bit NDI field and the K-bit RV field for scheduling up to K PDSCHs. Therefore, when generating a bitmap of Scell dormancy indication, the order of combining the K-bit NDI field and the K-bit RV field is required. As a method for this, the following method may be considered.

[Method 2-1] Only Using of the 1-Bit NDI Field and 1-Bit RV Field for the First PDSCH

In Method 2-1, only 1 bit of the NDI field and 1 bit of the RV field for the first PDSCH among the K-bit NDI field and the K-bit RV fields may be included in a bitmap of Scell dormancy indication. One bit of the K-bit NDI field may be a preceding most significant bit (MSB) of the K-bit NDI field. One bit of the K-bit RV field may be a preceding MSB of the K-bit RV field. That is, the bitmap of Scell dormancy indication may be combined of a MCS field of transport block 1, a 1 bit of the NDI field of the first PDSCH of transport block 1, a 1 bit of the RV field of the first PDSCH of transport block 1, a HPN field, an antenna port(s) field, a DMRS sequence initialization fields in order. With reference to FIG. 14(b), the UE interprets the DCI as the DCI indicating multi-PDSCH scheduling, and may constitute the bitmap of Scell dormancy indication by combining a 5-bit MCS field, a 1 bit 1410 of the NDI field of the first PDSCH of transport block 1, a 1 bit 1411 of the RV field of the first PDSCH of transport block 1, a HPN field, an antenna port(s) field, and a DMRS sequence initialization field in order.

[Method 2-2] Only using of bits of the NDI field and bits of the RV field corresponding to the number of scheduling information in the row of the TDRA field indicated in DCI

For example, the UE may determine whether to indicate single-PDSCH scheduling or multi-PDSCH scheduling based on the TDRA field included in DCI. For example, the UE may determine the number of bits of the NDI field and the number of bits of the RV field based on the TDRA field included in the DCI.

In method 2-2, the UE may determine the number of scheduling information (K0, SLIV, PDSCH mapping type) included in a row indicated through the TDRA field, and when the number is M, the M bits of the NDI field and the M bits of the RV field corresponding to M pieces of scheduling information may be included in the bitmap of Scell dormancy indication. However, the (K-M) bits of NDI field and the (K-M) bits of RV field that do not correspond to the M pieces of scheduling information may not be included in the bitmap of Scell dormancy indication. For reference, the M bits of the K-bit NDI field may be M bits proceeding the K-bit NDI field. The M bits of the K-bit RV field may be preceding M bits of the K-bit RV field. Therefore, the bitmap of Scell dormancy indication may be constituted by combining a MCS field of transport block 1, a M bits of the NDI field of transport block 1, a M bits of the RV field of transport block 1, a HPN field, an antenna port(s) field, a DMRS sequence initialization field in order.

[Method 2-3] Using of Bits of the NDI Field and Bits of the RV Field Corresponding to the Maximum Number of Scheduling Information Among the Rows of the TDRA Field

For example, the UE may determine whether to indicate single-PDSCH scheduling or multi-PDSCH scheduling based on the TDRA field included in DCI. For example, the UE may determine the number of bits of the NDI field and the number of bits of the RV field based on the TDRA field included in the DCI.

In Method 2-3, the UE may determine the maximum number of scheduling information (K0, SLIV, PDSCH mapping type) in a row indicated through the TDRA field, and the number is equal to K. That is, all bits of the K-bit NDI field and the K-bit RV field may be included in the bitmap of Scell dormancy indication. Therefore, the bitmap of Scell dormancy indication may be constituted by combining a MCS field of transport block 1, K bits of the NDI field of transport block 1, K bits of the RV field of transport block 1, a HPN field, an antenna port(s) field, a DMRS sequence initialization field in order.

<Alignment Method of NDI Field of a Plurality of Bits and RV Field of a Plurality of Bits>

In the foregoing Method 2-2 or 2-3, when a plurality of bits of the NDI field and a plurality of bits of the RV field are used as the bitmap of Scell dormancy indication, the order of the plurality of bits of the NDI field and the plurality of bits of the RV field are necessary to be determined. For convenience, it is assumed that the plurality of bits are K bits based on Method 2-3. However, the method of the disclosure may be equally applied to method 2-2.

[Method 2-4] Arrangement of K Bits of NDI Field in a Position Ahead of K Bits of RV Field in a Bitmap of Scell Dormancy Indication

According to Method 2-4, the K bits of the NDI field are continuously arranged in the bitmap, the K bits of the RV field are consecutively arranged in the bitmap, and the K bits of the RV field may be arranged in the bitmap following the K bits of the NDI field. With reference to FIG. 14 (d), according to this method, the bitmap of Scell dormancy indication may be constituted by combining the following in order:
bits of the MCS field of transport block 1;
K bits (1430) of the NDI field of transport block 1;
K bits (1431) of the RV field of transport block 1; and
bits of a HPN field, bits of an antenna port(s) field, and bits of a DMRS sequence initialization field.

[Method 2-5] Arrangement the Bit of NDI Field and Bit of RV Field of a Preceding PDSCH at a Position Earlier than the Bit of NDI Field and Bit of RV Field of a Later PDSCH in a Bitmap of Scell Dormancy Indication

According to method 2-5, in the bitmap, the bits of the NDI field and the bits of the RV field corresponding to a preceding PDSCH are arranged at positions preceding the bits of the NDI field and the bits of the RV field of a subsequent PDSCH. In addition, the bits of the NDI field and the bits of the RV field corresponding to one PDSCH are sequentially arranged. According to this method, the bitmap of Scell dormancy indication may be constituted by combining the followings in order:
bits of the MCS field of transport block 1;
1-bit of the NDI field corresponding to transport block 1 of the first PDSCH, 1-bit 1420 of the RV field corresponding to transport block 1 of the first PDSCH;
1-bit of the NDI field corresponding to transport block 1 of the second PDSCH, 1-bit 1421 of the RV field corresponding to transport block 1 of the second PDSCH;
1-bit of the NDI field corresponding to transport block 1 of the K-th PDSCH, 1-bit of the RV field corresponding to transport block 1 of the K-th PDSCH; and
bits of a HPN field, bits of an antenna port(s) field, and bits of a DMRS sequence initialization field.

<Optional Use of the First Method and the Second Method>

[Method 3-1] Selective Use of the First Method and the Second Method According to the Configuration of the Rows of a TDRA Table

In the first method, when determining <condition for transmitting Scell dormancy indication> and generating a bitmap, DCI was regarded as the DCI indicating single-PDSCH scheduling. However, in a case that all rows of the TDRA table indicate multi-PDSCH scheduling (that is, in a case that a plurality of pieces of scheduling information are configured in all rows), it may be unnecessary to regard the DCI as the DCI indicating single-PDSCH scheduling as in the first method. Accordingly, the use of the first method may be limited when at least one row among the rows of the TDRA table includes one piece of scheduling information. In a case that all rows of the TDRA table indicate multi-PDSCH scheduling, the second method may be used to determine <condition for transmitting Scell dormancy indication> and generate a bitmap. That is, the first method and the second method may be selectively used according to the configuration of rows of the TDRA table.

[Method 3-2] Selective Use of the First Method and the Second Method According to the Number of Scheduling Information in a Row Corresponding to a TDRA Field of a Received DCI

As another method, the first method and the second method may be selectively used according to the configuration of rows indicated by the TDRA field of the received DCI. That is, if the row indicated by the TDRA field of the received DCI includes one piece of scheduling information, the UE interprets the DCI in the first method to determine <condition for transmitting Scell dormancy indication> and generate a bitmap, and if the row indicated by the TDRA field of the received DCI includes two or more pieces of scheduling information, the UE interprets the DCI in the second method to determine the <condition for transmitting Scell dormancy indication> and generate a bitmap.

For reference, in Method 3-1, the first method or the second method is selected based on the configuration information of the TDRA table, but in Method 3-2, the first method or the second method is selected according to a row corresponding to the TDRA field of the received DCI.

<Flowchart>

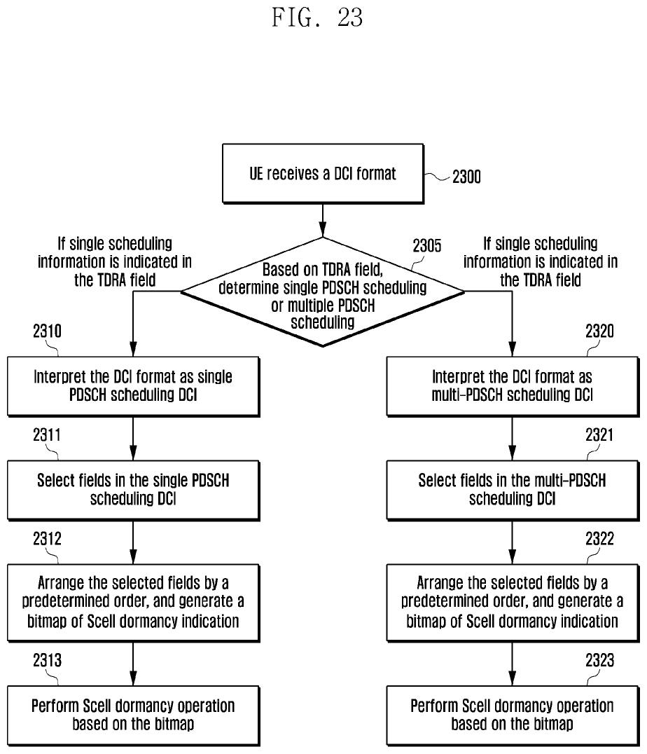

With reference to FIG. 23, a flowchart of a preferred combination of the disclosure is illustrated.

The UE receives a DCI format (2300). Here, the DCI format may include DCI format 1_1. Here, CRC of the DCI format may be scrambled with C-RNTI or MCS-C-RNTI.

The UE determines whether single-PDSCH scheduling or multi-PDSCH scheduling is indicated based on the value of the TDRA field of the received DCI format (2305). Here, if one piece of scheduling information is configured in a row corresponding to the value of the TDRA field, the UE may determine that the DCI format is the DCI indicating single-PDSCH scheduling. If two or more scheduling information is configured in a row corresponding to the value of the TDRA field, the UE may determine that the DCI format is the DCI indicating multi-PDSCH scheduling.

For example, the UE may determine whether to indicate single-PDSCH scheduling or multi-PDSCH scheduling based on the TDRA field included in DCI. For example, the UE may determine the number of bits of the NDI field and the number of bits of the RV field based on the TDRA field included in the DCI.

In a case that it is determined that the received DCI format is the DCI indicating single-PDSCH scheduling, the UE may interpret the DCI by considering the DCI as the DCI indicating single-PDSCH scheduling (2310). In the case of the DCI indicating single-PDSCH scheduling, a 1-bit NDI field and a 2-bit RV field may be included.

The UE may select some fields from the DCI interpreted as the DCI indicating single-PDSCH scheduling (2311). Here, some fields may include at least one of an MCS field of transport block 1, an NDI field of transport block 1, an RV field of transport block 1, an HPN field, an antenna port(s) field, and a DMRS sequence initialization field. Here, the NDI field may be 1-bit and the RV field may be 2-bits.

The selected fields may be combined and arranged in a predetermined order to generate a bitmap of Scell dormancy indication (2312). Here, according to the first method, the combining order may be the MCS field of transport block 1, the NDI field of transport block 1, the RV field of transport block 1, the HPN field, the antenna port(s) field, and the DMRS sequence initialization field.

The UE may perform Scell dormancy operation according to the generated bitmap (2313).

In a case that it is determined that the received DCI format is the DCI indicating multi-PDSCH scheduling, the UE may interpret the DCI by considering the DCI as the DCI indicating multi-PDSCH scheduling (2320). In the case of the DCI indicating multi-PDSCH scheduling, a K-bit NDI field and a K-bit RV field may be included.

The UE may select some fields from the DCI interpreted as the DCI indicating multi-PDSCH scheduling (2321). Here, some fields may include at least one of a MCS field of transport block 1, an NDI field of transport block 1, a RV field of transport block 1, an HPN field, an antenna port(s) field, and a DMRS sequence initialization field. Here, according to Method 2-1, the selected NDI field may be 1-bit corresponding to the first PDSCH, and the RV field may be 1-bit corresponding to the first PDSCH. Here, according to Method 2-2, the selected NDI field may be M-bit corresponding to M, which is the number of scheduling information in a row corresponding to the TDRA field, and the RV field may be M-bit corresponding to M, which is the number of scheduling information in a row corresponding to the TDRA field.

The selected fields may be combined and arranged in a predetermined order to generate a bitmap of Scell dormancy indication (2322). Here, the order of the combination may be determined by Method 2-3 or Method 2-4.

The UE may perform Scell dormancy operation according to the generated bitmap (2323).

[Fourth Method] Only when the TDRA field indicates single-PDSCH scheduling, it can be interpreted as Scell dormancy indication. In a case that the TDRA field indicates multi-PDSCH scheduling, it is not interpreted as Scell dormancy indication.

The Rel-16 scheme was applied for determining the <condition for transmitting Scell dormancy indication> in the first method or the second method. However, in a case that multi-PDSCH scheduling is configured, the <condition for transmitting Scell dormancy indication> may be different. In the fourth method, when multi-PDSCH scheduling is indicated, the UE may not consider the Scell dormancy indication. That is, only in the case that single-PDSCH scheduling is indicated, the UE may determine whether Scell dormancy indication is transmitted according to the <condition for transmitting a Scell dormancy indication>.

With reference to the flowchart of FIG. 23, the fourth method is specifically as follows.

The UE receives a DCI format (2300). Here, the DCI format may include DCI format 1_1. Here, the CRC of the DCI format may be scrambled with C-RNTI or MCS-C-RNTI.

The UE determines whether single-PDSCH scheduling or multi-PDSCH scheduling is indicated based on the value of the TDRA field of the received DCI format (2305). Here, if one piece of scheduling information is configured in a row corresponding to the value of the TDRA field, the UE may determine that it is the DCI indicating single-PDSCH scheduling. If two or more scheduling information is configured in a row corresponding to the value of the TDRA field, the UE may determine that it is the DCI indicating multi-PDSCH scheduling.

In a case that the UE determines that the received DCI format is the DCI indicating single-PDSCH scheduling, the DCI may be interpreted by considering the DCI as the DCI indicating single-PDSCH scheduling (2310). In the case of the DCI indicating single-PDSCH scheduling, a 1-bit NDI field and a 2-bit RV field may be included.

The UE may select some fields from the DCI interpreted as the DCI indicating single-PDSCH scheduling (2311). Here, some fields may include at least one of an MCS field of transport block 1, an NDI field of transport block 1, an RV field of transport block 1, an HPN field, an antenna port(s) field, and a DMRS sequence initialization field. Here, the NDI field may be 1-bit and the RV field may be 2-bits.

The selected fields may be combined and arranged in a predetermined order to generate a bitmap of Scell dormancy indication (2312). Here, according to the first method, the combining order may be the MCS field of transport block 1, the NDI field of transport block 1, the RV field of transport block 1, the HPN field, the antenna port(s) field, and the DMRS sequence initialization field.

The UE may perform Scell dormancy operation according to the generated bitmap (2313).

In a case that the UE determines that the received DCI format is the DCI indicating multi-PDSCH scheduling, the DCI may be interpreted by considering the DCI as the DCI indicating multi-PDSCH scheduling (2320). However, it can be assumed that the DCI does not indicate Scell dormancy indication. That is, the UE may interpret the DCI indicating multi-PDSCH scheduling by limiting it to only the DCI scheduling PDSCH.

[Fifth Method] Introduction of a DCI Interpretation Indicator for Scell Dormancy Indication

The interpretation method of Scell dormancy indication according to the fourth method described above can be limitedly used because the UE determines the interpretation according to the number of scheduling information in a row corresponding to the value of the TDRA field. For example, in a case that all rows of the TDRA field include a plurality of pieces of scheduling information, Scell dormancy indication cannot be indicated according to the fourth method. To solve this, the DCI may include an explicit Scell dormancy indication use indicator. The explicit Scell dormancy indication use indicator may be 1 bit, and if the 1 bit is one value (e.g., “0”), the UE may determine that the DCI is the DCI for scheduling the PDSCH, and if the 1 bit is another one (e.g., “1”), the UE may determine that the DCI is the DCI transmitting Scell dormancy indication. In a case that the DCI is determined the DCI transmitting Scell dormancy indication, the UE may configure a bitmap of Scell dormancy indication based on the DCI. Here, the bitmap may be configured according to the first method or the second method described above.

As another method, a new RNTI value may be defined in place of the 1-bit indicator. That is, in the case of receiving the DCI format 1_1 in which CRC is scrambled with a new RNTI value, the UE may determine that DCI format 1_1 is Scell dormancy indication. In this case, the bitmap of Scell dormancy indication in the DCI format 1_1 may be determined according to the first method or the second method.

[Related to SPS/CG]

3GPP NR introduces a downlink semi-persistent scheduling (SPS) PDSCH reception method and an uplink configured grant (CG) PUSCH transmission method for periodic information transmission and reception. Although it will be described based on downlink SPS PDSCH reception in the following disclosure, the disclosure may be applied to uplink CG PUSCH transmission.

More specifically, the UE may receive a configuration for receiving SPS PDSCH from the base station. This may be configured as follows through an upper layer signal (e.g., an RRC signal):
cs-RNTI: A RNTI value for activation, deactivation (or release), and retransmission of SPS PDSCH. When the UE receives the DCI format in which the CRC is scrambled with the cs-RNTI value, the UE determines the DCI format as the DCI format indicating one of activation, deactivation, and retransmission of the SPS;
nrofHARQ-Processes: the number of HARQ processes configured in SPS;
harq-ProcID-Offset: an offset value of the HARQ process for SPS; and/or
periodicity: SPS PDSCH reception period. Unless otherwise specified, the periodicity is indicated in slot unit.

In a case that SPS is activated, a slot in which the N-th SPS PDSCH is received is determined according to Equation 3 below.

(numberOfSlotsPerFrame×SFN+slot number in the frame)=[(numberOfSlotsPerFrame×SFN_{start time}+slot_{start time})+N×periodicity×numberOfSlotsPerFrame/10] modulo(1024×numberOfSlotsPerFrame). [Equation 3]

Here, the SFN_{start time} and the slot_{start time} are a system frame number (SFN) and a slot in which the first PDSCH is received after the SPS is (re)initialized, respectively. numberOfSlotPerFrame is the number of slots included in one frame. In the case of 15 kHz subcarrier spacing, numberOfSlotPerFrame is 10, in the case of 30 kHz subcarrier spacing, numberOfSlotPerFrame is 20, in the case of 60 kHz subcarrier spacing, numberOfSlotPerFrame is 40, in the case of 120 kHz subcarrier spacing, numberOfSlotPerFrame is 80, in the case of 240 kHz subcarrier spacing, numberOfSlotPerFrame is 160, in the case of 480 kHz subcarrier spacing, numberOfSlotPerFrame is 320, and in the case of 960 kHz subcarrier spacing, numberOfSlotPerFrame is 640.

In the case of the SPS PDSCH, the HARQ process ID may be determined by the following equation.

HARQ Process ID=[floor (CURRENT_slot×10/(numberOfSlotsPerFrame×periodicity))]modulo nrofHARQ-Processes+harq-ProcID-Offset. [Equation 4]

Here, CURRENT_slot is an index of a slot in which SPS PDSCH is received, and CURRENT_slot is [(SFN×numberOfSlotsPerFrame)+slot number in the frame]. For reference, if harq-ProcID-Offset is not configured from an upper layer, its value is 0.

As described above, in a case that the UE receives the DCI format in which CRC is scrambled with cs-RNTI, the UE may determine the DCI format as the DCI format indicating activation, deactivation, or retransmission of the SPS. In more detail, the UE may determine the DCI format indicating the activation, deactivation, or retransmission of the SPS according to the following conditions.

The UE determines the DCI format as SPC activation or deactivation DCI format when the following conditions are satisfied:
CRC of the DCI format is scrambled with cs-RNTI;
The NDI field of the enabled transport block of the DCI format is configured to “0”;
If a downlink feedback indicator (DFI) flag field exists in the DCI format, it is configured to “0”; and/or
The PDSCH-to-HARQ_feedback timing indicator field of the DCI format does not indicate an “inapplicable value.”

One or a plurality of SPS configurations may be configured for the UE. In a case that one SPS configuration is configured for the UE, the UE determines the DCI format as an SPS activation DCI format if the HPN field or RV field of the received DCI format satisfies a specific condition. Here, the specific condition of the HPN field or the RV field is illustrated in Table 24. In a case that the HPN field, RV field, MCS field, and FDRA field of the received DCI format satisfy a specific condition, the UE determines the DCI format as the SPS deactivation DCI format. Here, the specific conditions of the HPN field, RV field, MCS field, and FDRA field are shown in Table 25.

TABLE 24

| | DCI format | DCI format | DCI format |
|---|---|---|---|
| | 0_0/0_1/0_2 | 1_0/1_2 | 1_1 |
| HARQ process | set to all “0”s | set to all “0”s | set to all “0”s |
| number | | | |
| Redundancy | set to all “0”s | set to all “0”s | For the endabled |
| version | | | transport block: |
| | | | set to all “0”s |

TABLE 25

| | DCI format | DCI format |
|---|---|---|
| | 0_0/0_1/0_2 | 1_0/1_1/1_2 |
| HARQ process number | set to all “0”s | set to all “0”s |
| Redundancy version | set to all “0”s | set to all “0”s |
| Modulation and coding | set to all “1”s | set to all “1”s |
| scheme | | |
| Frequency domain | set to all “0”s for | set to all “0”s for |
| resource assignment | FDRA Type 2 with | FDRA Type 0 or for |
| | μ = 1 | dynamicSwitch |
| | set to all “1”s, | set to all “1”s for |
| | otherwise | FDRA Type 1 |

In a case that a plurality of SPS configurations is configured for the UE, the UE determines that the DCI format is an SPS activation DCI format if the RV field of the received DCI format satisfies a specific condition. Here, the specific conditions of the RV field are shown in Table 26. If the RV field, MCS field, and FDRA field of the received DCI format satisfy a specific condition, the UE determines the DCI format as the SPS deactivation DCI format. Here, the specific conditions of the RV field, MCS field, and FDRA field are shown in Table 27.

In a case that the DCI format satisfies the condition shown in Table 26, the HPN field may indicate which SPS configuration among a plurality of SPS configurations is activated. For reference, each SPS configuration may have a unique ID, and the HPN field of the DCI format may indicate the unique ID.

In a case that the DCI format satisfies the conditions shown in Table 27, the HPN field may indicate which SPS configuration among a plurality of SPS configurations is deactivated. For reference, each SPS configuration may have a unique ID, and the HPN field of the DCI format may indicate the unique ID. In addition, in a case that a condition is satisfied as shown in Table 27 of the DCI format, the HPN field may combine some or all the plurality of SPS configurations to make groups and indicate which group is deactivated. For reference, a group combining SPS configurations may have a unique ID, and the HPN field of the DCI format may indicate the unique ID.

TABLE 26

| | DCI format | DCI format | DCI format |
|---|---|---|---|
| | 0_0/0_1/0_2 | 1_0/1_2 | 1_1 |
| Redundancy | set to all “0”s | set to all “0”s | For the endabled |
| version | | | transport block: |
| | | | set to all “0”s |

TABLE 27

| | DCI format | DCI format |
|---|---|---|
| | 0_0/0_1/0_2 | 1_0/1_1/1_2 |
| Redundancy version | set to all “0”s | set to all “0”s |
| Modulation and coding | set to all “1”s | set to all “1”s |
| scheme | | |
| Frequency domain | set to all “0”s for | set to all “0”s for |
| resource assignment | FDRA Type 2 with | FDRA Type 0 or for |
| | μ = 1 | dynamicSwitch |
| | set to all “1”s, | set to all “1”s for |
| | otherwise | FDRA Type 1 |

The base station may retransmit SPS PDSCH to the UE. The base station may transmit the DCI format for SPS PDSCH retransmission to the UE. The DCI format may be referred to as an SPS retransmission DCI format. By receiving the DCI format, the UE may receive again a transport block for the previously received SPS PDSCH. More specifically, the UE needs to determine whether the DCI format is the DCI format for retransmitting the SPS PDSCH. The DCI format for retransmitting the SPS PDSCH satisfies the following conditions:
CRC of DCI format is scrambled with cs-RNTI value, and/or
The value of the NDI field included in the DCI format is “1.”

For reference, the SPS activation DCI format and the SPS deactivation DCI format have a value of the NDI field of “0,” but may be distinguished from each other because the value of the NDI field of the SPS retransmission DCI format is “1.” The UE may obtain the HARQ process ID of the SPS PDSCH to be retransmitted from the HPN field of the DCI format. That is, the UE can determine which SPS PDSCH is retransmitted from the HPN field even if the reception of a plurality of SPS PDSCHs fails.

<Second Embodiment: An Activation/Deactivation Method of Semi-Persistent Scheduling PDSCH Reception (Configured Grant PUSCH Transmission) in a Case of Configuring Multi-PDSCH (Multi-PUSCH) Scheduling>

The problem to be solved in the disclosure relates to a method of determining SPS PDSCH reception activation in the case of configuring multi-PDSCH scheduling.

Thereafter, unless otherwise specified, the CRC of DCI format is scrambled with cs-RNTI.

[Method 1-1] SPS Activation Method Using Multi-PDSCH Scheduling (Sequential Application of Scheduling Information within a Period) in a Case of Single SPS Configuration

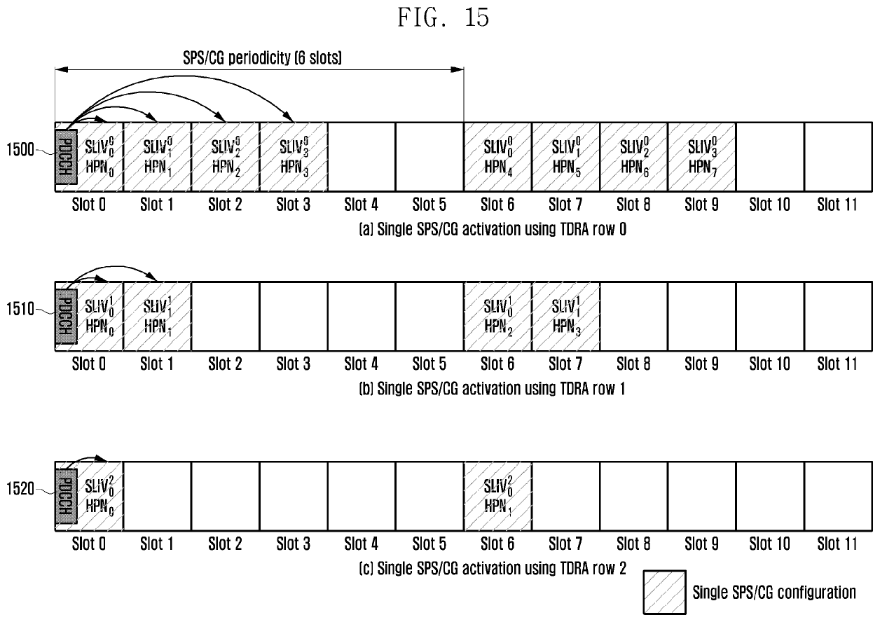

With reference to FIG. 15, in the case of configuration of multi-PDSCH scheduling, SPS PDSCH reception according to SPS activation is illustrated. Here, when the DCI format indicates multi-PDSCH scheduling, the plurality of scheduling information is sequentially applied within the period of the SPS configuration.

With reference to FIG. 15(c), a case in which the TDRA field of the DCI format received in a PDCCH 1520 indicates row 2 is illustrated. Here, since row 2 has one piece of scheduling information (K0, SLIV, and PDSCH mapping type), the UE may determine a first slot in which SPS PDSCH will be received based on the scheduling information (here, the slot is slot 0 assuming K0=0). Also, a symbol to be received in the slot may be determined as SLIV²₀. The HARQ process ID of SPS PDSCH of the first slot may be determined according to Equation 4. In a case that the activated SPS configuration of the DCI format is configured to periodicity=6, the UE may receive the next SPS PDSCH in slot 6. That is, the UE may receive the SPS PDSCH from the symbol indicated by SLIV²₀ in slot 6*n (n=0, 1, 2, . . . ). Also, the HARQ process ID is sequentially increased by the HARQ process ID determined in the first slot. A more specific determination method of HARQ process ID will be described later.

With reference to FIG. 15(b), a case in which the TDRA field of the DCI format received in a PDCCH 1510 indicates row 1 is illustrated. Here, since row 1 has two pieces of scheduling information (K0, SLIV, PDSCH mapping type), the UE may determine a first slot in which SPS PDSCH is to be received based on the first scheduling information (K0, SLIV, PDSCH mapping type) among the two pieces of scheduling information (K0, SLIV, PDSCH mapping type) (Here, the slot is slot 0 assuming K0=0). Also, a symbol to be received in the slot may be determined as SLIV¹₀. In addition, the UE may determine a second slot in which SPS PDSCH is to be received based on the second scheduling information (K0, SLIV, PDSCH mapping type) among the two pieces of scheduling information (K0, SLIV, PDSCH mapping type) (Here, the slot is slot 1 assuming K0=1). Also, a symbol to be received by the UE in the slot may be determined as SLIV¹₁.

The UE may determine a slot determined based on each scheduling information, and a slot to receive a next SPS PDSCH based on periodicity of activated SPS configuration and symbols to receive. In a case that the SPS configuration is configured to periodicity=6, the UE may receive SPS PDSCH from slot 0, which is the first slot determined based on the first scheduling information among the two pieces of scheduling information, and slots 6, 12, . . . , which are slots correspond to periodicity=6. In addition, the UE may receive SPS PDSCH from slot 1, which is the first slot determined based on the second scheduling information among the two pieces of scheduling information, and slots 7, 13, . . . , which are slots correspond to periodicity=6. Also, the HARQ process ID is sequentially increased by the HARQ process ID determined in the first slot. A more specific determination method of the HARQ process ID will be described later.

With reference to FIG. 15(a), a case in which the TDRA field of the DCI format received in a PDCCH 1500 indicates row 0 is illustrated. Here, since row 0 has four pieces of scheduling information (K0, SLIV, PDSCH mapping type), the UE may determine a first slot in which SPS PDSCH will be received based on a first scheduling information among the four pieces of scheduling information (Here, the slot is slot 0 assuming K0=0). Also, a symbol to be received by the UE in the slot may be determined to be SLIV⁰₀. Then, the UE may determine a second slot in which SPS PDSCH is to be received based on a second scheduling information among the four pieces of scheduling information (Here, the slot is slot 1 assuming K0=1). Also, a symbol to be received by the UE in the slot may be determined as SLIV⁰₁. In addition, the UE may determine a third slot in which SPS PDSCH is to be received based on a third scheduling information (K0, SLIV, PDSCH mapping type) among the four pieces of scheduling information (Here, the slot is slot 2 assuming K0=2). Also, a symbol to be received by the UE in the slot may be determined as SLIV⁰₂. In addition, the UE may determine a fourth slot in which the SPS PDSCH is to be received based on a fourth scheduling information among the four pieces of scheduling information. (Here, the slot is slot 3 assuming K0=3) Also, a symbol to be received by the UE in the slot may be determined as SLIV⁰₃.

The UE may determine a slot determined based on each scheduling information, and a slot to receive a next SPS PDSCH based on periodicity of activated SPS configuration and symbols to receive. In a case that the SPS configuration is configured to periodicity=6, the UE may receive SPS PDSCH from slot 0, which is a first slot determined based on a first scheduling information, among four pieces of scheduling information, and slots 6, 12, . . . , which are slots corresponding to periodicity=6. In addition, the UE may receive SPC PDSCH from slot 1, which is a first slot determined based on a second scheduling information, among the four pieces of scheduling information, and slots 7, 13, . . . , which are slots corresponding to periodicity=6. In addition, the UE may receive SPC PDSCH from slot 2, which is the first slot determined based on a third scheduling information among the four pieces of scheduling information, and slots 8, 14, . . . , which are slots corresponding to periodicity=6. In addition, the UE may receive SPC PDSCH from slot 3, which is the first slot determined based on a fourth scheduling information among the four pieces of scheduling information, and slots 9, 15, . . . , which are slots corresponding to periodicity=6.

The HARQ process ID of SPS PDSCH may be obtained by sequentially increasing the HARQ process ID determined in the first slot. A more specific determination method of the HARQ process ID will be described later.

With reference to FIG. 15, a method of determining the HARQ process ID is as follows. First, the UE may determine the HARQ process ID of the first PDSCH based on Equation 4. That is, in FIGS. 15(a), (b), and (c), HPN₀, which is the HARQ process ID of the first PDSCH, may be determined based on Equation 4. Thereafter, the HARQ process ID may be obtained by sequentially increasing HPN₀, which is the HARQ process ID of the first SPS PDSCH. More specifically, if the HARQ process ID of the first SPS PDSCH is HPN₀=X, the HARQ process ID (HPN₁) of a next SPS PDSCH is as follows:

HPN₁=(HPN₀+1) modulo nrofHARQ-Processes+harq-ProcID-Offset.

More generally, the HARQ process ID (HPNᵢ) of the i-th SPS PDSCH after the first SPS PDSCH is as follows:

HPNᵢ=(HPN₀+i) modulo nrofHARQ-Processes+harq-ProcID-Offset.

[Method 1-2] SPS Activation Method Using Multi-PDSCH Scheduling (Scheduling Information Sequentially Applied for Each Period) in the Case of Single SPS Configuration

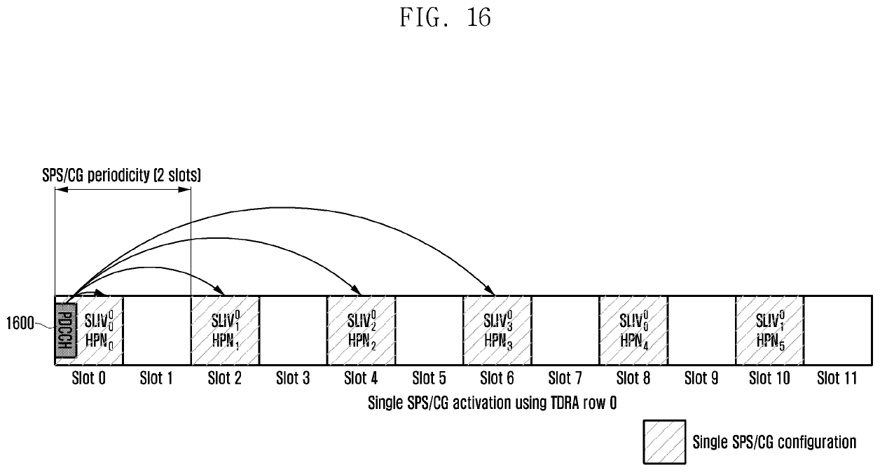

With reference to FIG. 16, in a case that multi-PDSCH scheduling is configured, SPS PDSCH reception according to SPS PDSCH reception activation is illustrated. Here, if the DCI format indicates multi-PDSCH scheduling, a plurality of pieces of scheduling information is sequentially applied for each period of SPS configuration.

With reference to FIG. 16, a case in which the TDRA field of the DCI format received in a PDCCH 1600 indicates row 0 is illustrated. Here, since row 0 has four pieces of scheduling information (K0, SLIV, PDSCH mapping type), the UE may determine a first slot within a first period in which SPS PDSCH is to be received based on a first scheduling information among the four pieces of scheduling information (Here, the slot is slot 0 assuming K0=0) Also, a symbol to be received by the UE in the slot may be determined to be SLIV⁰₀. Also, the UE may determine a second slot within a second period in which SPS PDSCH is to be received based on a second scheduling information among the four pieces of scheduling information (Here, K0 is not used and is determined according to the first slot and a period of SPS configuration. Here, the slot is slot 2 assuming that the period is 2) Also, a symbol to be received by the UE in the slot may be determined as SLIV⁰₁. In addition, the UE may determine a third slot in a third period in which SPS PDSCH is to be received based on a third scheduling information among the four pieces of scheduling information (Here, K0 is not used and is determined according to the first slot and the period of SPS configuration. Here, the slot is slot 4 assuming the period is 2). Also, a symbol to be received by the UE in the slot may be determined as SLIV⁰₂. In addition, the UE may determine a fourth slot in a fourth period in which SPS PDSCH is to be received based on a fourth scheduling information among the four pieces of scheduling information (Here, K0 is not used and is determined according to the first slot and the period of SPS configuration. Here, the slot is slot 6 assuming the period is 2). Also, a symbol to be received by the UE in the slot may be determined as SLIV⁰₃. Thereafter, the UE may again determine a fifth slot in a fifth period in which SPS PDSCH is to be received based on a first scheduling information among the four pieces of scheduling information (Here, K0 is not used and is determined according to the first slot and the period of SPS configuration. Here, the slot is slot 8 assuming the period is 2), and a symbol to be received by the UE in the slot may be determined as SLIV⁰₀. This is determined by repetition. In other words, when the number of indicated scheduling information is N, the SPS PDSCH to be received within the k=i*N+n-th period is determined according to the n-th scheduling information. Here, i is 0, 1, 2 . . . .

Here, the HARQ process ID may be determined in the same manner as in the above method 1-1.

[Method 2-1] SPS Activation Method Using Multi-PDSCH Scheduling (Same Periodicity) in a Case of a Plurality of SPS Configurations

The UE may receive a plurality of SPS configurations. When receiving the plurality of SPS configurations, each SPS configuration may include a unique index. In addition, each SPS configuration may include nrofHARQ-Processes, harq-ProcID-Offset, and periodicity. In the following description, for convenience, nrofHARQ-Processes, harq-ProcID-Offset, and periodicity of the SPS configuration having a unique index of n are referred to as nrofHARQ-Processes(n), harq-ProcID-Offset(n), and periodicity(n).

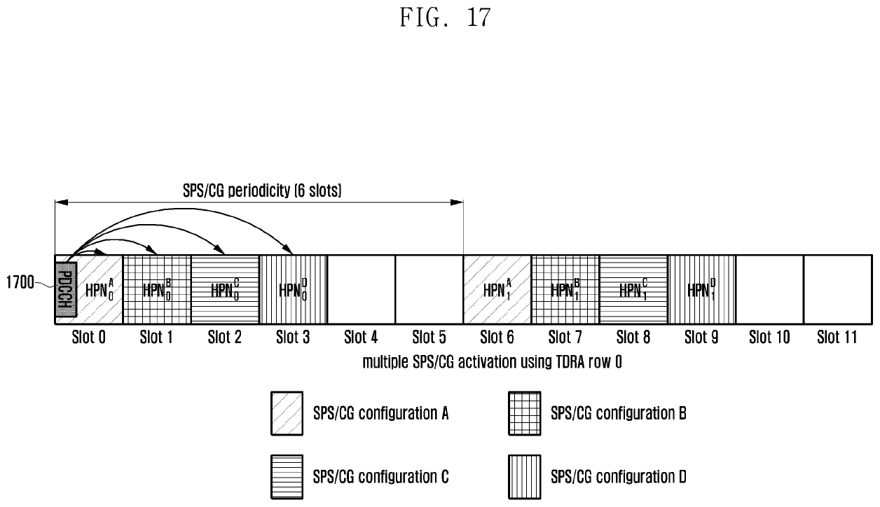

With reference to FIG. 17, in the case of configuring multi-PDSCH scheduling, SPS PDSCH reception according to SPS PDSCH reception activation is illustrated. Here, it is assumed that the plurality of SPS configurations is received, but the SPS to be activated in multi-PDSCH scheduling is based on the same periodicity. In addition, for convenience of description, the plurality of pieces of scheduling information is sequentially applied within the period of SPS configuration as in Method 1-1 above. However, Method 2-1 may also be applied to Method 1-2 above.

In the disclosure, there may be a corresponding SPS configuration in each scheduling information of multi-PDSCH scheduling in the DCI format indicating SPS activation. The UE may receive the SPS configuration corresponding to the scheduling information from the base station through an upper layer. Exemplarily, the base station may configure the SPS configuration corresponding to each scheduling information of each row of the TDRA table to the UE. In this case, the scheduling information may be expressed as (K0, SLIV, PDSCH mapping type, SPS configuration ID). Here, the SPS configuration ID may be a unique ID of the SPS configuration.

With reference to FIG. 17, a case in which the TDRA field of the DCI format received in a PDCCH 1700 indicates row 0 is illustrated. Here, since row 0 has four pieces of scheduling information (K0, SLIV, PDSCH mapping type), the UE may determine a first slot in which SPS PDSCH is to be received based on a first scheduling information among the four pieces of scheduling information (Here, the slot is slot 0 assuming K0=0) Also, a symbol to be received by the UE in the slot may be determined to be SLIV⁰₀. Additionally, there may be an SPS configuration A corresponding to the first scheduling information. Accordingly, the SPS configuration A corresponding to the first scheduling information may be received in the SPS PDSCH. For reference, a HARQ process ID may be determined according to the SPS configuration A. This will be described later.

In addition, the UE may determine a second slot in which SPS PDSCH is to be received based on a second scheduling information among the four pieces of scheduling information (K0, SLIV, and PDSCH mapping type) (Here, the slot is slot 1 assuming K0=1) Also, a symbol to be received by the UE in the slot may be determined as SLIV⁰₁. Additionally, there may be an SPS configuration B corresponding to the second scheduling information. Accordingly, the SPS configuration B corresponding to the second scheduling information may be received in the SPS PDSCH. For reference, the HARQ process ID may be determined according to the SPS configuration B. This will be described later.

In addition, the UE may determine a third slot in which SPS PDSCH is to be received based on a third scheduling information among the four pieces of scheduling information (K0, SLIV, and PDSCH mapping type) (Here, the slot is slot 2 assuming K0=2). Also, a symbol to be received by the UE in the slot may be determined as SLIV® 2. Additionally, there may be an SPS configuration C corresponding to the third scheduling information. Accordingly, the SPS configuration C corresponding to the third scheduling information may be received in the SPS PDSCH. For reference, the HARQ process ID may be determined according to the SPS configuration C. This will be described later.

In addition, the UE may determine a fourth slot in which SPS PDSCH is to be received based on a fourth scheduling information (K0, SLIV, PDSCH mapping type) among the four pieces of scheduling information (K0, SLIV, PDSCH mapping type) (Here, the slot is slot 3 assuming K0=3). Also, a symbol to be received by the UE in the slot may be determined as SLIV® 3. Additionally, there may be an SPS configuration D corresponding to the fourth scheduling information. Accordingly, the SPS configuration D corresponding to the fourth scheduling information may be received in the SPS PDSCH. For reference, the HARQ process ID may be determined according to the SPS configuration D. This will be described later.

In a case that a plurality of activated SPS configurations (A, B, C, D) of the DCI format is configured with the same periodicity, the UE may determine a slot determined based on each scheduling information and a slot to receive a next SPS PDSCH based on the same periodicity and symbols to receive. In a case that the SPS configurations (A, B, C, D) are configured to the same periodicity=6, the UE may receive SPS PDSCH of SPS configuration A from slot 0, which is a first slot determined based on a first scheduling information among the four pieces of scheduling information (K0, SLIV, PDSCH mapping type), and slots 6, 12, . . . , which are slots corresponding to periodicity=6. In addition, the UE may receive SPS PDSCH of the SPS configuration B from slot 1, which is a first slot determined based on a second scheduling information among the four pieces of scheduling information (K0, SLIV, PDSCH mapping type), and slots 7, 13, . . . , which are slots corresponding to periodicity=6. In addition, the UE may receive SPS PDSCH of the SPC configuration C from slot 2, which is a first slot determined based on a third scheduling information among the four pieces of scheduling information (K0, SLIV, PDSCH mapping type), and slots 8, 14, . . . , which are slots corresponding to periodicity=6. In addition, the UE may receive SPS PDSCH of the SPS configuration D from slot 3, which is a first slot determined based on a fourth scheduling information among the four pieces of scheduling information (K0, SLIV, PDSCH mapping type), and slots 9, 15, . . . , which are slots corresponding to periodicity=6.

With reference to FIG. 17, a method of determining a HARQ process ID is as follows. First, the UE may determine the HARQ process ID of a first SPS PDSCH of each SPS configuration based on Equation 4. That is, in FIG. 17, HPN^{A}₀, which is the HARQ process ID of the first SPS PDSCH of the SPS configuration A, HPN^{B}₀, which is the HARQ process ID of the first SPS PDSCH of the SPS configuration B, HPN^{C}₀, which is the HARQ process ID of the first SPS PDSCH of the SPS configuration C, and HPN^{D}₀, which is the HARQ process ID of the first SPS PDSCH of the SPS configuration D, may be determined based on Equation 4. Thereafter, the HARQ process ID of the SPS PDSCH of each SPS configuration may be obtained by sequentially increasing each of HPN^{A}₀, HPN^{B}₀, HPN^{C}₀, and HPN^{D}₀, which are the HARQ process IDs of the first SPS PDSCH of the corresponding SPS configuration. More specifically, if the HARQ process ID of the first SPS PDSCH of the SPS configuration A of FIG. 17 is HPN^{A}₀=X, the HARQ process ID (HPN^{A}₁) of a next SPS PDSCH of the SPS configuration A is as follows:

HPN₁=(HPN₀+1) modulo nrofHARQ-Processes(A)+harq-ProcID-Offset(A).

Here, nrofHARQ-Processes(A) and harq-ProcID-Offset(A) are the values configured in the SPS configuration A.

More generally, the HARQ process ID (HPNᵢ) of the i-th SPS PDSCH after the first SPS PDSCH of the SPS configuration A is as follows:

HPNᵢ=(HPN₀+i) modulo nrofHARQ-Processes(A)+harq-ProcID-Offset(A).

[Method 2-2] SPS Activation Method Using Multi-PDSCH Scheduling (Different Periodicity) in a Case of a Plurality of SPS Configurations

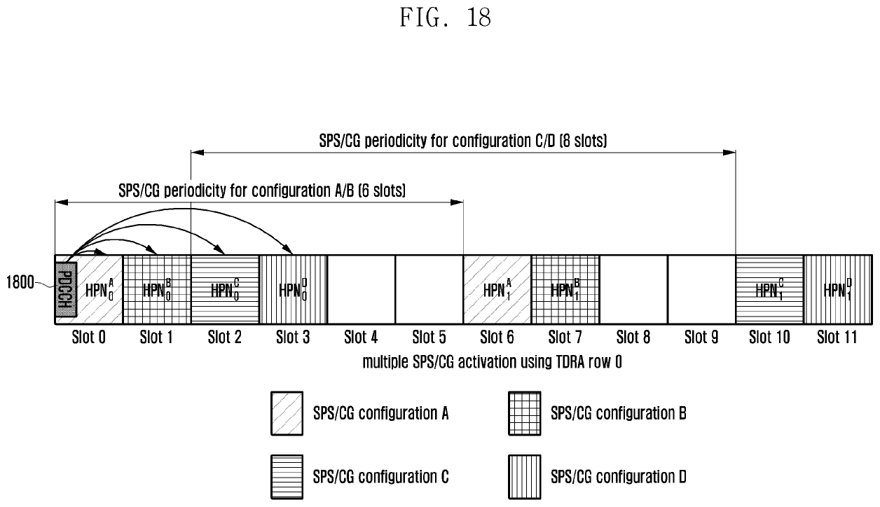

With reference to FIG. 18, in a case that multi-PDSCH scheduling is configured, SPS PDSCH reception according to SPS PDSCH reception activation is illustrated. Here, it is assumed that a plurality of SPS configurations is received, but SPS activated in multi-PDSCH scheduling is based on different periodicities. In addition, for convenience of description, the plurality of pieces of scheduling information is sequentially applied within the period of SPS configuration as in Method 1-1 above. However, Method 2-1 may also be applied to Method 1-2 above.

With reference to FIG. 18, a case in which the TDRA field of the DCI format received in a PDCCH 1800 indicates row 0 is illustrated. Here, since row 0 has four pieces of scheduling information (K0, SLIV, PDSCH mapping type), the UE may determine a first slot in which SPS PDSCH is to be received based on a first scheduling information among the four pieces of scheduling information (Here, the slot is slot 0 assuming K0=0). Also, a symbol to be received by the UE in the slot may be determined to be SLIV⁰₀. Additionally, there may be an SPS configuration A corresponding to the first scheduling information. Accordingly, the SPS configuration A corresponding to the first scheduling information may be received in the SPS PDSCH. For reference, a HARQ process ID may be determined according to the SPS configuration A. This will be described later.

In addition, the UE may determine a second slot in which SPS PDSCH is to be received based on a second scheduling information among the four pieces of scheduling information (K0, SLIV, and PDSCH mapping type) (Here, the slot is slot 1 assuming K0=1). Also, a symbol to be received by the UE in the slot may be determined as SLIV⁰₁. Additionally, there may be an SPS configuration B corresponding to the second scheduling information. Accordingly, the SPS configuration B corresponding to the second scheduling information may be received in the SPS PDSCH. For reference, the HARQ process ID may be determined according to the SPS configuration B. This will be described later.

In addition, the UE may determine a third slot in which SPS PDSCH is to be received based on a third scheduling information among the four pieces of scheduling information (K0, SLIV, and PDSCH mapping type) (Here, the slot is slot 2 assuming K0=2). Also, a symbol to be received by the UE in the slot may be determined as SLIV⁰₂. Additionally, there may be an SPS configuration C corresponding to the third scheduling information. Accordingly, the SPS configuration C corresponding to the third scheduling information may be received in the SPS PDSCH. For reference, the HARQ process ID may be determined according to the SPS configuration C. This will be described later.

In addition, the UE may determine a fourth slot in which SPS PDSCH is to be received based on a fourth scheduling information among the four pieces of scheduling information (K0, SLIV, and PDSCH mapping type) (Here, the slot is slot 3 assuming K0=3). Also, a symbol to be received by the UE in the slot may be determined as SLIV⁰₃. Additionally, there may be an SPS configuration D corresponding to the fourth scheduling information. Accordingly, the SPS configuration D corresponding to the fourth scheduling information may be received in the SPS PDSCH. For reference, the HARQ process ID may be determined according to the SPS configuration D. This will be described later.

In a case that a plurality of activated SPS configurations (A, B, C, D) of the DCI format is configured with different periodicities, the UE may determine a slot determined based on each scheduling information, a slot to receive a next SPS PDSCH based on each periodicity of SPS configuration, and symbols to receive. In the case that the first two SPS configurations (A, B) are configured to periodicity=6, the UE may receive the SPS PDSCH of the SPS configuration A, from slot 0, which is a first slot determined based on a first scheduling information among the four pieces of scheduling information (K0, SLIV, PDSCH mapping type), and slots 6, 12, . . . , which are slots corresponding to periodicity=6. In addition, the UE may receive SPS PDSCH of the SPS configuration B from slot 1, which is a first slot determined based on a second scheduling information, among the four pieces of scheduling information, and slots 7, 13, . . . , which are slots corresponding to periodicity=6. In a case that the following two SPS configurations (C, D) are configured to periodicity=8, the UE may receive SPS PDSCH of the SPC configuration C from slot 2, which is a first slot determined based on a third scheduling information, among the four pieces of scheduling information, and slot 10, 18, . . . , which are slots corresponding to periodicity=8. In addition, the UE may receive SPS PDSCH of the SPC configuration D from slot 3, which is a first slot determined based on a fourth scheduling information, among the four pieces of scheduling information, and slot 11, 19, . . . , which are slots corresponding to periodicity=8.

Here, the HARQ process ID may be determined in the same manner as in Method 2-1 above.

In a case that different SPS configurations have different periodicities, collisions between SPS PDSCHs of different SPS configurations may occur. When collision occurs, the UE may receive SPS PDSCH corresponding to the lowest index among the SPS PDSCHs in which collision occurs. Another method may preferentially receive SPS PDSCH corresponding to the scheduling information of a preceding order.

Here, the collision case may include at least one of i) a case in which a symbol to which two SPS PDSCHs are allocated and a frequency resource (i.e., RE) are the same, ii) a case in which symbols to which two SPS PDSCHs are allocated are the same, and iii) a case in which time units (e.g., slots) to which two SPS PDSCHs are allocated are the same.

A method of activating one or a plurality of SPS configurations through the above-described Method 1-1, Method 1-2, Method 2-1, or Method 2-2 has been disclosed. Now, a method for determining the activation DCI when the UE receives the DCI format is disclosed. For easy description of the disclosure, the foregoing Method 1-1 will be described as a reference, but the method may be applied to Method 1-2, Method 2-1, or Method 2-2.

[Method 3] Activation of Only the SPS PDSCH Corresponding to Some Scheduling Information According to the DCI Format in a Case that Multi-PDSCH Scheduling is Indicated

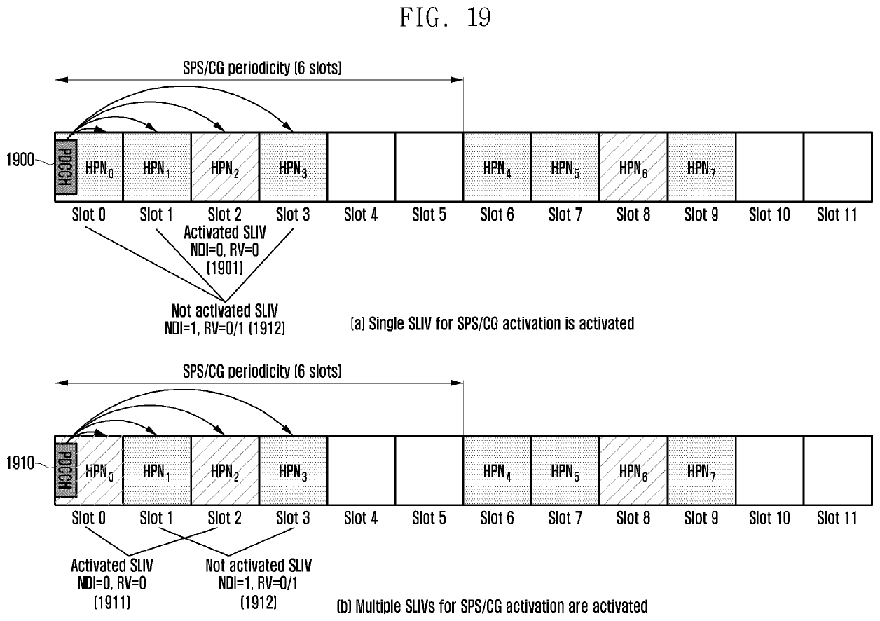

With reference to FIG. 19, the UE may activate only some reception among SPS PDSCH receptions corresponding to all scheduling information (K0, SLIV, PDSCH mapping type) indicated by the DCI format. A specific method for this is disclosed.

The UE may be configured with multi-PDSCH scheduling. One or a plurality of pieces of scheduling information may be included in a row corresponding to the TDRA field of the DCI format received by the UE. The UE may interpret the DCI format according to the number of scheduling information included in a row corresponding to the TDRA field. This is described in the description of FIGS. 12 to 12. With reference to FIG. 12, in a case that one piece of scheduling information is included in a row corresponding to a TDRA field 1200 of DCI format received by the UE, as illustrated in FIG. 12(a), an NDI field 1210 is 1 bit, and a RV field 1215 is 2 bits. In a case that a plurality of pieces of scheduling information is included in a row corresponding to the TDRA field 1200 of the received DCI format, a plurality of NDI fields 1260, 1261 is K bits, and a plurality of RV fields 1262, 1263 is K bits, as illustrated in FIG. 12(b). Each bit of the plurality of NDI fields and the plurality of RV fields corresponds to each scheduling information. Here, K may be the largest value among the number of scheduling information included in each row of the TDRA table.

In a case that the UE is instructed for single-PDSCH scheduling (that is, the number of scheduling information included in a row corresponding to the TDRA field is one), the UE may determine whether the DCI format indicates activation of the SPS configuration based on the 1-bit NDI field 1210, 2-bit RV field 1215, and the HPN field 1220. Here, conditions of the 2-bit RV field 1215 and the HPN field 1220 are specified in Tables 24 to 26.

In a case that the UE is instructed for single-PDSCH scheduling (that is, the number of scheduling information included in a row corresponding to the TDRA field is two or more), the UE may determine whether the DCI format indicates the activation of SPS configuration based on the k-bit NDI field 1210, 1261, the k-bit RV fields 1262, 1263, HPN filed 1270 of the DCI format, and, the UE may determine, if it indicates the activation of the SPS configuration, which scheduling information to active the SPS PDSCHs. A more specific determination method is as follows.

The DCI format includes the K-bit NDI fields 1260, 1261 and the K-bit RV fields 1262, 1263. Here, the k-th bit of each NDI field and the k-th bit of the RV field correspond to the k-th scheduling information. The UE may determine whether the SPS PDSCH corresponding to the k-th scheduling information is activated based on the values of the k-th bit of the NDI field and the k-th bit of the RV field.

With reference to FIGS. 19(a) and (b), the UE may receive the DCI format through a PDCCH 1900, 1910. Here, it is assumed that the received DCI format indicates multi-PDSCH scheduling and indicates a row including four pieces of scheduling information (K0, SLIV, PDSCH mapping type) in a TDRA field. In the K-bit NDI field and the K-bit RV field, a first bit corresponds to a first scheduling information, a second bit corresponds to a second scheduling information, a third bit corresponds to a third scheduling information, and a fourth bit corresponds to a fourth scheduling information.

If the i-th bit of the K-bit NDI field is 0 and the i-th bit of the K-bit RV field is 0, the UE may determine that SPS PDSCH corresponding to the i-th scheduling information is activated (for reference, it is assumed here that the condition of a HPN field is satisfied according to Tables 24 to 26). However, if the i-th bit of the K-bit NDI field is 1 and the i-th bit of the K-bit RV field is 0 or 1, it may be determined that the SPS PDSCH corresponding to the i-th scheduling information is not activated.

According to FIG. 19(a), since the third bit of the 4-bit NDI field is 0 and the third bit of the 4-bit RV field is all 0, the UE may determine that the SPS PDSCH corresponding to the third scheduling information is activated. However, the UE may determine that the SPS PDSCH corresponding to the remaining first, second, and fourth scheduling information in which the bit of the NDI field is 1 and the bit of the RV field is 0 or 1 is not activated.

According to FIG. 19(b), since the first and third bits of the 4-bit NDI field are 0, and the first and third bits of the 4-bit RV field are 0, the UE may determine that the SPS PDSCH corresponding to the first and third scheduling information is activated. However, the UE may determine that the SPS PDSCH corresponding to the remaining second and fourth scheduling information in which the bit of the NDI field is 1 and the bit of the RV field is 0 or 1 is not activated.

With reference to FIGS. 19(a) and (b), if i exists in which both the i-th bit of the K-bit NDI field and the i-th bit of the K-bit RV field are all “0” (i=1,2, . . . ,K), the UE determines that the DCI format is an SPS activation DCI. Conversely, in a case that i does not exist in which both the i-th bit of the K-bit NDI field and the i-th bit of the K-bit RV field are all “0” (i=1, 2, . . . , K), the UE does not determine that the DCI format is the SPS activation DCI. The DCI format may be an SPS deactivation DCI or an SPS retransmission DCI.

For reference, the number of scheduling information indicated by the DCI format may be less than K. For example, the number of scheduling information indicated by the DCI format may be M, and M may be less than K (M<K). In this case, it may be determined whether the DCI format is an SPS activation DCI, an SPS deactivation DCI, or an SPS retransmission DCI based on the preceding M bits among the K-bit NDI field and the K-bit RV field. In addition, among the K-bit NDI field and the K-bit RV field, the following K-M bits may be fixed to a specific value. For example, the K-M bits may be fixed to “0.” However, this “0” value may be excluded from determining whether it is an SPS activation DCI, an SPS deactivation DCI, or an SPS retransmission DCI. More specifically, if i exists in which both the i-th bit of the K-bit NDI field and the i-th bit of the K-bit RV field are all “0” (i=1, 2, . . . , M, where M<K), the DCI format is determined to be an SPS activation DCI. Conversely, in a case that i does not exist in which both the i-th bit of the K-bit NDI field and the i-th bit of the K-bit RV field are all “0” (i=1, 2, . . . , M, where M<K), the DCI format is not determined to be an SPS activation DCI. The DCI format may be an SPS deactivation DCI or an SPS retransmission DCI.

With reference to FIG. 19(a), the UE may expect that only the SPS PDSCH corresponding to one piece of scheduling information is activated. That is, the UE may expect only one the i-th bit of the K-bit NDI field and only one the i-th bit of the K-bit RV field to be “0” and “0.” When the base station always transmits the DCI format indicating SPS activation through a PDCCH 1900, the base station may indicate that only one the i-th bit of the K-bit NDI field and only one the i-th bit of the K-bit RV field of the DCI format are “0” and “0.” Other UEs may not determine that the DCI format is an SPS activation DCI, but may determine that the DCI format is an SPS deactivation DCI or an SPS retransmission DCI.

Although not illustrated in FIG. 19(a), for example, the UE may expect that only the SPS PDSCH corresponding to the first scheduling information is activated. That is, the UE may expect that only the first bit of the K-bit NDI field and only the first bit of the K-bit RV field are “0” and “0.” When the base station always transmits the DCI format indicating SPS activation through the PDCCH 1900, the base station may indicate that only the first bits of the K-bit NDI field and only the first bit of the K-bit RV field of the DCI format are “0” and “0.” That is, the UE may determine that the DCI formation is an SPS activation DCI based on only the first bit of the K-bit NDI field and only the first bit of the K-bit RV field. Here, the value of the first bit is “0.” In other cases, the UE may not determine that the DCI format is an SPS activation DCI, but may determine that the DCI formation is an SPS deactivation DCI or an SPS retransmission DCI.

Although not illustrated in FIG. 19(a), for example, the UE may expect that only the SPS PDSCH corresponding to the last scheduling information is activated. That is, the UE may expect only the last bit of the K-bit NDI field and only the last bit of the K-bit RV field to be “0” and “0.” When the base station always transmits the DCI format indicating SPS activation through the PDCCH 1900, the base station may indicate only the last bit of the K-bit NDI field and only the last bit of the K-bit RV field of the DCI format are “0” and “0.” That is, the UE may determine that the DCI format is an SPS activation DCI based on only the last bit of the K-bit NDI field and only the last bit of K-bit RV field. Here, the value of the last bit is “0.” In other cases, the UE may not determine that the DCI format is an SPS activation DCI, but may determine that the DCI formation is an SPS deactivation DCI or an SPS retransmission DCI. Here, the last bits are the M-th bits (the number of scheduling information indicated by the DCI format is M, and M<K). In this case, it may be determined whether the DCI format is an SPS activation DCI, an SPS deactivation DCI, or an SPS retransmission DCI based on a preceding M bits among the K-bit NDI field and the K-bit RV field.

<Third Embodiment: Semi-Persistent Scheduling PDSCH Reception (Configured Grant PUSCH Transmission) Retransmission Method in a Case that Multi-PDSCH (Multi-PUSCH) Scheduling is Configured>

In a case that multi-PDSCH scheduling is configured to the UE, the DCI format may indicate one of a single PDSCH scheduling indication and a multi-PDSCH scheduling indication. The disclosure discloses a method of retransmitting SPS PDSCH via the DCI format.

Thereafter, unless otherwise specified, the CRC of the DCI format is scrambled with cs-RNTI.

[Method 1] Retransmission Via the DCI Format Indicating Single-PDSCH Scheduling

Even if multi-PDSCH scheduling is configured, the UE may only expect to retransmit SPS PDSCH via the DCI format indicating single-PDSCH scheduling. That is, in a case that the UE receives the DCI format indicating multi-PDSCH scheduling, the DCI format may be interpreted as an SPS activation DCI or an SPS deactivation DCI, and may not be interpreted as an SPS retransmission DCI.

With reference to FIG. 12(a), in a case that the UE interprets the received DCI as the DCI format indicating single-PDSCH scheduling, the DCI format includes a 1-bit NDI field. If the 1-bit NDI is “1,” the UE may determine the DCI format as an SPS PDSCH retransmission DCI format. Also, the HARQ process ID of the retransmitted SPS PDSCH may be indicated in a HPN field 1220 of the DCI format.

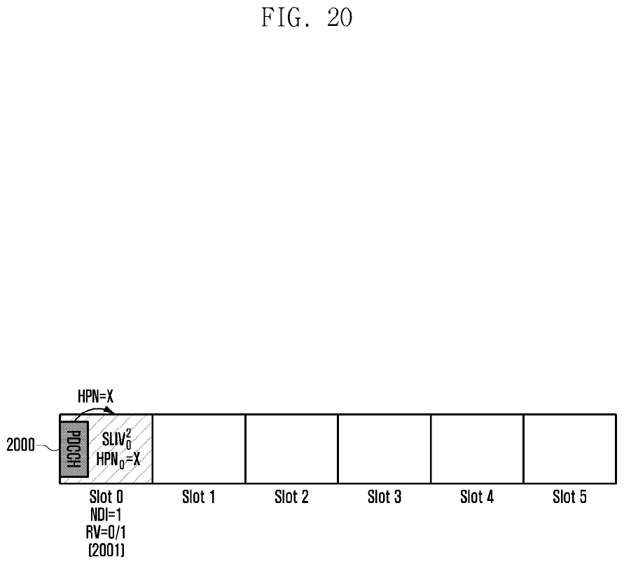

With reference to FIG. 20, a case in which the TDRA field of the DCI format received in the PDCCH 2000 indicates row 2 is illustrated. Here, since row 2 has one piece of scheduling information (K0, SLIV, PDSCH mapping type), the UE may determine a slot in which SPS PDSCH is to be retransmitted based on the scheduling information (here, the slot is slot 0 assuming K0=0). Also, a symbol to receive the retransmission of SPS PDSCH in the slot may be determined as SLIV²₀. The HARQ process ID of SPS PDSCH of the first slot is indicated in the HPN field of the DCI format.

According to Method 1, in the case of DCI format in which CRC is scrambled with cs-RNTI, multi-PDSCH scheduling may not be required. Moreover, a row indicating at least one single-PDSCH scheduling must be included in the TDRA table. Accordingly, in the case of DCI format in which CRC is scrambled with cs-RNTI, the base station may configure a new TDRA table. All the new TDRA tables may include the rows indicating single-PDSCH scheduling. That is, when the UE receives the DCI format in which the CRC is scrambled with cs-RNTI, the UE may use a new TDRA table as the TDRA table of the DCI format. Since the new TDRA table includes only a row indicating single-PDSCH scheduling, SPS PDSCH retransmission may be received according to the scheduling information indicated by the row.

[Method 2] Retransmission Via DCI Format Indicating Multi-PDSCH Scheduling

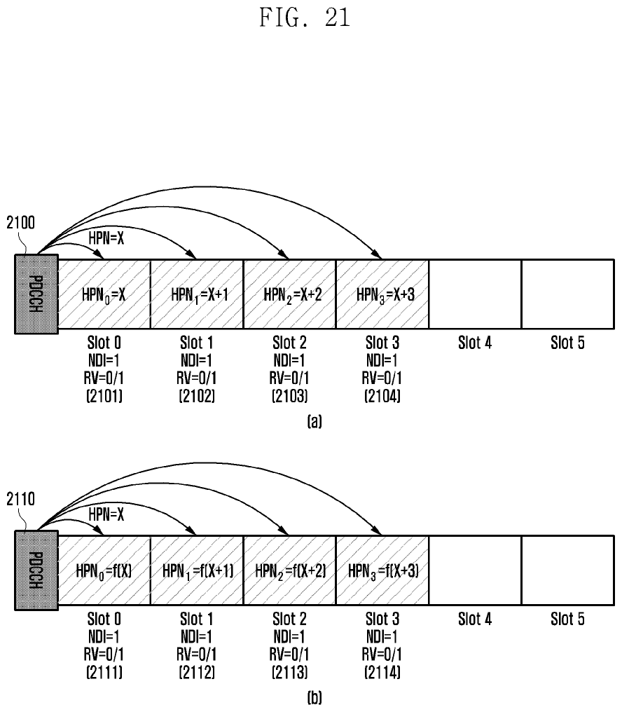

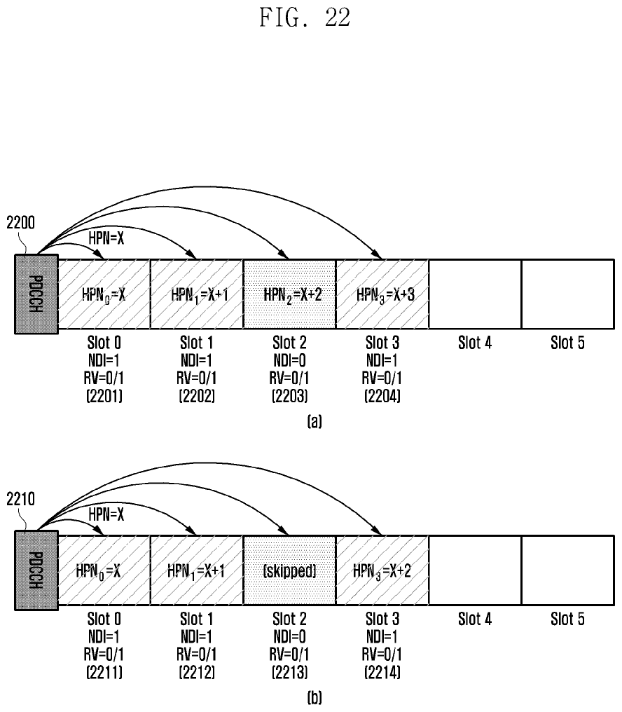

With reference to FIGS. 21 and 22, the UE may retransmit SPS PDSCH using the DCI format indicating multi-PDSCH scheduling.

With reference to FIG. 21, the UE may retransmit SPS PDSCH using the DCI format indicating multi-PDSCH scheduling. Here, the UE may retransmit a plurality of SPS PDSCHs using a plurality of pieces of scheduling information.

When the number of scheduling information indicated in the DCI format received in a PDCCH 2100 is M, in a case that all the preceding M bits of the K-bit NDI field are “1,” the UE may determine that the DCI format is the DCI format retransmitting SPS PDSCH. In addition, a slot and symbol in which the retransmission of SPS PDSCH is to be received may be determined according to the scheduling information indicated in the DCI format. FIG. 21 illustrates a case in which the TDRA field of the DCI format received in the PDCCH 2100 indicates row 0. Here, since row 0 has four pieces of scheduling information (K0, SLIV, PDSCH mapping type), in a case that all 4 bits of the NDI field are “1,” the UE may determine that the DCI is the DCI for scheduling SPS PDSCH retransmission.

The UE may receive the SPS PDSCH retransmission based on the four pieces of scheduling information. In FIG. 21, the UE may determine that the SPS PDSCH is retransmitted in slot 0 according to the first scheduling information, the SPS PDSCH is retransmitted in slot 1 according to the second scheduling information, the SPS PDSCH is retransmitted in slot 2 according to the third scheduling information, and the SPS PDSCH is retransmitted in slot 3 according to the fourth scheduling information.

[Method 2-1] Sequential increase from an indicated HARQ process ID—However, SPS PDSCH outside the HARQ process ID range is excluded from reception.

Assume that the HARQ process ID of SPS PDSCH of slot 0 according to the first scheduling information is HPN₀, the HARQ process ID of SPS PDSCH of slot 1 according to the second scheduling information is HPN₁, the HARQ process ID of SPS PDSCH of slot 2 according to the third scheduling information is HPN₂, and the HARQ process ID of SPS PDSCH of slot 3 according to the fourth scheduling information is HPN₃. HPN₀ may be indicated in the HPN field of the DCI format. Here, for convenience, the value indicated in the HPN field may be X. Thereafter, the HARQ process ID may be a value increased by one in order from X. That is, HPN₁=X+1, HPN₂=X+2, and HPN₃=X+3.

The SPS configuration may include nrofHARQ-Processes (the number of HARQ processes configured in the SPS) or harq-ProcID-Offset (an offset value of the HARQ process for the SPS). In this case, the HARQ process IDs that the SPS PDSCHs of the SPS configuration may have harq-ProcID-Offset, harq-ProcID-Offset+1, . . . , harq-ProcID-Offset+nrofHARQ-Processes−1. Therefore, the HARQ process IDs cannot have any other value.

In the above, the HARQ process ID is a value increased by 1 from X, which is the value indicated in HPN₀. However, the value increased by 1 may deviate from the HARQ process IDs available in the SPS configuration, which are harq-ProcID-Offset, harq-ProcID-Offset+1, . . . , harq-ProcID-Offset+nrofHARQ-Processes−1. Therefore, the value should not deviate from the range of the HARQ process IDs.

With reference to FIG. 21(a), when the HARQ process ID of the SPS PDSCH is determined by sequentially increasing the value of the HPN field indicated in the DCI format, the increased value may be out of the range of the available HARQ process ID. For example, with reference to FIG. 21(a), available HARQ process IDs are X and X+1, but the HARQ process IDs of SPS PDSCH scheduled in slots 2 to 3 are X+2 and X+3. In this case, the UE may receive the SPS PDSCH included in the available HARQ process ID, but may not receive the SPS PDSCH that does not correspond to the available HARQ process ID.

The available HARQ process ID may be the HARQ process ID included in at least one of SPS configurations configured for the UE.

The available HARQ process ID may be the HARQ process ID included in one of the SPS configurations configured for the UE. Here, one configuration may be separately indicated from the base station or may be determined based on the value of the HPN field of the DCI format received by the UE. Exemplarily, when the value of the HPN field is X, there may be one SPS configuration in which X is an available HARQ process ID, and an available HARQ process ID can be obtained using nrofHARQ-Processes and harq-ProcID-Offset of the one SPS configuration.

[Method 2-2] Sequentially increasing within an available HARQ process ID from an indicated HARQ process ID—However, SPS PDSCH outside the HARQ process ID range is excluded from reception.

With reference to FIG. 21(b), the HARQ process ID of SPS PDSCH retransmitted according to the i-th scheduling information may be determined based on the value of X+i−1 (i=1,2, . . . ). That is, the HARQ process ID of SPS PDSCH retransmitted according to the first scheduling information may be determined as f(X) based on the X value; the HARQ process ID of SPS PDSCH retransmitted according to the second scheduling information may be determined as f(X+1) based on the value of X+1; the HARQ process ID of SPS PDSCH retransmitted according to the third scheduling information may be determined as f(X+2) based on the value of X+2; and the HARQ process ID of SPS PDSCH retransmitted according to the fourth scheduling information may be determined as f(X+3) based on the value X+3. Here, f(x) may be determined as follows: [Equation 5]f(x)=x modulo nrofHARQ-Processes+harq-ProcID-Offset.

Here, nrofHARQ-Processes and harq-ProcID-Offset are included in the SPS configuration. In a case that a plurality of SPS configurations is given to the UE, one SPS configuration should be selected for the UE. This may be separately indicated by the base station or may be determined based on the value of the HPN field of the DCI format received by the UE. Exemplarily, when the value of the HPN field is X, there may be one SPS configuration in which X is an available HARQ process ID, and nrofHARQ-Processes and harq-ProcID-Offset of the one SPS configuration may be used.

When the UE determines the HARQ process ID using Equation 5, there may be a HARQ process ID that overlaps with the HARQ process ID already used in the retransmission of the SPS PDSCH. For example, with reference to FIG. 21(b), in the case of nrofHARQ-Processes=2, the available HARQ process IDs are harq-ProcID-Offset, harq-ProcID-Offset+1, but the number of scheduled SPS PDSCHs is 4. In this case, the UE may receive the previous number, nrofHARQ-Processes of SPS PDSCH, but may not receive subsequent SPS PDSCHs.

Additionally, the UE may expect that the number of scheduling information indicated by the received DCI format is less than or equal to nrofHARQ-Processes. According to such a condition, the number of SPS PDSCHs scheduled by the UE may not be greater than nrofHARQ-Processes.

[Method 2-3] SPS PDSCH Retransmission Using Some Scheduling Information According to DCI Format

With reference to FIG. 22, the UE may receive SPS PDSCH retransmission using the DCI format indicating multi-PDSCH scheduling. Here, the UE may receive the SPS PDSCH retransmission by using some of a plurality of pieces of scheduling information.

When the number of scheduling information indicated in the DCI format received in a PDCCH 2200 is M, the scheduling information corresponding to “1” among the preceding M bits of the K-bit NDI field is used for SPS PDSCH retransmission, but the scheduling information corresponding to “0” may not be used for SPS PDSCH retransmission. With reference to FIG. 22, a case in which the TDRA field of the DCI format received in the PDCCH 2200 indicates row 0 is illustrated. Here, since row 0 has four pieces of scheduling information (K0, SLIV, PDSCH mapping type), the scheduling information in which NDI is “1” among 4 bits of the NDI field, that is, the first, second, and fourth scheduling information is used for SPS PDSCH retransmission, but the scheduling information in which NDI is “0,” that is, the third scheduling information may not be used for SPS PDSCH retransmission.

With reference to FIGS. 22(a) and (b), the UE may determine the HARQ process ID of the SPS PDSCH based on the NDI value.

With reference to FIG. 22(a), the UE may determine the HARQ process ID of SPS PDSCH by sequentially increasing the HARQ process ID value according to the order of the scheduling information, regardless of the NDI value. For example, the SPS PDSCH of slot 2 corresponding to the third scheduling information is not used for retransmission because NDI=“0,” but the HARQ process ID may be determined as X+2. Therefore, the HARQ process ID of SPS PDSCH of slot 3 corresponding to the fourth scheduling information may be determined as X+3. Therefore, according to the above example, the HARQ process ID of the actually retransmitted SPS PDSCH may be discontinuous.

With reference to FIG. 22(b), the UE may determine the HARQ process ID of SPS PDSCH by sequentially increasing the HARQ process ID value according to the order of scheduling information in consideration of the NDI value. For example, since the SPS PDSCH of slot 2 corresponding to the third scheduling information is not used for retransmission because NDI=“0,” the SPS PDSCH may be excluded. Therefore, the HARQ process ID of SPS PDSCH of slot 3 corresponding to the fourth scheduling information may be determined as X+2. Therefore, according to the above example, the HARQ process ID of SPS PDSCH that is actually retransmitted may be continuous.

<Flowchart>

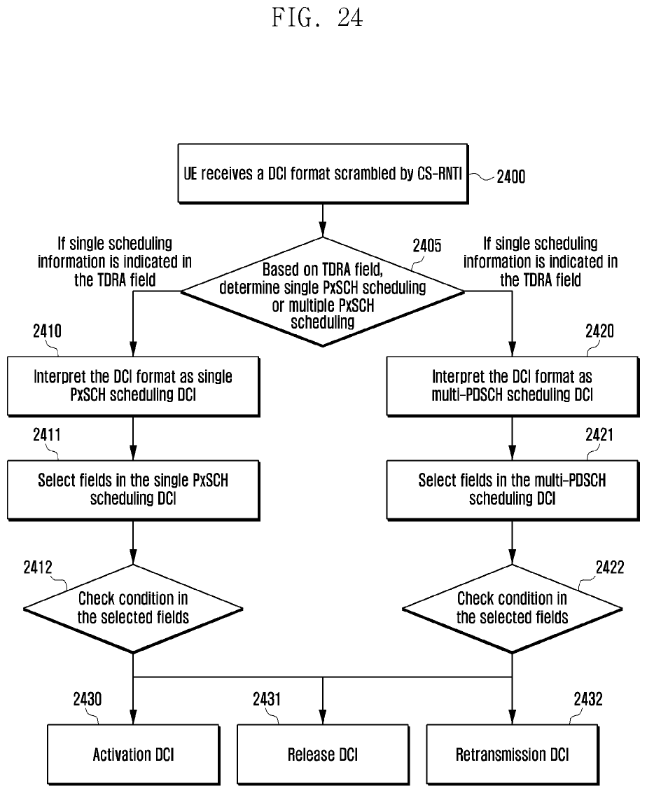

With reference to FIG. 24, a flowchart of a preferred combination of the disclosure is illustrated.

The UE receives the DCI format 2400. Here, CRC of DCI format is scrambled CS-RNTI.

The UE determines whether single-PDSCH scheduling or multi-PDSCH scheduling is indicated based on the value of the TDRA field of the received DCI format 2405. Here, if one piece of scheduling information (K0, SLIV, PDSCH mapping type) is configured in a row corresponding to the value of the TDRA field, the UE may determine that it is the DCI indicating single-PDSCH scheduling. If two or more pieces of scheduling information (K0, SLIV, PDSCH mapping type) are configured in a row corresponding to the value of the TDRA field, the UE may determine that it is the DCI indicating multi-PDSCH scheduling.

In a case that the UE determines that the received DCI format is the DCI indicating single-PDSCH scheduling, the UE may interpret the DCI by considering the DCI as the DCI indicating single-PDSCH scheduling 2410. In the case of the DCI indicating single-PDSCH scheduling, a 1-bit NDI field and a 2-bit RV field may be included.

The UE may select some fields from the DCI interpreted as the DCI indicating single-PDSCH scheduling 2411. Here, some fields may include at least one of a MCS field, an NDI field, a RV field, a HPN field, and a FDRA field. Here, the NDI field may be 1-bit and the RV field may be 2-bits.

The UE may determine the received DCI 2412 based on the values of the selected fields as one of an SPS activation DCI 2430, an SPS deactivation or release DCI 2431, or an SPS retransmission DCI 2432.

The UE may determine the DCI as the SPS activation DCI 2430 in the following cases:
In the case of single SPS configuration, the bits of 1-bit NDI field are “0,” the bits of 2-bit RV field are “0,” and the bits of HPN field are “0”;
In the case of two or more SPS configurations, the bits of the 1-bit NDI field are “0” and the bits of the 2-bit RV field are “0”;
In this case, the SPS configuration is activated. In a case of more than one SPS configuration, the active SPS configuration is indicated in the HPN field,
The UE may determine the DCI as the SPS deactivation DCI 2431 in the following case;
In the case of single SPS configuration, the bits of the 1-bit NDI field are “0,” the bits of the 2-bit RV field are “0,” the bits of the HPN field are “0,” and the bits of the MCS field are “1,” and the bits of the FDRA field are “0” in the case of FDRA type-0 and “1” in the case of FDRA type-1;
In the case of two or more SPS configurations, the bits of the 1-bit NDI field are “0,” the bits of the 2-bit RV field are “0,” the bits of the MCS field are “I,” and the bits of the FDRA field are “0” in the case of FDRA type-0 and “1” in the case of FDRA type-1; and/or
In this case, the SPS configuration is deactivated. For more than one SPS configuration, the SPS configuration or group of SPS configurations to be deactivated is indicated in the HPN field.

The UE may determine the DCI as the SPS retransmission DCI 2432 in the following cases:
The bits of 1-bit NDI field are “1”; and/or
In this case, the SPS PDSCH is retransmitted and the HARQ process ID of the SPS PDSCH is indicated in the HPN field.

In a case that the UE determines that the received DCI format is the DCI indicating multi-PDSCH scheduling, the UE may interpretate the DCI according to the DCI indicating multi-PDSCH scheduling 2420. In the case of the DCI indicating multi-PDSCH scheduling, a K-bit NDI field and a K-bit RV field may be included. Here, K may be the largest value among the number of scheduling information included in each row of the TDRA table. When the DCI indicates multi-PDSCH scheduling, let M be the number of indicated scheduling information. Here, M is greater than K (M<K).

The UE may select some fields from the DCI interpreted as the DCI indicating multi-PDSCH scheduling 2421. Here, some fields may include at least one of a MCS field, an NDI field, a RV field, a HPN field, and a FDRA field. Here, the NDI field may be K-bits and the RV field may be K-bits.

The UE may determine the DCI as one of the SPS activation DCI 2430, the SPS deactivation or release DCI 2431, and the SPS retransmission DCI 2432 based on the values of the selected fields 2422.

The UE may determine the DCI as the SPS activation DCI 2430 in the following cases:
In the case of single SPS configuration, the bits of the HPN field are “0,” and at least one i-th bits among the preceding M bits of the K-bit NDI field and the preceding M bits of the K-bit RV field are all “0” (the i-th bits of the NDI field are 0) and “0” (the i-th bits of the RV field are 0);
In the case of two or more SPS configurations, the bits of the HPN field are “0,” and at least one i-th bits among the preceding M bits of the K-bit NDI field and the preceding M bits of the K-bit RV field are all “0” (the i-th bits of the NDI field are 0) and “0” (the i-th bits of the RV field are 0): and/or
In this case, the SPS configuration is activated in the SPS PDSCH corresponding to the i-th scheduling information. For more than one SPS configuration, the active SPS configuration is indicated in the HPN field.

The UE may determine the DCI as the SPS deactivation DCI 2431 in the following cases:
In the case of single SPS configuration, the bits of the HPN field are “0,” and at least all i-th bits among the preceding M bits of the K-bit NDI field and the preceding M bits of the K-bit RV field are not “0” (the i-th bits of NDI field are 0) and “0” (the i-th bits of RV field are 0) (for example, in the case that the all preceding M bits of the K-bit NDI field are “0” and the all preceding M bits of the K-bit RV field are “l,” it is determined as the SPS deactivation DCI 2431);
In the case of two or more SPS configurations, at least all i-th bits among the preceding M bits of the K-bit NDI field and the preceding M bits of the K-bit RV field are not “0” (the i-th bits of the NDI field are 0) and “0” (the i-th bits of RV field are 0) (for example, in the case that the all preceding M bits of the K-bit NDI field are “0” and the all preceding M bits of the K-bit RV field are “1,” it is determined as the SPS deactivation DCI 2431), and/or
In this case, the SPS configuration is deactivated. In the case of more than one SPS configuration, the SPS configuration or group of SPS configurations to be deactivated is indicated in the HPN field.

The UE may determine the DCI as the SPS retransmission DCI 2432 in the following cases:
At least one of the preceding M bits of the K-bit NDI field contains “1”; and/or
In this case, the SPS PDSCH is retransmitted according to the scheduling information corresponding to the “1.”

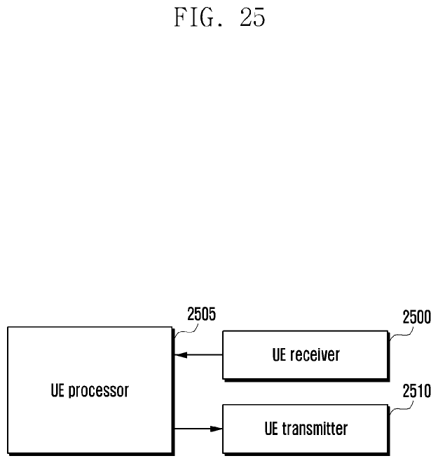

FIG. 25 illustrates a structure of a UE in a wireless communication system according to an embodiment of the disclosure.

With reference to FIG. 25, a UE may include a transceiver which may be referred to as a UE receiver 2500 and a UE transmitter 2510, a memory (not shown), and a UE processor 2505 (or a UE controller or processor) According to the above-described method of the UE, the transceiver 2500, 2510, memory, and processor 2505 of the UE may operate. However, the components of the UE are not limited to the above-described examples. For example, the UE may include more or fewer components compared to the above-mentioned components. In addition, the transceiver, the memory, and the processor may be implemented in the form of one chip.

The transceiver may transmit a signal to or receive a signal from a base station. Here, the signal may include control information and data. To this end, the transceiver may include an RF transmitter to perform up-conversion and amplification of a frequency of a transmitted signal, an RF receiver to perform low-noise amplification of a received signal and down-conversion of a frequency of the received signal, and the like. However, this is only an embodiment of the transceiver, and the components of the transceiver are not limited to the RF transmitter and the RF receiver.

In addition, the transceiver may receive a signal via a radio channel, may output the signal to the processor, and may transmit the signal output from the processor via the radio channel.

The memory may store a program and data necessary for operation of the UE. Also, the memory may store control information or data included in a signal transmitted or received by the UE. The memory may include a storage medium or a combination of storage media, such as ROM. RAM, hard disk, CD-ROM, and DVD. Also, there may be a plurality of memories.

In addition, the processor may control a series of procedures so that the UE may operate according to the above-described embodiments. For example, the processor may receive the DCI constituted with two layers and control the components of the UE to receive a plurality of PDSCHs at the same time. There may be a plurality of processors, and the processor may perform control operation of the components of the UE by executing a program stored in the memory.

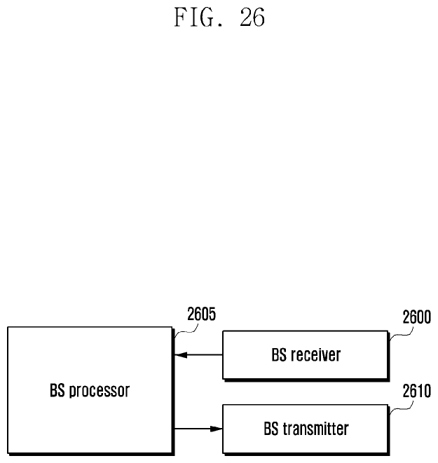

FIG. 26 illustrates a structure of a base station in a wireless communication system according to an embodiment of the disclosure.

With reference to FIG. 26, a base station may include a transceiver which is referred to as a BS receiver 2600 and a BS transmitter 2610, a memory (not shown), and a BS processor 2605 (or BS controller or processor). According to the above-described communication method, the transceiver 2600, 2610, memory, and processor 2605 of the base station may operate. However, the components of the base station are not limited to the above examples. For example, the base station may include more or fewer components compared to the above-described components. In addition, the transceiver, the memory, and the processor may be implemented in the form of one chip.

The transceiver may transmit a signal to or receive a signal from the UE. Here, the signal may include control information and data. To this end, the transceiver may include an RF transmitter to perform up-conversion and amplification of a frequency of a transmitted signal, an RF receiver to perform low-noise amplification of a received signal and down-conversion of a frequency of the received signal, and the like. However, this is only an embodiment of the transceiver, and the components of the transceiver are not limited to the RF transmitter and the RF receiver.

In addition, the transceiver may receive a signal via a radio channel, may output the signal to the processor, and may transmit the signal output from the processor via the radio channel.

The memory may store a program and data necessary for operation of the base station. Also, the memory may store control information or data included in a signal transmitted or received by the base station. The memory may include a storage medium or a combination of storage media, such as ROM, RAM, hard disk, CD-ROM, and DVD. There may be a plurality of memories.

The processor may control a series of procedures so that the base station may operate according to the above-described embodiment of the disclosure. For example, the processor may control each component of the base station to constitute two-layer DCIs including allocation information for a plurality of PDSCHs and transmit the two-layers DCIs. There may be a plurality of processors, and the processor may perform control operation of the components of the base station by executing a program stored in the memory.

The methods according to various embodiments described in the claims or the specification of the disclosure may be implemented by hardware, software, or a combination of hardware and software.

In a case that the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to the embodiments described in the claims or specification of the disclosure

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, the programs may be stored in a memory constituted with any combination of some or all of them. Further, each component memory may include a plurality of memories.

In addition, the programs may be stored in an attachable storage device that may be accessed through the Internet, an intranet, a local area network (LAN), a wireless LAN (WLAN), and a storage area network (SAN), or a communication network including a combination thereof. This storage device may be connected through an external port to a device carrying out an embodiment of the disclosure. In addition, a separate storage device on a communication network may be connected to the device carrying out an embodiment of the disclosure.

In the above-described detailed embodiments of the disclosure, a component included in the disclosure is expressed in the singular or the plural according to presented detailed embodiments. However, the singular form or plural form is selected appropriately to the presented situation for the convenience of description, and the disclosure is not limited by components expressed in the singular or the plural. Therefore, either a component expressed in the plural may be also constituted with a single component or a component expressed in the singular may be also constituted with a plurality of components.

Meanwhile, the embodiments of the disclosure described and shown in the specification and the drawings have been presented to easily explain the technical contents of the disclosure and help understanding of the disclosure, and are not intended to limit the scope of the disclosure. That is, it will be apparent to those skilled in the art that other modifications and changes may be made thereto on the basis of the technical idea of the disclosure. Further, the above respective embodiments may be employed in combination, as necessary. For example, one embodiment of the disclosure may be partially combined with other embodiments to operate a base station and a UE. As an example, embodiment I and 2 of the disclosure may be combined with each other to operate a base station and a UE. Further, although the above embodiments have been described on the basis of the FDD LTE system, other variants based on the technical idea of the embodiments may also be implemented in other systems such as TDD LTE, 5G, or NR systems.

Meanwhile, in the drawings in which methods of the present disclosure are described, the order of the description does not always correspond to the order in which steps of each method are performed, and the order relationship between the steps may be changed or the steps may be performed in parallel.

Alternatively, in the drawings in which methods of the present disclosure are described, some components may be omitted and only some components may be included therein without departing from the essential spirit and scope of the present disclosure.

Further, in methods of the present disclosure, some or all of the contents of each embodiment may be combined without departing from the essential spirit and scope of the disclosure.

Various embodiments of the disclosure have been described above. The foregoing description of the disclosure is for illustrative purposes only, and embodiments of the disclosure are not limited to the disclosed embodiments. Those of ordinary skill in the art to which the disclosure pertains will understand that it can be easily modified into other specific forms without changing the technical spirit or essential features of the disclosure. The scope of the disclosure is indicated by the following claims rather than the above detailed description, and all changes or modifications derived from the meaning and scope of the claims and their equivalents should be interpreted as being included in the scope of the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of a terminal in a wireless communication system, the method comprising:
receiving, from a base station, a radio resource control (RRC) message including scheduling information related to a plurality of physical downlink shared channels (PDSCHs);
receiving, from the base station, downlink control information (DCI);
identifying whether the DCI is related to a secondary cell (SCell) dormancy indication;
identifying, based on the scheduling information related to the plurality of PDSCHs, a number of bits of a new data indicator (NDI) field and a number of bits of a redundancy version (RV) field included in the DCI;
identifying a bitmap of the SCell dormancy indication included in the DCI based on the number of bits of the NDI field and the number of bits of the RV field; and
identifying an active bandwidth part (BWP) for the SCell configured in the terminal based on the identified bitmap.

2. The method according to claim 1, wherein the bitmap is determined based on a modulation and coding scheme (MCS) field, the NDI field, the RV field, a hybrid automatic repeat request (HARD) process number field, an antenna port field, and a demodulation reference signal (DMRS) sequence initialization field that are included in the DCI,
wherein the DCI includes time domain resource (TDRA) field, and
wherein the number of bits of the NDI field and a number of bits of the RV field included in the DCI is identified based on the TDRA field.

3. The method according to claim 2, wherein the number of bits of the NDI field and the number of bits of the RV field correspond to a maximum number of the PDSCHs scheduled by the TDRA field.

4. The method according to claim 1, wherein in a case that a bit of the bitmap is set to zero, the active BWP is identified as a dormant BWP, and in a case that the bit of the bitmap is set to one, the active BWP is identified as a first BWP to be activated after the dormant BWP.

5. The method according to claim 2, wherein the scheduling information for the plurality of PDSCHs includes at least one of K0, a start and length indicator value (SLIV), and a PDSCH mapping type corresponding to a row indicated by the TDRA field.

6. The method according to claim 2, further comprising:
identifying that there is one start and length indicator value (SLIV) corresponding to a row indicated by the TDRA field; and
identifying, based on the one SLIV corresponding to the indicated row, that the DCI include information for an activation/deactivation of an SPS semi-persistent scheduling physical downlink shared channel (SPS PDSCH).

7. A terminal in a wireless communication system, the terminal comprising:
a transceiver; and
a processor operably connected to the transceiver and configured to:
receive, from a base station, a radio resource control (RRC) message including scheduling information related to a plurality of physical downlink shared channels (PDSCHs),
receive, from the base station, downlink control information (DCI),
identify whether the DCI is related to a secondary cell (SCell) dormancy indication,
identify, based on the scheduling information related to the plurality of PDSCHs, a number of bits of a new data indicator (NDI) field and a number of bits of a redundancy version (RV) field included in the DCI,
identify a bitmap of the SCell dormancy indication included in the DCI based on the number of bits of the NDI field and the number of bits of the RV field, and
identify an active bandwidth part (BWP) for the SCell configured in the terminal based on the identified bitmap.

8. The terminal according to claim 7, wherein the bitmap is determined based on a modulation and coding scheme (MCS) field, the NDI field, the RV field, a hybrid automatic repeat request (HARD) process number field, an antenna port field, and a demodulation reference signal (DMRS) sequence initialization field that are included in the DCI,
wherein the DCI includes time domain resource (TDRA) field,
wherein the number of bits of the NDI field and a number of bits of the RV field included in the DCI is identified based on the TDRA field, and
the number of bits of the NDI field and the number of bits of the RV field correspond to a maximum number of the PDSCHs scheduled by the TDRA field.

9. The terminal according to claim 7, wherein, in a case that a bit of the bitmap is set to zero, the active BWP is identified as a dormant BWP, and in a case that the bit of the bitmap is set to one, the active BWP is identified as a first BWP to be activated after the dormant BWP.

10. The terminal according to claim 8, wherein the scheduling information for the plurality of PDSCHs includes at least one of K0, a start and length indicator value (SLIV), and a PDSCH mapping type corresponding to a row indicated by the TDRA field.

11. The terminal according to claim 8, wherein the processor is further configured to:
identify that there is one start and length indicator value (SLIV) corresponding to a row indicated by the TDRA field; and
identify, based on the one SLIV corresponding to the indicated row, that the DCI include information for an activation/deactivation of an SPS semi-persistent scheduling physical downlink shared channel (SPS PDSCH).

12. A method of a base station in a wireless communication system, the method comprising:
transmitting, to a terminal, a radio resource control (RRC) message including scheduling information related to a plurality of physical downlink shared channels (PDSCHs); and
transmitting, to the terminal, downlink control information (DCI),
wherein the DCI is related to a secondary cell (SCell) dormancy indication,
wherein, based on the scheduling information related to the plurality of PDSCHs, a number of bits of a new data indicator (NDI) field and a number of bits of a redundancy version (RV) field included in the DCI is configured,
wherein a bitmap of the SCell dormancy indication included in the DCI is configured based on the number of bits of the NDI field and the number of bits of the RV field, and
wherein an active bandwidth part (BWP) for the SCell configured in the terminal is configured based on the identified bitmap.

13. The method according to claim 12, wherein the bitmap is determined based on a modulation and coding scheme (MCS) field, the NDI field, the RV field, a hybrid automatic repeat request (HARD) process number field, an antenna port field, and a demodulation reference signal (DMRS) sequence initialization field that are included in the DCI,
wherein the DCI includes time domain resource (TDRA) field,
wherein the number of bits of the NDI field and a number of bits of the RV field included in the DCI is identified based on the TDRA field,
wherein the number of bits of the NDI field and the number of bits of the RV field correspond to a maximum number of the PDSCHs scheduled by the TDRA field,
wherein, in a case that a bit of the bitmap is set to zero, the active BWP is identified as a dormant BWP, and in a case that the bit of the bitmap is set to one, the active BWP is identified as a first BWP to be activated after the dormant BWP, and
wherein the scheduling information for the plurality of PDSCHs includes at least one of K0, a start and length indicator value (SLIV), and a PDSCH mapping type corresponding to a row indicated by the TDRA field.

14. A base station in a wireless communication system, the base station comprising:
a transceiver; and
a processor operably connected to the transceiver and configured to:
transmit, to a terminal, a radio resource control (RRC) message including scheduling information related to a plurality of physical downlink shared channels (PDSCHs), and
transmit, to the terminal, downlink control information (DCI),
wherein the DCI is related to a secondary cell (SCell) dormancy indication,
wherein, based on the scheduling information related to the plurality of PDSCHs, a number of bits of a new data indicator (NDI) field and a number of bits of a redundancy version (RV) field included in the DCI is configured,
wherein a bitmap of the SCell dormancy indication included in the DCI is configured based on the number of bits of the NDI field and the number of bits of the RV field, and
wherein an active bandwidth part (BWP) for the SCell configured in the terminal is configured based on the identified bitmap.

15. The base station according to claim 14, wherein the bitmap is determined based on a modulation and coding scheme (MCS) field, the NDI field, the RV field, a hybrid automatic repeat request (HARD) process number field, an antenna port field, and a demodulation reference signal (DMRS) sequence initialization field that are included in the DCI,
wherein the DCI includes time domain resource (TDRA) field,
wherein the number of bits of the NDI field and a number of bits of the RV field included in the DCI is identified based on the TDRA field,
wherein the number of bits of the NDI field and the number of bits of the RV field correspond to a maximum number of the PDSCHs scheduled by the TDRA field,
wherein, in a case that a bit of the bitmap is set to zero, the active BWP is identified as a dormant BWP, and in a case that the bit of the bitmap is set to one, the active BWP is identified as a first BWP to be activated after the dormant BWP, and
wherein the scheduling information for the plurality of PDSCHs includes at least one of K0, a start and length indicator value (SLIV), and a PDSCH mapping type corresponding to a row indicated by the TDRA field.
